(19) United States
(12) Patent Application Publication
(10) Pub. No.: US 2025/0058219 A1
(43) Pub. Date: Feb. 20, 2025

(54) VIRTUAL CHARACTER CONTROL METHOD AND ELECTRONIC DEVICE THEREOF

(71) Applicant: NETEASE (HANGZHOU) NETWORK CO., LTD., Hangzhou, Zhejiang (CN)

(72) Inventors: Lei KUAN, Hangzhou, Zhejiang (CN); Hanlin WEI, Hangzhou, Zhejiang (CN); Xutao HU, Hangzhou, Zhejiang (CN); Chen GONG, Hangzhou, Zhejiang (CN); Tao CHEN, Hangzhou, Zhejiang (CN)

(73) Assignee: NETEASE (HANGZHOU) NETWORK CO., LTD., Hangzhou, Zhejiang (CN)

(21) Appl. No.: 18/725,837

(22) PCT Filed: May 15, 2023
(86) PCT No.: PCT/CN2023/094320

§ 371 Date: Jul. 1, 2024

(30) Foreign Application Priority Data
May 19, 2022 (CN) 202210558052.5
Apr. 21, 2023 (CN) 202310452466.4

(51) Int. Cl. A63F 13/537

(52) U.S. Cl. CPC A63F 13/537

(57) ABSTRACT

A virtual character control method and an electronic device thereof. The method includes: displaying a first attack control on a graphical user interface; in response to detecting a first touch-control operation acting on the first attack control, determining whether the first touch-control operation is a click operation or a sliding operation; in response to determining that the first touch-control operation is the click operation, controlling a virtual character to perform a first attack action corresponding to the first attack control; and in response to determining that the first touch-control operation is the sliding operation, determining a first target action from a first action set according to the sliding operation, and controlling the virtual character to perform the first target action.

### CROSS-REFERENCE TO RELATED APPLICATIONS

The present disclosure is a U.S. National Phase Application of International Application No. PCT/CN2023/094320, filed on May 15, 2023, which is based on and claims the priority of China Patent Application No. 202310452466.4 filed on Apr. 21, 2023, entitled “VIRTUAL CHARACTER CONTROL METHOD, APPARATUS, ELECTRONIC DEVICE AND STORAGE MEDIA” and claims the priority of China Patent Application No. 202210558052.5 filed on May 19, 2022, entitled “VIRTUAL CHARACTER CONTROL METHOD, APPARATUS AND ELECTRONIC DEVICE”, the entire contents of all of which are incorporated by reference in the present disclosure for all purposes.

### TECHNICAL FIELD

The present disclosure relates to a technical field of games, in particular to a virtual character control method, a virtual character control apparatus, an electronic device and a non-transitory storage medium.

### BACKGROUND

The action game (ACT for short) is a kind of the electronic game. Broadly speaking, all instant interactive games with action elements belong to the action game, such as a shooting game and a sports game. In a narrow sense, it is a game in which physical fighting and a cold weapon are the main fighting mode.

With the popularity of the mobile terminal, there have been many shooting games adapted to the mobile touch-control terminal in recent years. However, compared with shooting games, which mainly take the ranged shooting as the main combat mode, games with physical fighting and the cold weapon as the main combat mode have more diverse combat attack modes, more variable combat attack moves, and more flexible offensive and defensive conversion.

Limited by the man-machine interaction mode of touch control, the related technical solutions of physical fighting and/or cold weapon fighting control of the virtual character in the touch-control terminal may have the following technical problems: when the player controls the virtual characters to change attack moves or perform the attack and defense conversion, the operation is not consistent enough, and is easy to touch by mistake.

### SUMMARY

The present disclosure provides a virtual character control method, a virtual character control apparatus, an electronic device and a non-transitory computer-readable storage medium.

In a first aspect, one or more embodiment of the present disclosure provides a virtual character control method. The method includes: displaying a first attack control on a graphical user interface; and in response to a first touch-control operation acting on the first attack control, if the first touch-control operation is a click operation, controlling the virtual character to perform a first attack action corresponding to the first attack control; and if the first touch-control operation is a sliding operation, determining a first target action from a first action set according to the sliding operation, and controlling the virtual character to perform the first target action.

In a third aspect, one or more embodiment of the present disclosure also provides an electronic device, which includes a processor and a memory, where the memory stores a computer-executable instruction that may be executed by the processor, and the processor executes the computer-executable instruction to realize the virtual character control method as described above.

In the fourth aspect, one or more embodiment of the present disclosure also provides a non-transitory computer-readable storage medium, in which a computer-executable instruction is stored, and when the computer-executable instruction is called and executed by a processor, the computer-executable instruction causes the processor to realize the virtual character control method as described above.

### BRIEF DESCRIPTION OF THE DRAWINGS

In order to more clearly illustrate the specific embodiments of the present disclosure or the technical solution in the related art, the accompanying drawings required to be used in the description of the specific embodiments or the related art will be briefly introduced as follows. Obviously, the accompanying drawings in the following description are only some embodiments of the present disclosure, and other accompanying drawings may be obtained from these accompanying drawings without any creative effort for those skilled in the art.

FIG. 1 is a flowchart of a virtual character control method provided by one or more embodiment of the present disclosure;

FIG. 2 is a flowchart of another virtual character control method provided by one or more embodiment of the present disclosure;

FIG. 3 is a schematic diagram of a graphical user interface provided by one or more embodiment of the present disclosure;

FIG. 4 is a flowchart of another virtual character control method provided by one or more embodiment of the present disclosure;

FIG. 5 is a schematic diagram of a graphical user interface corresponding to a near-field fighting scene provided by one or more embodiment of the present disclosure;

FIG. 6 is a schematic diagram of a graphical user interface corresponding to another near-field fighting scene provided by one or more embodiment of the present disclosure;

FIG. 7 is a schematic diagram of another graphical user interface provided by one or more embodiment of the present disclosure;

FIG. 8 is a schematic diagram of another graphical user interface provided by one or more embodiment of the present disclosure;

FIG. 9 is a schematic diagram of an attack scene provided by one or more embodiment of the present disclosure;

FIG. 10 is a schematic diagram of another graphical user interface provided by one or more embodiment of the present disclosure;

FIG. 11 is a schematic diagram of another graphical user interface provided by one or more embodiment of the present disclosure;

FIG. 12 is a flowchart of another virtual character control method provided by one or more embodiment of the present disclosure;

FIG. 13 is a flowchart of another virtual character control method provided by one or more embodiment of the present disclosure;

FIG. 14 is a schematic diagram of a definition mode of an action subset and a character state provided by one or more embodiment of the present disclosure;

FIG. 15 is a schematic diagram of another definition mode of the action subset and the character state provided by one or more embodiment of the present disclosure;

FIG. 16 is a schematic diagram of another definition mode of the action subset and the character state provided by one or more embodiment of the present disclosure;

FIG. 17 is a flowchart of another virtual character control method provided by one or more embodiment of the present disclosure;

FIG. 18 is a schematic diagram of a customized editing interface of an action set provided by one or more embodiment of the present disclosure;

FIG. 19 is a schematic diagram of an editing interface of a corresponding relationship between a virtual weapon and an action set provided by one or more embodiment of the present disclosure;

FIG. 20 is a schematic structural diagram of a virtual character control apparatus provided by one or more embodiment of the present disclosure;

FIG. 21 is a schematic structural diagram of another virtual character control apparatus provided by one or more embodiment of the present disclosure;

FIG. 22 is a schematic structural diagram of another virtual character control apparatus provided by one or more embodiment of the present disclosure; and

FIG. 23 is a schematic structural diagram of an electronic device provided by one or more embodiment of the present disclosure.

### DETAILED DESCRIPTION

The technical solution of the present disclosure will be clearly and completely described in combination with embodiments. Obviously, the described embodiments are part of the embodiments of the present disclosure, but not all. Based on the embodiments in the present disclosure, all other embodiments obtained by those skilled in the art without creative work belong to the scope of protection in the present disclosure.

First, the terms involved in the present disclosure are introduced.

### (1) Virtual Scene (Game Scene)

A virtual scene is a virtual scene displayed (or provided) when an application runs on a terminal or server. In at least one embodiment, the virtual scene is a simulation environment of a real world, or a semi-simulated and semi-fictional virtual environment, or a purely fictional virtual environment. The virtual scene is any one of a two-dimensional (2D) virtual scene, a 2.5-dimensional (2.5D) virtual scene and a three-dimensional virtual scene, and the virtual environment may be sky, land, ocean, etc., where the land includes an environmental element such as desert and city. The virtual scene is a scene in which the user controls the virtual object to complete the game logic. For example, in a sandbox 3D shooting game, the virtual scene is a 3D game world for the player to control the virtual object to battle. Example virtual scenes may include at least one element of mountains, rivers, lakes, oceans, deserts, skies, plants, buildings and vehicles. For example, in 2D or 2.5D card games, the virtual scene is a scene for displaying released cards or displaying virtual objects corresponding to the cards. Example virtual scenes may include: an arena field, a decisive battle field, or other “field” elements that may show the card's battle states or other elements. For 2D or 2.5D multiplayer online tactical competitive games, the virtual scene is a 2D or 2.5D terrain scene for the virtual object to battle. Example virtual scenes may include canyon-style mountains, routes, rivers, classrooms, desks and chairs, platforms and other elements.

### (2) Game Interface

The game interface refers to an interface corresponding to an application program provided or displayed through a graphical user interface, and the interface includes a UI interface and a game screen for the player to interact. In an alternative embodiment, the UI interface may include a game control (for example, a skill control, a movement control, a function control, etc.), an indication identification (for example, a direction indication identification, a character indication identification, etc.), an information display region (for example, kill count, competition time, etc.), or a game setting control (for example, a system setting, a shop, a gold coin, etc.). In an alternative embodiment, the game screen is a display screen corresponding to the virtual scene displayed by the terminal device, and the game screen may include virtual objects such as a game character, an NPC character, an AI character and the like that perform the game logic in the virtual scene.

### (3) Virtual Object

A virtual object refers to a dynamic object that may be controlled in a virtual scene. In at least one embodiment, the dynamic object may be a virtual role, a virtual animal, a cartoon role, and the like. The virtual object is a character controlled by a player through an input device, or is an artificial intelligence (AI) provided in a battle of a virtual environment through training, or a non-player character (NPC) provided in the battle of the virtual scene. In at least one embodiment, the virtual object is a virtual role performing competition in the virtual scene. In at least one embodiment, the number of virtual objects in the battle of the virtual scene is preset, or is dynamically determined according to the number of clients that join in the battle, which is not limited in the embodiments of the present disclosure. In one possible implementation, the user may control the virtual object to move in the virtual scene, for example, may control the virtual object to run, jump, crawl, etc., and may also control the virtual object to battle with other virtual objects using skills, virtual props, and the like provided by the application program.

### (4) Player Character

A player character refers to a virtual object that may be manipulated by a player to move in a game environment. The player character is also called a player virtual character or a player virtual object. In some electronic games, the player character may also be called a shikigami character or a hero character. The player character may be at least one of different forms such as a virtual role, a virtual animal and a virtual vehicle.

In a long-term research and development process, the applicant of the present disclosure found that, limited by a man-machine interaction mode of the touch control, the related technical solution of physical fighting and/or cold weapon fighting control of the virtual character in the touch-control terminal may have the following technical problems: when the player controls the virtual character to change attack moves or perform the attack and defense conversion, the operation is not consistent enough, and is easy to touch by mistake. The present disclosure provides a virtual character control method, apparatus, electronic device and a non-transitory computer-readable storage medium, so as to at least partially solve the shortcomings in related technical solutions.

According to the virtual character control method of the present disclosure, a control operation for the virtual character is received through a touch-control terminal device.

As a possible implementation, a control logic code of the virtual character may run on a touch-control terminal device or a server. The touch-control terminal device may be a local terminal device. When the virtual character control method runs on the server, the method may be implemented and executed based on a cloud interactive system, where the cloud interactive system includes a server and a client device.

In an alternative implementation, various cloud applications, such as a cloud game, may be run under the cloud interactive system. Take the cloud game as an example. The cloud game refers to a game based on the cloud computing. In a running mode of the cloud game, a running entity of the game program and the presenting subject of the game screen are separated, the storage and running of the virtual character control method are implemented on the cloud game server, and the client device is used for receiving and sending data and presenting the game screen. For example, the client device may be a display device with data transmission function near the user side, such as a mobile terminal, a television, a computer, a palmtop, etc. But a terminal device for information processing is a cloud game server in the cloud. When playing a game, the player operates the client device to send an operation instruction to the cloud game server, and the cloud game server runs the game according to the operation instruction, encodes and compresses data such as the game screen, and returns the data to the client device through the network, and finally decodes and outputs the game screen through the client device.

In an alternative implementation, the terminal device may be a local terminal device. Taking a game as an example, the local terminal device stores a game program and is used to present a game screen. The local terminal device is used to interact with a player through a graphical user interface, and that is, to download and install the game program and run it in a conventional manner through an electronic device. The local terminal device may provide the graphical user interface to the player in various ways, for example, the graphical user interface may be rendered and displayed on a display screen of the terminal, or the graphical user interface may be provided to the player through holographic projection. For example, the local terminal device may include a display screen for presenting the graphical user interface including the game screen and a processor for running the game, generating the graphical user interface and controlling the display of the graphical user interface on the display screen.

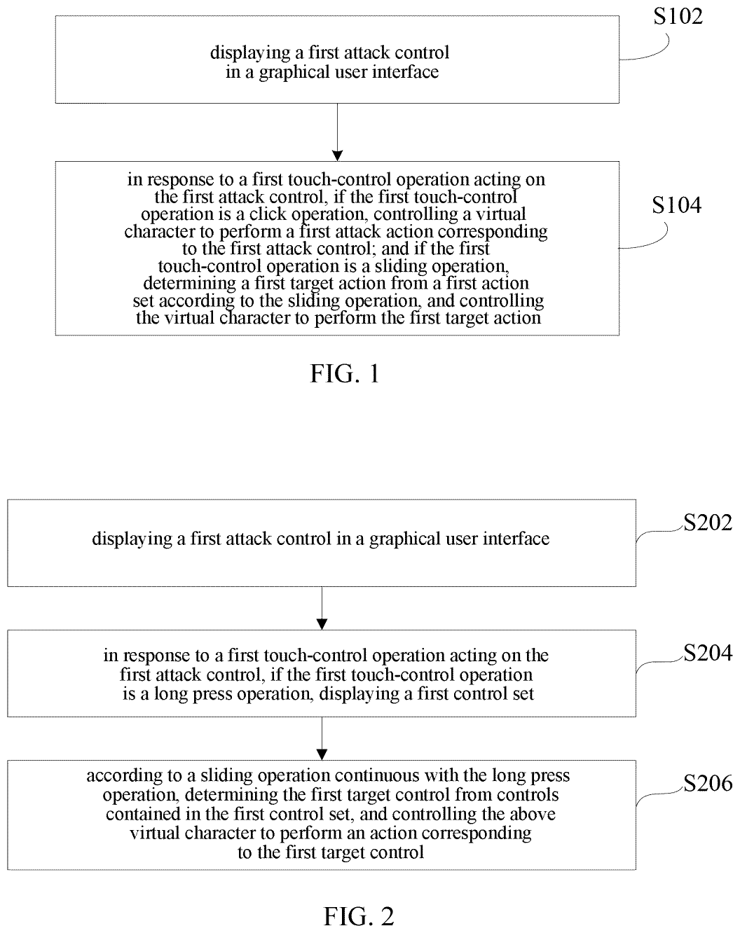

In a possible implementation, an embodiment of the present disclosure provides a virtual character control method, which provides a graphical user interface through a touch-control terminal, where the touch-control terminal may be the aforementioned local terminal device or the aforementioned client device in the cloud interaction system. Referring to FIG. 1, a virtual character control method in one or more embodiment of the present disclosure includes the following steps S102-S104.

In step S102, a first attack control is displayed on a graphical user interface.

The embodiments provide the graphical user interface through the touch-control terminal. In at least one embodiment, the graphical user interface includes at least a part of the game scene and a virtual character (specifically referring to a player virtual character here) in addition to the above-mentioned first attack control.

In step S104, in response to a first touch-control operation acting on the first attack control, if the first touch-control operation is a click operation, a virtual character is controlled to perform a first attack action corresponding to the first attack control; and if the first touch-control operation is a sliding operation, a first target action is determined from a first action set according to the sliding operation, and the virtual character is controlled to perform the first target action.

According to the above-mentioned method, by displaying the first attack control on the touch-control graphical user interface, the user controls the virtual character to perform the first attack action by touching the control. The user may also determine the first target action from the first action set by touching the first attack control, and control the virtual character to perform the first target action. That is, the first attack control may not only control the virtual character to perform the first attack action, but also control the virtual character to perform the first target action. Specifically, if a first touch-control operation on the first attack control is a click operation, the virtual character is controlled to perform the first attack action. If the first touch-control operation is a sliding operation, the first target action is determined from the first action set according to the sliding operation, and the virtual character is controlled to perform the first target action. The first target action may be the first attack action as described above or other actions. If the user needs to control the virtual character to perform the first attack action, he/she may click the first attack control originally displayed in the graphical user interface. If the user needs to control the virtual character to perform a jump action, a defensive action and other actions, it may be implemented not only by a jump control and a defensive control originally displayed in the touch graphical user interface, but also by performing a sliding operation on the first attack control. The above-mentioned way of determining the first target action from the first action set according to the sliding operation enables the user to realize a connection between the first attack action and the first target action more quickly and continuously. When it is necessary to control the virtual character to perform a certain action in the first action set, the first target action may be accurately determined from the first action set according to the sliding operation only via the sliding operation acting on the first attack control, without the need for the user to lift his finger and click other controls of the graphical user interface. During the whole process from the first attack action to the first target action of the virtual character, it is not necessary for the user to find and locate another control (a control corresponding to actions such as a defensive action and a jump action) in the interface, and the first target action may be easily determined from the first action set through the sliding operation on the first attack control, so as to control the virtual character to perform the first target action, thus realizing a rapid control of the virtual character, such as quickly controlling an attack move transformation or an attack and defense conversion. In such operation process, the user may realize control switching without lifting his finger and shifting his gaze, and the user may react quickly in the interaction, operate more conveniently, which effectively alleviates a problem of misoperation caused by relatively more interface controls. Such way of quickly controlling the virtual character also improves a consistency of user operations.

The first target action here may be a non-aggressive action, such as a jump action, a counter action, an evasive action, a sliding tackle action, a crawling action or a crouching action.

A corresponding relationship between actions in the first action set and the sliding operation may be preset, and different modes of the sliding operation may correspond to different actions. For example, actions in the first action set correspond to sliding directions of the sliding operation, and the sliding directions of the sliding operation acting on the first attack control are different, and thus the first target actions determined from the first action set according to the sliding operation are different. Based on this, the first action set includes direction information and action information corresponding to the direction information. Accordingly, the determining the first target action from the first action set according to the sliding operation includes determining an action in the first action set that matches a direction of the sliding operation as the first target action.

The direction information included in the first action set may be at least two directions of up, down, left and right, or at least two directions of upper left, up, upper right, right, lower right, down, lower left and left, and each direction corresponds to an action. For example, the first action set includes a jump action and a crouching action, where the direction information of the jump action is upward and the direction information of the crouching action is downward, such that an upward sliding operation corresponds to the jump action and a downward sliding operation corresponds to the crouching action. When a first touch-control operation for the first attack control is the upward sliding operation, the first target action is determined as the jump action from the first action set, and the virtual character is controlled to perform the jump action. Similarly, when the first touch-control operation for the first attack control is the downward sliding operation, the first target action is determined as the crouching action from the first action set, and the virtual character is controlled to perform the crouching action.

By matching the action information in the first action set with the direction information, the actions in the first action set may be matched according to the direction of the sliding operation acting on the first attack control, such as taking an action corresponding to the same direction of the sliding operation as the first target action, such that an action direction of the first target action is consistent with the direction of the sliding operation, which is more in line with the user's operating habits and reduces the memorization cost for a corresponding relationship between the sliding operation and the target action.

The above-mentioned determining the first target action from the first action set according to the sliding operation includes determining the first target action from the first action set according to the sliding operation and a state of the virtual character. The state of the virtual character mainly includes information about the movement of the virtual character, for example, the state of the virtual character may include a position state and/or a posture of the virtual character. The position state may include a ground state and a hovering state, etc. In at least one embodiment, the hovering state refers to an unsupported mid-air state of a virtual character in a virtual scene, for example, the virtual character jumps and rises into the air. The ground state refers to a state that the virtual character is supported in the virtual scene, for example, a state that the virtual character steps on the ground (that is, the ground supports the virtual character). Postures may include: an upright state, a crouching state, a lying down state, a jumping state, etc. In this way, a correlation between the state of the virtual character and the next action that the virtual character is suitable to perform is considered, which further simplifies the user's operation and memorization cost.

In at least one embodiment, the above-mentioned first action set includes at least two action subsets, and each action subset corresponds to a state of the virtual character. Based on this, the above-mentioned determining the first target action from the first action set according to the sliding operation and the state of the virtual character includes: determining a target action subset from the first action set according to the state of the virtual character; and determining the first target action from the target action subset according to the sliding operation. By dividing the actions in the first action set into a plurality of action subsets according to the virtual character state, the actions may be divided more finely when controlling the virtual character to perform the actions, such that the control of the virtual character is more accurate.

For example, the state of the virtual character includes the ground state and the hovering state, and the first action set corresponding to the first attack control includes two action subsets, namely, a first action subset corresponding to the ground state and a second action subset corresponding to the hovering state. The first action subset may include a counter action, an evasive action, a grand upper attack action, etc. The second action subset may include a counter action, a downward chopping attack action and an evasive action, etc. The state of the virtual character may be set based on the identity or actual needs of the virtual character, which is not limited by the embodiments of the present disclosure.

In at least one embodiment, the above-mentioned first action set is a user-defined set. The users may customize the first action set according to their usage habit, virtual character identity and personal preference. The definition process may include a corresponding relationship between the action in the first action set and the direction of sliding operation, as well as a corresponding relationship between the action subset in the first action set and the virtual character state.

In addition to the above-mentioned first attack control, the above-mentioned graphical user interface may also include other controls, which may be resident controls or non-resident controls. Based on this, the above-mentioned method also includes: displaying the first control on the graphical user interface; and controlling the virtual character to perform an action corresponding to the first control in response to the second touch-control operation acting on the first control.

The second touch-control operation here may be a click operation, a double click operation, a vigorously press operation or a long press operation, etc., which may be flexibly set according to the needs of game design, and this is not limited by the embodiments of the present disclosure.

When the touch-control terminal receives the second touch-control operation acting on the first control, the virtual character is controlled to perform an action corresponding to the first control, where the action corresponding to the first control is a pre-configured action of the control, such as a posture control action or a defensive action, and the direction of the action is usually the current direction of the virtual character, and the orientation of the virtual character may be controlled by a movement control (such as a movement rocker).

For example, if the first control is an evasion control, the action corresponding to the first control is an evasive action, and a direction of the evasive action is the current direction of the virtual character. As a possible implementation, when the first control is an evasion control, the evasion control may also be a directional control, that is, the evasion control is configured with a default evasive direction, and a direction of the evasive action of the virtual character is the default evasive direction. In at least one embodiment, as another possible embodiment, a type of the second touch-control operation acting on the first control (i.e., the evasion control) determines an evasive direction of the evasive action. For example, if the second touch-control operation is a left sliding operation, the virtual character evades to the left; if the second touch-control operation is a sliding operation to the right, the virtual character evades to the right; and if that second touch-control operation is a click operation, the virtual character evades towards the current direction of the virtual character.

As a possible implementation, the above-mentioned first action set includes an action corresponding to the first control.

Considering that in the fighting scene, a touch-control operation is performed on a first attack control to control the virtual character to perform an attack action. During the attack process, sometimes it is needed to avoid or defend an enemy's attack, and sometimes it is needed to change different attack modes, so it is also needed to switch controls to realize a transformation of attack modes, and to avoid or defend while attacking. In order to avoid an excessive movement of the player's line of sight when switching between the controls, in this embodiment, even when a first control is displayed on the graphical user interface, since the first action set includes an action corresponding to the first control, the user may determine the action corresponding to the first control as the first target action from a first action set through a sliding operation acting on the first attack control, and then the virtual character may be controlled to perform the action corresponding to the first control without switching from the first attack control to the first control, such that the player may control the virtual character to change attack moves or attack-defense conversion continuously and accurately. For example, after the player controls the virtual character to perform an attack action through the first attack control, and the player wants to control the virtual character to perform a defensive action according to the change of the surrounding combat situation, the defensive action may be determined from the first action set corresponding to the first attack control through a sliding operation acting on the first attack control, and a conversion from attack to defense may be quickly implemented. There is no need for the player's touch finger to be lifted from the first attack control to move to the defensive control of the device in the graphical user interface for performing a click operation, which improves the continuity of the conversion from attack to defense, reduces the difficulty for the user to find the defensive control in the graphical user interface during the combat, and reduces a possibility of misoperation.

In at least one embodiment, the above-mentioned method includes the following steps: if the first touch-control operation is a long press operation, displaying a first control set, and determining a first target control from the controls included in the first control set according to a sliding operation continuous with the long press operation, and controlling the virtual character to perform an action corresponding to the first target control (i.e. the first target action), where the controls included in the first control set correspond to actions included in the first action set, i.e. the first action set is a set of actions corresponding to each control in the first control set. In this way, the user may determine the first target action in the first action set more intuitively and clearly, reduce the memorization cost and improve the accuracy of operation.

The long press operation may be an operation in which a touch duration of contact between a touch medium (e.g., a finger) and the control is longer than a time threshold, and the time threshold may be 0.2 second, 0.3 second, 0.5 second and other times set by the game developer or user.

The above-mentioned sliding operation continuous with the long press operation means that the first touch-control operation may include two stages. A first stage is the long press operation, and a second stage is the sliding operation. During the operation of the two stages, the finger does not lift (does not leave the touch screen), such that the long press operation and the sliding operation are operationally consistent.

The above-mentioned display mode of the first control set enables the user to determine the position of each control in the control set more intuitively and clearly. When a control in the first control set needs to be operated, a first target control may be accurately determined from the first control set only by a sliding operation, without the user lifting his finger and clicking on other controls in the graphical interface. During the whole process, the first touch-control operation (a long press operation+a sliding operation) on the first attack control may easily determine the first target control from the first control set with no need for the user to locate another control (a control corresponding to the defensive action, jump action, etc.) in the interface, and then trigger the virtual character to perform the first target action corresponding to the first target control, thus realizing a rapid control of the virtual character, such as quickly controlling the attack move transformation or the attack and defense conversion.

An embodiment of the present disclosure shown in FIG. 2 provides another virtual character control method, which includes the following steps S202-S206.

In step S202, a first attack control is displayed on a graphical user interface.

In step S204, in response to a first touch-control operation acting on the first attack control, if the first touch-control operation is a long press operation, a first control set is displayed.

In step S206, according to a sliding operation continuous with the long press operation, the first target control is determined from controls included in the first control set, and the virtual character is controlled to perform an action corresponding to the first target control.

The controls included in the first control set correspond to actions included in a first action set.

The method shown in FIG. 2 is similar to the method shown in FIG. 1. If the first touch-control operation is a click operation, the virtual character is controlled to perform a first attack action corresponding to the first attack control. If the first touch-control operation is a sliding operation, a first target action is determined from the first action set according to the sliding operation, and the virtual character is controlled to perform the first target action.

The above-mentioned method provides an intuitive reference for the user to operate the controls by performing a long press on the first control set displayed by the first attack control, such that the user may more intuitively and clearly determine the position of each control in the control set. When a control in the first control set is needed to be operated, the first target control may be accurately determined from the first control set by a sliding operation without the user lifting his finger and clicking on other controls in the graphical interface. In the whole process, the user may easily determine the first target control from the first control set without looking for another control in the interface (a control corresponding to a defensive action, a jump action, etc.), and then trigger the virtual character to perform an action corresponding to the first target control, thus realizing a rapid control of the virtual character and a consistency of operation, such as quickly controlling the attack move transformation or the attack and defense conversion.

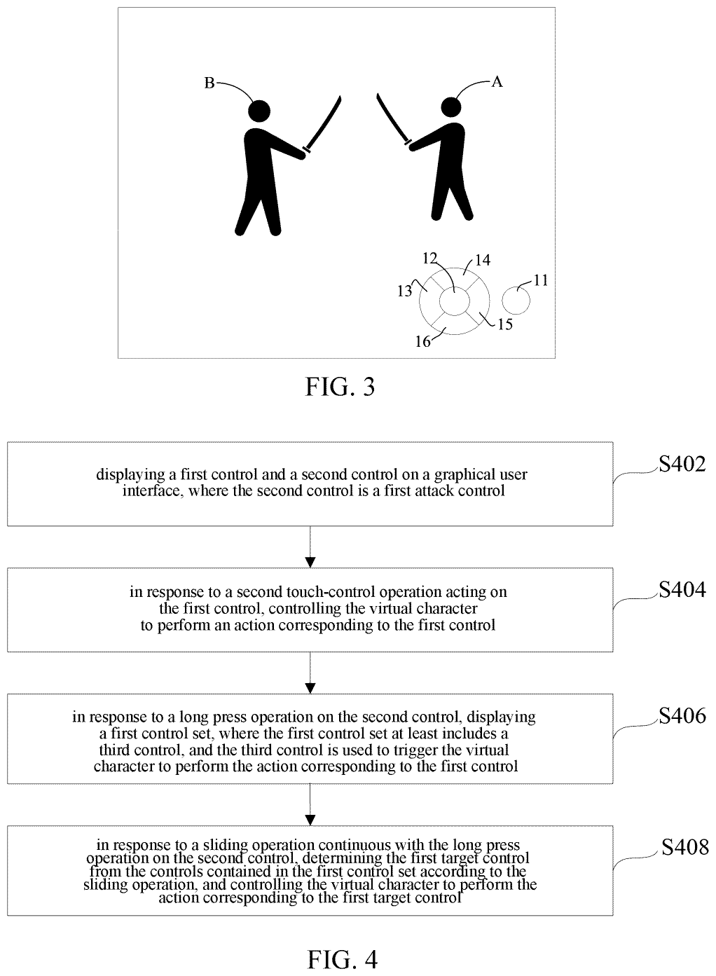

Referring to a schematic diagram of a graphical user interface in an alternative embodiment shown in FIG. 3, which includes a virtual character A (that is, the above-mentioned virtual character, which is a player virtual character) and a virtual character B fighting against the virtual character A. The first control 11 and the second control 12 (that is, the first attack control) are displayed in a lower right corner of the graphical user interface, and a finger of the player performs a long presses on the second control 12 to display a first control set on a periphery of the second control 12. The first control set includes a control 13 (that is, a third control that has a same action as the above-mentioned first control). If the finger of the player then slides from the second control 12 to the control 13 subsequent to a long press operation, the touch-control terminal controls the virtual character to perform the action corresponding to the first control.

As a possible implementation, the first control set may also include other controls, such as a control 14, a control 15 and a control 16 in FIG. 3. These other controls are used to trigger the virtual character to perform other attack actions or trigger the virtual character to perform an evasive action or a defensive action.

In the above embodiments, whether the first control set is displayed, during the operation, the user may realize control switching without lifting his finger and shifting his gaze, so the user may react quickly in the interaction, and operate more conveniently, which effectively alleviates a problem of misoperation caused by relatively more interface controls. Such way of quickly controlling the virtual character also improves a consistency of user operations.

An embodiment of the present disclosure provides another virtual character control method, which provides a graphical user interface through a touch-control terminal, where the touch-control terminal may be the aforementioned local terminal device or the aforementioned client device in the cloud interaction system. Referring to FIG. 4, a virtual character control method according to another embodiment of the present disclosure includes the following steps S402-S408.

In step S402, a first control and a second control are displayed on a graphical user interface, where the second control is a first attack control.

The embodiment provides a graphical user interface through a touch-control terminal. In at least one embodiment, the graphical user interface includes at least a part of a game scene and a virtual character (specifically referring to a player virtual character here) in addition to the above-mentioned first control and second control. The first control here may be a resident control other than an attack control, such as a jump control, a counter control, an evasion control, a sliding tackle control, a crawl control or a crouch control.

In step S404, in response to a second touch-control operation acting on the first control, the virtual character is controlled to perform an action corresponding to the first control.

The second touch-control operation here may be a click operation, a double click operation, a vigorously press operation or a long press operation, etc., which may be flexibly set according to the needs of a game design, and this is not limited by the embodiments of the present disclosure.

In step S406, in response to a long press operation on the second control, a first control set is displayed, where the first control set at least includes a third control, and the third control is used to trigger the virtual character to perform the action corresponding to the first control.

The third control and the first control are visually identical. For example, an icon of the third control is the same as an icon of the first control. In at least one embodiment, the third control is visually different from the first control. For example, when both the first control and the third control correspond to the evasive action, an evasive graphic in the icon of the first control is filled with green, while an evasive graphic in the icon of the third control is filled with red. In at least one embodiment, the icon of the first control is a circular icon and the icon of the third control is a fan icon.

If a touch-control operation acting on the second control is a click operation, the first control set is not displayed, and the virtual character is controlled to perform a first attack action corresponding to the second control.

In at least one embodiment, the click operation here is an operation that acts on the second control for a duration within a preset time threshold.

In step S408, in response to a sliding operation continuous with the long press operation on the second control, the first target control is determined from the controls included in the first control set according to the sliding operation, and the virtual character is controlled to perform the action corresponding to the first target control.

In at least one embodiment, the above-mentioned sliding operation refers to an operation that a moving track length of a touch point of the touch-control operation acting on the second control exceeds a preset length threshold. A specific determination method of the first target control may take a control pointed by the sliding operation as the first target control, or a control corresponding to a position where the touch point is located at an end of the sliding operation as the first target control.

In the embodiment of the present disclosure, in a virtual character control method corresponding to the above-mentioned FIG. 4, a user (player) may control a virtual character to perform an action (such as a jump action, a defensive action, etc.) corresponding to the first control by touching a first control in a graphical user interface. The user performs a long press on a first attack control (i.e. a second control) in the graphical user interface to display the control set corresponding to the first attack control (denoted by a first control set). The first control set includes a third control that may be used to trigger and control the virtual character to perform an action corresponding to the first control. If the touch-control operation acting on the second control is a click operation, the virtual character may be controlled to perform the first attack action. If the long press operation acting on the second control is followed by a sliding operation, a first target control is determined from controls included in the first control set according to the sliding operation, and the virtual character is controlled to perform an action corresponding to the first target control. If the first target control is a third control in the first control set, the virtual character may be controlled to perform the action corresponding to the first control in the graphical user interface. In this way, if the user needs to control the virtual character to perform the first attack action, he/she may click the first attack control originally displayed on the graphical user interface. The control set corresponding to the first attack control (denoted by the first control set) may be displayed by performing a long press on the first attack control. The first control set includes the third control that may be used to trigger and control the virtual character to perform an action corresponding to the first control. If the user needs to control the virtual character to perform a jump action, a defensive action and other actions, it may be implemented by touching the first control originally displayed on the graphical user interface, or the virtual character may be controlled to perform the jump action, the defensive action and the other actions through the third control in the control set (denoted by the first control set) triggered by a sliding operation acting on the first attack control. The above-mentioned first control set displayed may enable the user to determine a position of each control in the control set more intuitively and clearly. When a control in the first control set needs to be operated, the first target control may be accurately determined from the first control set according to the sliding operation without the user lifting his finger and clicking on other controls in the graphical interface. During the whole process, the user does not need to find and locate another control (a control corresponding to a defensive action, a jump action, etc.) in the interface, and the sliding operation on the second control may easily determine the first target control from the first control set, thus triggering the virtual character to perform an action corresponding to the first target control, and realizing a rapid control of the virtual character, such as quickly controlling an attack move transformation or an attack and defense conversion. The first control set may be displayed in the case that the second control is pressed for a long time, which provides an intuitive reference for the user to operate the control. The user does not need to remember an operation mode of triggering a control in the first control set, but may slide towards which control in the first control set needs to be operated. If the user has memorized a corresponding relationship between each control in the first control set and a sliding operation direction, the user may not perform a long press on the second control, such that the first control set will not be displayed, which reduces an occlusion of the interface by the first control set to a certain extent and improves a switching speed and a consistency of actions of the virtual character to a certain extent.

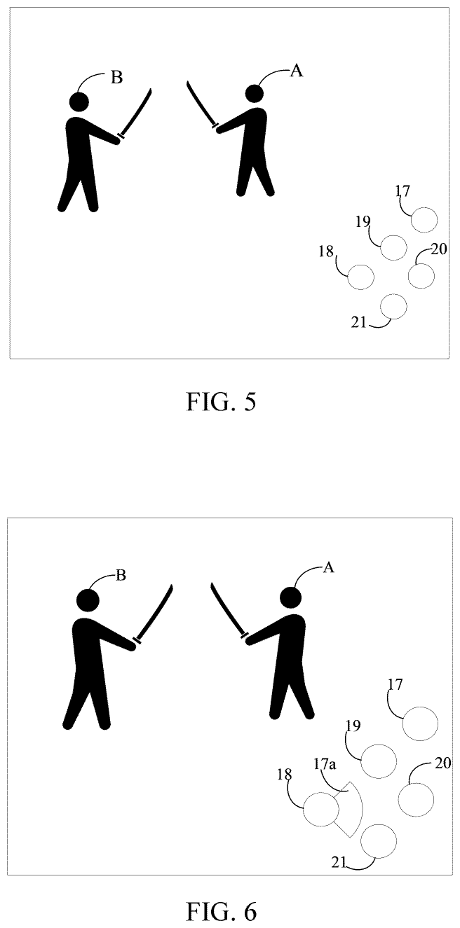

Referring to a schematic diagram of a graphical user interface corresponding to a near-field fighting scene shown in FIG. 5, a counter control 17 (corresponding to the above-mentioned first control) and a horizontal attack control 18 (corresponding to the above-mentioned second control) are displayed on a lower right side of the graphical user interface, and a vertical attack control 19, an evasion control 20 and a jump control 21 are also displayed on the lower right side of the graphical user interface. Assuming that both a player virtual character A and an enemy virtual character B hold a long blade, and the player clicks the horizontal attack control continuously, the player virtual character A will horizontally attack the enemy virtual character B for many times in a row, or perform corresponding continuous attacks according to the times and a time interval of clicking the horizontal attack control 18. If the player finds that the enemy is about to make an ultimate skill (i.e., an attack with great harm), and the player wants to control the player virtual character A to counter (which is a defensive action of the character, usually used for when an enemy character is about to release an ultimate skill attack, the player making the character release the counter action by operating the counter control, so as to defend the ultimate skill of the enemy and knock out a weapon of the enemy), it is necessary to move the finger from the currently clicked horizontal attack control 18 to a resident counter control 17 in the interface for clicking. In this process, the finger needs to “lift-move-click the counter control”. Since there is a certain gap between the horizontal attack control 18 and the counter control 17, this process is time-consuming, not fast or consistent enough, and it is easy to make a wrong click, making it difficult to quickly and accurately click on the counter control

Based on the above-mentioned problems of not being fast or consistent, and being prone to making a wrong click, the embodiment provides a corresponding virtual character control method. Following the corresponding example in FIG. 5, if the player clicks the horizontal attack control 18 continuously, the player virtual character A will horizontally attack the enemy virtual character for many times in a row or perform corresponding continuous attacks according to the times and a time interval of clicking the horizontal attack control 18. In the embodiment, the horizontal attack control 18 corresponds to a first action set, which may include a counter action. The counter action corresponds to a rightward sliding direction. If the player finds that the enemy is about to make a ultimate skill and wants to control the virtual character A to counter, he/she may slide his finger from the horizontal attack control 18 to the right to control the virtual character A to switch from the attack action to the counter action. In the process of quickly switching the virtual character from the attack action to the counter action, the conversion is implemented by finger sliding operation, which is simple, fast and consistent, and reduces misoperation.

In at least one embodiment, based on the above-mentioned problems of not being fast or consistent, and being prone to making a wrong click, the embodiment provides another corresponding graphical user interface schematic diagram as shown in FIG. 6. Following the corresponding example in FIG. 5, when the horizontal attack control 18 is triggered by a long press (for example, the player may be ready to use a charge attack), the first control set including the counter control 17a will be displayed on a periphery of the horizontal attack control 18 of the embodiment, and the counter control 17a in the first control set is visually identical to the counter control 17 resident in the graphical user interface. If the player finds that the enemy is about to make a ultimate skill and wants to control the player virtual character A to counter, he/she may slide his finger from the horizontal attack control 18 to the counter control 17a in the first control set or move his finger from the horizontal attack control 18 to a direction where the counter control 17a in the first control set is located. In this process, the finger may perform a long-press operation and a sliding operation on the same control (i.e., the horizontal attack control 18), which is relatively simple, fast and consistent, and is not easy to make a wrong click.

As a possible implementation, the above-mentioned action corresponding to the first control is a non-aggressive action. The first control set displayed by triggering the second control (the control corresponding to the first attack action) includes a third control, and an action corresponding to the third control may also be a non-aggressive action. This way of including a control corresponding to the non-aggressive action in the control set corresponding to the attack control may quickly switch the virtual character from the attack action to the non-aggressive action, which may better meet the practical application needs.

The action corresponding to the above-mentioned first control is a defensive action, an evasive action, a jump action, a squat action, a sliding tackle action or a crawling action, etc. These actions are usually frequently used in a melee scene, and the convenience of operation may be better improved by taking them as the actions corresponding to the first control.

The defensive action, the evasive action, the jump action, the squat action, the sliding tackle action or the crawling action are common virtual actions in the game. The defensive action is an action that the player character defends against an attack to reduce the damage it takes. In at least one embodiment, the counter action is a defensive action that may make the attacking part's weapon fall. The evasive action is a quick movement of the player character in a short distance (usually predetermined by a game system or calculated by the game system) to avoid the enemy's attack. Usually, the evasive action is a quick movement, which is faster than a movement speed of the virtual character in a default situation. The default situation includes the virtual character's movement without a skill, a prop, a vehicle, etc. Usually, the distance is short, for example, 1 meter, 2 meters, 3 meters, 5 meters, 10 meters and other distances in the virtual environment. The short distance here is relative to other long-distance movements. For example, in some games, virtual characters may realize a long-distance movement in the virtual environment through props such as a fly rope. The virtual character may enter a state of fast running to move a long distance in the virtual environment, for example, a “continuous running” function that is common in some games. The jump action is an upward jump action of the player character. The squat action is an action of the player character crouching down. The sliding tackle action is an action of lowering a center of gravity of the player character (for example, squatting or leaning down) and sprinting. The crawling action is an action that the player character crouches down and moves.

In at least one embodiment, the above-mentioned method further includes: cancelling displaying the first control set. In this way, when the controls in the first control set do not need to be operated, the first control set is no longer displayed, and an unnecessary occlusion of the interface by the first control set is reduced.

As a possible implementation, the above-mentioned cancelling the display of the first control set may include: in response to an end of the first touch-control operation, cancelling the display of the first control set. In at least one embodiment, if the first touch-control operation is a click operation, the first control sets may not be displayed. If the first touch-control operation is an operation of long pressing first and then sliding, the display of the first control set is cancelled when the finger performing the sliding operation leaves the touch-control terminal screen. This way of cancelling the display of the first control set at the end of the first touch-control operation is simple and reasonable. After the end of the first touch-control operation, the controls in the first control set are no longer needed to be operated, so cancelling the display of the first control set in time may reduce the time that the first control set occupies the graphical user interface and optimize the graphical user interface.

In other examples, the step of cancelling the display of the first control set may further include one of the following: (1) cancelling the display of the first control set in response to a determination of the first target control; (2) when a duration of the first touch-control operation reaches a set time threshold, cancelling the display of the first control set; (3) in response to the virtual character performing the action corresponding to the first target control, cancelling the display of the first control set. The specific way to cancel displaying the first control set may be selected according to actual needs, and the embodiment does not limit this.

In at least one embodiment, the above-mentioned first action set includes a first subset of action and a second subset of action, where the first subset of action is an action set corresponding to resident controls in the graphical user interface, and the second subset of action is an action set corresponding to non-resident controls in the graphical user interface. During the game, a target action set may be determined from the first action set according to a state of the virtual character, and then a target action may be determined from the target action set according to the sliding operation. If the above-mentioned graphical user interface displays a first control set, as a possible implementation, the first control set includes a first control subset and a second control subset, controls included in the first control subsets are a subset of the resident controls, and controls included in the second control subsets are a subset of the non-resident controls. The above-mentioned method takes into account that the fighting scene in the game usually has a certain tendency, some games are more inclined to near-field fighting scenes, and some games are more inclined to the ranged fighting scenes. Therefore, according to the fighting scene inclined by a specific game, some controls are permanently displayed on the graphical user interface.

The first control and the second control (i.e., the first attack control) displayed on the graphical user interface may both be resident controls. In this way, the second control as the attack control is permanently displayed on the graphical user interface, and the first control as a non-attack control may also be permanently displayed on the graphical user interface. A control set corresponding to the second control (the first attack control) may include a third control, which is used to control the virtual character to perform the action corresponding to the first control. As a possible implementation, the above-mentioned first control set further includes a fourth control, and the first control set includes a first control subset and a second control subset. The first control subsets includes the third control, and the controls included in the first control subset are a subset of the resident controls, while the controls included in the second control subset are a subset of the non-resident controls. In the embodiment, the first control set is divided into the first control subset and the second control subset according to whether the control is resident or not, such that the non-resident control does not need to be continuously displayed on the graphical user interface, and may be displayed only through the display of the first control set, thus alleviating the problem of a large number of controls in the graphical user interface.

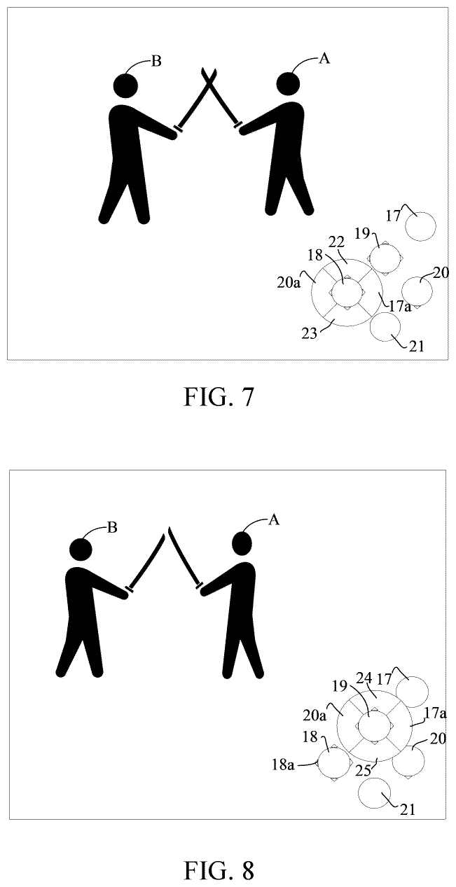

Referring to the schematic diagram of another graphical user interface shown in FIG. 7, on the basis of the above-mentioned FIG. 6, the first control set corresponding to the horizontal attack control 18 includes, in addition to the above-mentioned counter control 17a, an evasion control 20a, a jumping-horizontal attack combination control 22 and a crouching-horizontal attack combination control 23, where the counter control 17a and the evasion control 20a are controls in the first sub-control set, and the jumping-horizontal attack combination control 22 and the crouching-horizontal attack combination control 23 are controls in the second sub-control set. The jumping-horizontal attack combination control 22 is used to trigger the virtual character to perform a jump action and a horizontal attack action in turn, and the crouching-horizontal attack combination control 23 is used to trigger the virtual character to perform a crouch action and the horizontal attack action in turn.

In FIG. 7, the evasion control 20a in the first control set is located on a left side of the horizontal attack control 18, the counter control 17a is located on a right side of the horizontal attack control 18, the jumping-horizontal attack combination control 22 is located on an upper side of the horizontal attack control 18, and the crouching-horizontal attack combination control 23 is located on a lower side of the horizontal attack control 18. This layout of controls may make it easier for the player to distinguish the controls in the first control set. When the player clicks on the horizontal attack control 18 for one or more times to trigger the virtual character to perform the horizontal attack action, the player may continue to touch the horizontal attack control 18. The touch may be that the finger presses on the horizontal attack control 18 without releasing the finger, and the above-mentioned first control set as shown in FIG. 6 is displayed on the periphery of the horizontal attack control 18. According to the different operations of the player on the first control set as shown in FIG. 7, there are several situations as follows.

(1) A finger pressed on the horizontal attack control 18 slides to the right from a position where the horizontal attack control 18 is located, that is, the finger slides toward the counter control 17a, and after sliding to a certain extent, for example, a sliding distance is greater than a set distance threshold, the virtual character is controlled to perform a counter action corresponding to the counter control 17a. In this way, the virtual character may be switched from a horizontal attack action corresponding to the horizontal attack control 18 to a counter action corresponding to the counter control 17a, with no need for the player to search for the counter control 17a in controls resident in the graphical user interface, nor to change a falling position of the finger, which is smoother and more convenient in operation and in turn reduces the problem of accidental touches. In addition, if the virtual character is in a charge state of horizontal attack, through the above sliding operation to the right, the charge state of the virtual character is directly interrupted by the counter action, which realizes a rapid conversion of the virtual character from an attack state to a defense state.

(2) The finger pressed on the horizontal attack control 18 slides to the left from the position where the horizontal attack control 18 is located, that is, the finger slides toward the evasion control 20a, and after sliding to a certain extent, for example, sliding into an area where the evasion control 20a is located, the virtual character is controlled to perform an evasion action corresponding to the evasion control 20a. In this way, the virtual character may be switched from the horizontal attack action corresponding to the horizontal attack control 18 to an evasive action corresponding to the evasion control 20a, with no need for the player to search for the evasion control 20 in controls resident in the graphical user interface, nor to change a falling position of the finger. Similar to the above way, this switching mode of one-time sliding realizing corresponding actions of two controls is smoother and more convenient in operation. If the virtual character is in a process of the horizontal attack, through the above sliding operation to the left, the horizontal attack action of the virtual character may be directly interrupted by the evasive action, so as to realize a quick evasion and reduce the injury degree of the virtual character.

(3) The finger pressed on the horizontal attack control 18 slides upward from the position where the horizontal attack control 18 is located, that is, the finger slides toward the jumping-horizontal attack combination control 22, and after sliding to a certain extent, for example, sliding into an area where the jumping-horizontal attack combination control 22 is located and lifting the finger, the virtual character is controlled to perform a combined action of jumping and horizontal attack corresponding to the jumping-horizontal attack combination control 22. Through the displayed first control set, a sliding direction of the sliding operation may be determined, and the player may lift his finger when releasing the combined action of jumping and horizontal attack. The virtual character may be switched from the horizontal attack action corresponding to the horizontal attack control 18 to a jumping-horizontal attack action corresponding to the jumping-horizontal attack control 22, with no need for the player to lift his finger in the process of the sliding operation to click the jumping-horizontal attack combination control 22, which is smoother and more convenient to operate. Moreover, on the basis of the first horizontal attack of the virtual character, the attack mode may be adjusted according to a posture of the enemy character through the above sliding operation in the upward direction. For example, if the enemy character jumps up, the virtual character may perform a horizontal attack on the enemy character again while jumping up. This continuous attack mode with different postures may quickly change the attack moves. The jumping-horizontal attack combination control 22 located above the horizontal attack control 18 also takes the jumping direction being the upward direction into account in the setting position of the control, which is more in line with the operating habits.

(4) The finger pressed on the horizontal attack control 18 slides downwards from the position where the horizontal attack control 18 is located, that is, the finger slides toward the crouching-horizontal attack combination control 23, and after sliding to a certain extent, for example, sliding into an area where the crouching-horizontal attack combination control 23 is located, the virtual character is controlled to perform a combined action of crouching and horizontal attack corresponding to the crouching-horizontal attack combination control 23. A sliding direction of the sliding operation may be determined through the displayed first control set. Moreover, the virtual character may be switched from the horizontal attack action corresponding to the horizontal attack control 18 to a crouching-horizontal attack action corresponding to the crouching-horizontal attack combination control 23, with no need for the player to lift his finger in the process of the sliding operation to click the crouching-horizontal attack combination control 23, which is not only smoother and more convenient to operate, but also may adjust the virtual character's own attack mode according to the attack of the enemy character through the sliding operation in the downward direction on the basis of the first horizontal attack of the virtual character. For example, when the enemy character horizontally attacks, then the virtual character may horizontally attack the enemy character again while crouching, which may not only avoid the attack of the enemy character, but also cause the damage by the horizontal attack on the enemy character again, improve the probability of defeating the enemy character, and quickly change the attack moves.

The settings of the jumping-horizontal attack combination control and the crouching-horizontal attack combination control in the first control set above have an inherent logical relationship with the horizontal attack control. The horizontal attack control mainly serves the purpose of attacking the enemy character horizontally. Therefore, on this basis, the attack mode configured in the first control set is the horizontal attack, which mainly takes into account the player clicking on the horizontal attack control, and it is highly probable that a horizontal attack skill will be applied. Compared with clicking the horizontal attack control many times to realize combos, the setting mode of the jumping-horizontal attack combination control and the crouching-horizontal attack combination control may be faster and more convenient in operation and may be richer and more powerful in function, by combining the horizontal attack with an adjustment of the character posture. Moreover, the triggering mode of this combined action does not need to be implemented by two separate controls, and only needs to trigger the jumping-horizontal attack combination control or the crouching-horizontal attack combination control once, such that the triggering of the combined action may be implemented. Through the above method, the triggering efficiency is higher and the operation is simpler.

In at least one embodiment, the controls in the above-mentioned first control set may also be adjusted according to the user's attack habits. For example, the jumping-horizontal attack combination control and the crouching-horizontal attack combination control in the first control set may also be replaced by a jumping-vertical attack combination control and a crouching-vertical attack combination control. In at least one embodiment, only one of the jumping-horizontal attack combination control and the crouching-horizontal attack combination control may be replaced by a control with a vertical attack function, which may be a combination control or a separate vertical attack control.

Referring to a schematic diagram of another graphical user interface shown in FIG. 8, this embodiment takes the second control being a vertical attack control 19 as an example to explain. A first control set corresponding to the vertical attack control 19 includes a counter control 17a, an evasion control 20a, a jumping-vertical attack combination control 24 and a crouching-vertical attack combination control 25, where the counter control 17a and the evasion control 20a are controls in a first control subset, and the jumping-vertical attack combination control 24 and the crouching-vertical attack combination control 25 are controls in a second control subset. The jumping-vertical attack combination control 24 is used to trigger the above-mentioned virtual character to perform the jump action and a vertical attack action in turn, and the crouching-vertical attack combination control 25 is used to trigger the virtual character to perform the crouching action and the vertical attack action in turn.

In order to make it easier for the player to distinguish the controls in the first control set, in FIG. 8, the evasion control 20a in the first control set is located on a left side of the vertical attack control 19, the counter control 17a is located on a right side of the vertical attack control 19, the jumping-vertical attack combination control 24 is located on an upper side of the vertical attack control 19, and the crouching-vertical attack combination control 25 is located on a lower side of the vertical attack control 19. When the player clicks on the vertical attack control 19 for one or more times to trigger the virtual character to perform a vertical attack action, the player may continue to touch the vertical attack control 19. The touch may be that the finger presses on the vertical attack control 19, and the above-mentioned first control set as shown in FIG. 7 is displayed on the periphery of the vertical attack control 19 with no need to lift the finger. According to the different operations of the player on the first control set as shown in FIG. 8, there are the following situations.

(1) A finger pressed on the vertical attack control 19 slides to the right from a position where the vertical attack control 19 is located, that is, the finger slides toward the counter control 17a, and after sliding to a certain extent, for example, sliding into an area where the counter control 17a is located, the virtual character is immediately controlled to perform a counter action corresponding to the counter control 17a. In this way, the virtual character may be switched from a vertical attack action corresponding to the vertical attack control 19 to the counter action corresponding to the counter control 17a, with no need for the player to search for the counter control 17a in controls resident in the graphical user interface, nor to change a falling position of the finger, which is smoother and more convenient in operation and reduces the problem of accidental touches. In addition, if the character is in a charge state of vertical attack, through the above sliding operation to the right, the charge state of the virtual character is directly interrupted by the counter action, which realizes a rapid conversion of the virtual character from an attack state to a defense state.

(2) The finger pressed on the vertical attack control 19 slides to the left from the position where the vertical attack control 19 is located, that is, the finger slides toward the evasion control 20a in the first control set, and after sliding to a certain extent, for example, a sliding distance is greater than a preset distance threshold, the virtual character is controlled to perform an evasion action corresponding to the evasion control 20a. In this way, the virtual character may be switched from the vertical attack action corresponding to the vertical attack control 19 to the evasive action corresponding to the evasion control 20a, with no need for the player to search for the evasion control 20 in controls resident in the graphical user interface, nor to change a falling position of the finger. Similar to the above way, this switching mode of one-time sliding realizing corresponding actions of two controls is smoother and more convenient in operation. In addition, if the virtual character is in a process of the vertical attack, through the above sliding operation to the left, the vertical attack action of the virtual character may be directly interrupted by the evasive action, so as to realize a quick evasion and reduce the injury degree of the virtual character.

(3) The finger pressed on the vertical attack control 19 slides upward from the position where the vertical attack control 19 is located, that is, the finger slides toward the jumping-vertical attack combination control 24 in the first control set, and after sliding to a certain extent, for example, sliding into an area where the jumping-vertical attack combination control 24 is located and lifting the finger, the virtual character is controlled to perform a combined action of jumping and vertical attack corresponding to the jumping-vertical attack combination control 24. Through the displayed first control set, a sliding direction of the sliding operation may be determined, and the player may lift his finger when releasing the combined action of jumping and vertical attack. The virtual character may be switched from the vertical attack action corresponding to the vertical attack control 19 to a jumping-vertical attack action corresponding to the jumping-vertical attack control 24, with no need for the player to lift his finger in the process of the sliding operation to click the jumping-vertical attack control 24, which is smoother and more convenient to operate. Moreover, on the basis of the first vertical attack of the virtual character, through the above sliding operation in the upward direction, the attack mode may be adjusted according to a posture of the enemy character. For example, if the enemy character jumps up, the virtual character may vertically attack the enemy character again while jumping up. This continuous attack mode with different postures may quickly change the attack moves. The jumping-vertical attack combination control 24 located above the vertical attack control 19 also takes the jumping direction being the upward direction into account in the setting position of the control, which is more in line with the operating habits.

(4) The finger pressed on the vertical attack control 19 slides downwards from the position where the vertical attack control 19 is located, that is, the finger slides toward the crouching-vertical attack combination control 25, and after sliding to a certain extent, for example, sliding into an area where the crouching-vertical attack combination control 25 is located, the virtual character is controlled to perform a combined action of crouching and vertical attack corresponding to the crouching-vertical attack combination control 25. A sliding direction may be determined through the displayed first control set. Moreover, the virtual character may be switched from the vertical attack action corresponding to the vertical attack control 19 to a crouching-vertical attack action corresponding to the crouching-vertical attack combination control 25, with no need for the player to lift his finger in the process of the sliding operation to click the crouching-vertical attack combination control 25, which is not only smoother and more convenient to operate, but also may adjust the virtual character's own attack mode according to the attack of the enemy character through the sliding operation in the downward direction on the basis of the first vertical attack of the virtual character. For example, when the enemy character horizontally attacks, then the virtual character may vertically attack the enemy character again while crouching, which may not only avoid the horizontal attack of the enemy character, but also cause the damage by the vertical attack on the enemy character again, improve the probability of defeating the enemy character, and quickly change the attack moves.

The settings of the jumping-vertical attack combination control and the crouching-vertical attack combination control in the above-mentioned first control set have an inherent logical relationship with the vertical attack control. The vertical attack control mainly serves the purpose of attacking the enemy character vertically. Therefore, on this basis, the attack mode configured in the first control set is the vertical attack, which mainly takes into account the player clicking on the vertical attack control, and it is highly probable that a vertical attack skill will be applied. Compared with clicking the vertical attack control many times, the setting mode of the jumping-vertical attack combination control and the crouching-vertical attack combination control not only may perform the vertical attack action again without lifting the finger, but also may be faster and more convenient in operation and may be richer and more powerful in function, by combining the vertical attack with an adjustment of the character posture. In addition, the triggering mode of this combined action does not need to be implemented by two separate controls, and only needs to trigger the jumping-vertical attack combination control or the crouching-vertical attack combination control once, such that the triggering of the combined action may be implemented. Through the above method, the complexity of the operation is reduced, the triggering efficiency is higher, the operation is more simplified, and the fatigue of the player during the game is effectively reduced.

In at least one embodiment, the jumping-vertical attack combination control and the crouching-vertical attack combination control in the first control set corresponding to the vertical attack control may also be replaced with the jumping-horizontal attack combination control and the crouching-horizontal attack combination control according to the player's operation preference. In at least one embodiment, only one of the controls may be replaced by a control with a horizontal attack function, which may be a combination control or a separate horizontal attack control.

The above-mentioned graphical user interface includes a movement control area, and the movement control area and an operation area where the first attack control is located are located on both sides of the graphical user interface respectively. The controlling the virtual character to perform the evasive action (referring to an evasive action corresponding to the evasion control in the first control set here) may include: determining an evasive direction corresponding to the evasion control according to a character orientation control operation in the movement control area, and controlling the virtual character to perform an evasive action toward this evasive direction; or, according to a preset evasive direction of the evasion control, controlling the virtual character to perform evasive action toward a preset evasive direction. Specifically, in the above-mentioned (2) corresponding to FIG. 7 and FIG. 8, the evasion control in the first control set is triggered, and the following ways are given in the embodiment of the present disclosure to determine the direction of the evasive action.

(21) The evasive direction is determined by a movement rocker on the left (may also be the movement control area on the left). In this way, if the movement rocker is operated by a left hand, a direction of the character's evasive action is consistent with a control direction according to the movement rocker. For example, when a finger of a right hand slides to the left from the position of the horizontal attack control 18 to trigger the evasion control 20a in the first control set, if a finger of the left hand drags the movement rocker to the left, the virtual character turns left and performs an evasive action to the left at the current position.

(22) If the movement rocker is not controlled, the current orientation of the virtual character is determined as the evasive direction. In this way, when the evasion control 20a in the first control set is triggered, if the movement rocker is not operated by the left hand, the evasive action is performed in the current orientation direction of the virtual character.

(23) The evasion control has direction information, and the direction corresponding to the evasion control is determined as the evasive direction. In this way, no matter whether an operation action is performed on the movement rocker, it may be ignored and the virtual character is controlled to perform the evasive action in the direction corresponding to the evasion control. For example, if a direction in which the evasion control 20a in the first control set is configured is the right direction, when the evasion control 20a in the first control set is triggered, the virtual character is controlled to perform the evasive action toward the right side at the current position.

(24) The evasion control has direction information, and the evasive direction is determined according to the direction corresponding to the evasion control and a direction of operating the movement rocker. In this way, if the evasion control in the first control set is triggered and a control operation is performed on the movement rocker, the control direction of the movement rocker is given priority as the evasive direction. If the evasion control in the first control set is triggered and no control operation is performed on the movement rocker, the direction corresponding to the evasion control is taken as the evasive direction.

The direction of the evasion control may be configured by the player in the setting. If the player does not configure this item, the direction of the evasion control is a default direction.

The above-mentioned horizontal attack control and vertical attack control as the first attack control may simultaneously appear in the graphical user interface of the game as resident controls in the same game. Of course, in addition to the above-mentioned horizontal attack control and vertical attack control, other attack controls may also be resident controls or non-resident controls displayed on the graphical user interface of the game, and the other attack controls may also be configured with a control set similar to the above-mentioned first control set. Based on this, the above method may further include: displaying a fifth control on the graphical user interface, where the fifth control is a second attack control, and an attack angle of the first attack action corresponding to the first attack control is different from an attack angle of a second attack action corresponding to the second attack control.

An attack direction of the attack action is usually consistent with an orientation of the virtual character. The attack direction is used to guide the virtual character to attack which target object, and the attack angle of the attack action usually refers to a trajectory direction of an action trajectory of the attack action. For example, how to attack the target object, whether to attack from top to bottom or from left to right, etc.

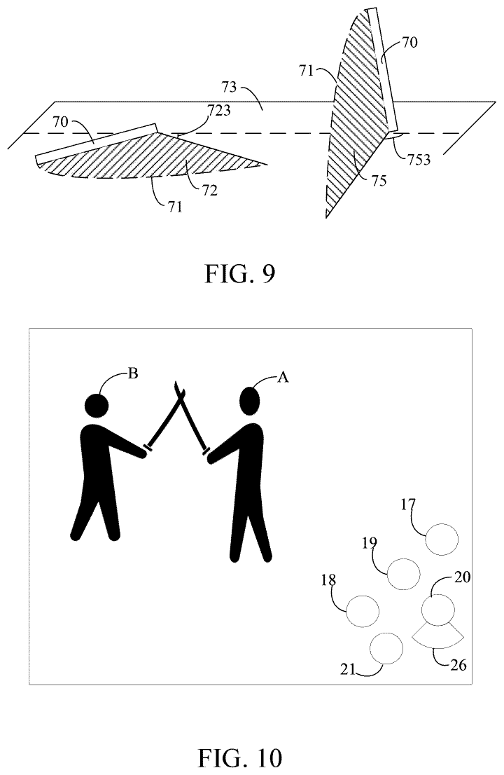

The first attack action is a melee attack action in which an included angle between a virtual attack damage surface (which may be a surface determined by a movement trajectory of the melee weapon in a three-dimensional virtual environment or a surface determined by a starting position and an ending position of a movement of the melee weapon in the three-dimensional virtual environment) and a specified plane (a ground plane and a horizontal plane) in the three-dimensional virtual environment is less than an angle threshold. The virtual attack damage surface may be a plane or a curved surface, and the above-mentioned included angle may be an included angle between the plane and the plane, or an included angle between a tangent plane corresponding to the curved surface and the plane. The second attack action is a melee attack action in which the included angle between the virtual attack damage surface determined according to the movement of the melee weapon in the three-dimensional virtual environment and the specified plane in the three-dimensional virtual environment is greater than the angle threshold. During the execution of the first attack action by the first virtual character, the target virtual character that collides with the virtual attack damage surface will be attacked by the first attack action. Referring to a schematic diagram of the attack scene shown in FIG. 9, the first attack action in FIG. 9 takes a horizontal attack action corresponding to a sword 70 as an example. A movement trajectory 71 of the sword 70 in the three-dimensional virtual environment determines the virtual attack damage surface 72, and the specified plane in the three-dimensional virtual environment is a horizontal plane 73, so the virtual attack damage surface 72 forms an included angle 723 with the horizontal plane 73. The second attack action takes a vertical attack action corresponding to the sword 70 as an example, and a virtual attack damage surface 75 is determined by a movement trajectory 74 of the sword 70 in the three-dimensional virtual environment, such that the virtual attack damage surface 75 forms an included angle 753 with the horizontal plane 73. The included angle 753 formed between the virtual attack damage surface 75 of the vertical attack action and the horizontal plane 73 is larger than the included angle 723 formed between the virtual attack damage surface 72 of the horizontal attack action and the horizontal plane 73.

Similar to the first attack control, on the basis of displaying the second attack control on the graphical user interface, the method further includes the following steps: in response to a third touch-control operation on the second attack control, if the third touch-control operation is a click operation, controlling the virtual character to perform a second attack action corresponding to the second attack control; and if the third touch-control operation is a sliding operation, determining a second target action from the second action set according to the sliding operation, and controlling the virtual character to perform the second target action, and if the third touch-control operation is a long press operation, displaying a second control set, and determining a second target control from controls included in the second control set according to a sliding operation continuous with the long press operation, and controlling the virtual character to perform an action corresponding to the second target control. The controls included in the second control set correspond to the action included in the second action set. The second control set may include the third control, and the third control is used to trigger the virtual character to perform the action corresponding to the first control.

In the embodiment, by displaying the second attack control (i.e., the fifth control) on the graphical user interface, the user (player) may control the virtual character to perform an action (such as a horizontal attack, a vertical attack, etc.) with an attack angle corresponding to the second attack control by touching the second attack control in the graphical user interface. The user may also display the control set corresponding to the second attack control (denoted by the second control set) by long-pressing the second attack control in the graphical user interface, and the second control set includes a third control that may be used to trigger controlling the virtual character to perform the action corresponding to the first control. If the touch-control operation is a click operation, the virtual character may be controlled to perform the second attack action. If the touch-control operation is a sliding operation, a second target control is determined from controls included in the second control set according to the sliding operation, and the virtual character is controlled to perform an action corresponding to the second target control. If the second target control is a third control in the first control set, the virtual character may be controlled to perform the action corresponding to the first control in the graphical user interface. In this way, if the user needs to control the virtual character to perform the second attack action, he/she may click the second attack control originally displayed in the graphical user interface, and long-press the second attack control to display the control set corresponding to the second attack control (denoted by the second control set). The second control set includes the third control that may be used to trigger controlling the virtual character to perform the action corresponding to the first control. If the user needs to control the virtual character to perform actions such as the horizontal attack and the vertical attack, it may be implemented by touching a fifth control originally displayed in the graphical user interface, or by touching the third control in the control set corresponding to the second attack control (denoted by the second control set). The displayed second control set enables the user to determine the position of each control in the control set more intuitively and clearly. When a control in the second control set needs to be operated, only by performing a sliding operation, a second target control may be accurately determined from the second control set according to the sliding operation, without the user lifting his finger and clicking on other controls in the graphical user interface. In the whole process, the user does not need to find and locate another control in the interface (the control corresponding to the horizontal attack action, the vertical attack action, etc.), and the sliding operation on the second attack control may conveniently determine the second target control from the second control set, thereby triggering the virtual character to perform the action corresponding to the second target control. By displaying the second control set when the second attack control is performed a long press, it provides an intuitive reference for the user to operate the controls. The user does not need to remember the operation mode of triggering the controls in the second control set, but only needs to slide towards which control in the second control set needs to be operated. In such operation process, the user may realize control switching without lifting his finger and shifting his gaze, and the user may react quickly in the interaction with no need to deliberately memorize, which is more convenient to operate and effectively alleviates the mistakes caused by relatively more interface controls. Such way of quickly controlling the virtual character also improves a consistency of user operations.

The above-mentioned horizontal attack control is taken as the first attack control, the vertical attack control is taken as the second attack control, and the evasion control is taken as the first control. If the player needs to horizontally attack an enemy virtual character, he/she may touch the first attack control. If the player needs to vertically attack the enemy character, he/she may touch the second attack control. In the process of attack, a target control may be selected by a sliding operation from the corresponding control set to avoid an attack action of the enemy virtual character.

In at least one embodiment, the method further includes: cancelling displaying the second control set. In this way, when the controls in the second control set do not need to be operated, the second control set is no longer displayed, and the unnecessary occlusion of the interface by the second control set is reduced.

As a possible implementation, the above-mentioned cancelling displaying the second control set includes: in response to an end of the third touch-control operation, cancelling displaying the second control set. If the third touch-control operation is a click operation, the second control set is not displayed. If the third touch-control operation is a long press and then a sliding operation, the display of the second control set is cancelled when the finger performing the sliding operation leaves the touch-control terminal screen. This way of cancelling the display of the second control set at the end of the third touch-control operation is simple and reasonable. After the third touch-control operation, the controls in the second control set are no longer needed to be operated, so cancelling the display of the second control set in time may reduce the time that the second control set occupies the graphical user interface and optimize the graphical user interface.

In other examples, the step of cancelling the display of the second control set may also include one of the following: (1) cancelling the display of the second control set in response to a determination of the second target control; (2) when a duration of the third touch-control operation reaches a set time threshold, cancelling the display of the first control set; (3) In response to the virtual character performing the action corresponding to the second target control, cancelling the display of the first control set. The specific way to cancel displaying the second control set may be selected according to actual needs, and this embodiment does not limit this.

In at least one embodiment, the description of other related processes and technical effects involved in the second attack control may refer to the above contents corresponding to the first attack control, which will not be repeated in the embodiments of the present disclosure.

In an alternative embodiment, the graphical user interface includes a first attack control. If a first touch-control operation on the first attack control is a long press operation and the press duration of the long press operation is greater than or equal to a first time threshold, the virtual character is controlled to perform a third attack action. In at least one embodiment, damage values caused by the third attack action and the first attack action to the enemy virtual character are different. For example, the third attack action is different from the first attack action in attack intensity and/or attack duration. Specifically, the first attack action is a normal attack, and the third attack action is a charge attack. When the first attack control is pressed for a long time, the first control set is displayed and the virtual character is controlled to perform the third attack action, such that the function of the first attack control may be expanded, and the player may adopt different operation modes of the first attack control to trigger the virtual character to perform different attack actions in different battle scenes, so as to achieve different attack effects.

If the first touch-control operation is the long press operation and the press duration of the long press operation is greater than or equal to the first time threshold, controlling the virtual character to perform the third attack action may include: if the first touch-control operation is the long press operation, controlling the virtual character to perform a preparation action for the third attack action, and controlling the virtual character to perform the third attack action after the press duration is greater than or equal to the first time threshold. The preparation action of the third attack action may be to control a posture of the virtual character or control an action of the virtual character holding a weapon, etc. The specific preparation action is related to a weapon currently held by the virtual character, a fighting scene in which the virtual character is currently located, or the third attack action corresponding to the first attack control, etc. The preparation action of the third attack action is used to indicate that the virtual character is ready to implement the third attack action.

If the first touch-control operation is a long press operation and the press duration of the long press operation is greater than or equal to the first time threshold, controlling the virtual character to perform the third attack action may further include: if the first touch-control operation is the long press operation and the press duration of the long press operation is greater than or equal to the first time threshold and less than the second time threshold at an end of the long press operation, triggering the virtual character to perform the third attack action at the end of the long press operation, where the second time threshold is greater than the first time threshold. In at least one embodiment, if the first touch-control operation is the long press operation and the press duration of the long press operation is equal to the second time threshold, the virtual character is automatically triggered to perform the third attack action.

The above-mentioned way of triggering the virtual character to perform the third attack action may be specifically selected according to the actual game, and the embodiment of the present disclosure does not limit this. Take the third attack action as a charge attack of the first attack action as an example. If the player presses the first attack control for a long time, it means that the charge attack will be carried out. When the press duration of the long press operation is between the first time threshold and the second time threshold, if the player raises his finger to end the long press operation, the virtual character is controlled to carry out the charge attack (that is, the third attack action). In at least one embodiment, the virtual character is automatically controlled to carry out the charge attack when the player presses for more than the second time threshold.

As a possible implementation, similar to the above-mentioned first touch-control operation corresponding to the first attack control, the above-mentioned method further includes: if the third touch-control operation corresponding to the second attack control is a long press operation and the press duration of the long press operation is greater than or equal to the first time threshold, controlling the virtual character to perform a fourth attack action. The fourth attack action and the second attack action have different damage values to the enemy virtual character.

The first time threshold and the second time threshold may be pre-configured according to the actual game, which is not limited in this embodiment.

On the basis of the third attack action triggered by the long press, the above-mentioned method further includes: if the first touch-control operation is the long press operation and the press duration of the long press operation is greater than or equal to the first time threshold and less than the second time threshold, determining a third target control from the first control set in response to a sliding operation continuous with the long press operation, and controlling the virtual character to perform an action corresponding to the third target control. In this way, in the process of triggering the third attack action by performing the long press operation on the first attack control, if the player wants to make the virtual character give up the execution of the third attack action due to fighting needs (even if the virtual character may currently execute the third attack action), he/she may slide his finger on the basis of the long press operation, and determine the third target control (such as a defensive control) from the first control set according to a direction of the finger sliding operation. Furthermore, the virtual character is triggered to perform the action corresponding to the third target control, such that the fighting strategy may be adjusted in time. For example, the third attack action that may be implemented may be interrupted in time, and the defensive action may be quickly entered, such that the fighting scene in the game is more in line with the actual process in real fighting and the game experience is more vivid and real. However, in the related art, if the first touch-control operation is the long press operation and the press duration of the long press operation is greater than or equal to the first time threshold and less than the second time threshold, in response to the end of the long press operation, the virtual character will be controlled to perform the third attack action. In this way, if the player raises his finger to end the long press action and then clicks the defensive control in the graphical user interface, the virtual character will perform the third attack action first and then perform the defensive action, which makes it impossible to adjust the fighting strategy of the virtual character and switch the offensive and defensive state in time.

In addition, the above-mentioned method further includes: if the first touch-control operation is a short press operation with a press duration less than the first time threshold, determining a third target action from the first control set in response to a sliding operation continuous with the short press operation, and controlling the virtual character to perform the third target action. In this way, during the process of the player wanting to trigger a charge operation by pressing the first attack control for a long time, if the player changes his mind according to the fighting scene, and wants to interrupt the unfinished charge operation, he/she may perform a sliding operation immediately to trigger the virtual character to switch to other target actions quickly without lifting his finger, thus realizing the timely adjustment of the fighting strategy and improving the flexibility of the game operation.

Taking the first control set displayed by performing a long press on the first attack control and the third attack action being a charge attack as an example, if the player wants to interrupt the current charge attack and quickly enter the counter action, the user may directly control the virtual character to interrupt the current charge attack and perform the action corresponding to the third target control without lifting his finger and sliding it to the third target control in the first control set, so as to quickly defend against an attack of the enemy virtual character and gain a greater fighting advantage for the player. In addition, if the player wants to interrupt the current charge attack and quickly enter other actions, he/she may also slide his finger to the corresponding target control in the first control set (such as the above-mentioned first target control, the above-mentioned second target control or the above-mentioned third target control) without lifting his finger, such that the virtual character may be directly controlled to interrupt the current charge attack and perform the action corresponding to the target control, thereby improving the flexibility of game operation.

As a possible implementation, determining the first target action may include: confirming the first target action from the first action set according to a sliding direction of the sliding operation; or, confirming the first target action from the first action set according to a sliding trajectory of the sliding operation. For example, an action corresponding to the sliding direction of the sliding operation in the first action set is determined as the first target action. In at least one embodiment, when the first control set is displayed, the control in the first control set whose sliding direction is opposite to the sliding operation is determined as the first target control, and the action corresponding to the first target control is the first target action. In at least one embodiment, the control in the first control set that is closest to an end position point of the sliding trajectory of the sliding operation is taken as the first target control, and the action corresponding to the first target control is the first target action. The method may quickly and accurately determine the first target action from the first action set.

A timing for the above-mentioned determining the first target control from the controls included in the first control set according to the sliding operation may include one of the following: (1) a moving distance of a touch point of the sliding operation reaching a set distance threshold; (2) the moving distance of the touch point of sliding operation reaches the above-mentioned set distance threshold and the movement ending; (3) the touch point of sliding operation moving to an area where the first target control is located; (4) the touch point of the sliding operation moving to the area where the first target control is located, and the movement ending.

The first control set may be displayed in a variety of ways, for example, in a form of a roulette on a periphery of the second control. Based on this, the above-mentioned displaying the first control set includes: displaying a first roulette including the first control set, where controls in the first control set are arranged in the first roulette. Generally, the first roulette is located near the first attack control, which helps the player select the target control from the roulette. As a possible implementation, the first roulette surrounds the first attack control, or the first roulette surrounds a preset position in a blank area in the graphical user interface. In at least one embodiment, the preset position is associated with a position where the second control is located. For example, the preset position is a point within a first distance from the center of the first attack control.

For the implementation of the first roulette surrounding the first attack control, the form of the first roulette may refer to the form of the above-mentioned first control set in schematic diagrams of the graphical user interface of FIGS. 7 and 8. Of course, the form of the first roulette may also adopt other variants of this form.

During the display of the first roulette, the resident controls in the graphical user interface are still displayed in their original positions. In order to reduce a blocking influence of the first roulette on the resident controls, there is a certain distance between the resident controls, such that during the display of the roulette, the player may not only quickly select a control to be triggered from the roulette, but also conveniently select other resident controls other than the roulette according to actual operational needs.

A transparency of the first roulette is greater than a preset transparency threshold, and in this way, an occlusion influence of the first roulette on the resident controls in the graphical user interface may be reduced.

In order to further reduce the problem of accidental touches, a direction from the first attack control to a third control in the first control set is different from a direction from the first attack control to a fourth control in the first control set. For example, the third control and the fourth control in the first control set are on the left side and the right side of the first attack control, respectively. This control layout is convenient for the player to accurately select a corresponding target control during the sliding operation.

As a possible implementation, the above-mentioned method further includes: displaying a first control indication in a first direction of the first attack control, and displaying a second control indication in a second direction of the first attack control, where the first control indication is used to indicate that the controls in the first control set are displayed in the first direction of the first attack control when the first control set corresponding to the first attack control is displayed; and the second control indication is used to indicate that the controls in the first control set are displayed in the second direction of the first attack control when the first control set corresponding to the first attack control is displayed. The above-mentioned first control indication and the above-mentioned second control indication may be preset graphic marks or graphic and color marks, as long as they may serve the purpose of indicating that the controls in the first control set present in this direction of the first attack control. Taking the graphical user interface shown in FIGS. 7 and 8 as an example, arrow-like graphics on an outer ring of the first attack control are the first control indication and the second control indication, such as control indications 18a in FIG. 8. The number of the first control indication and the second control indication is related to the number of the controls in the first control set, and each control in the first control set will correspond to one control indication. As a possible implementation, the first attack control displayed also has the control indication when the first control set is not displayed, such that the player may distinguish the control configured with the control set (or the action set) from the control not configured with the control set (or the action set), and let the player know in advance information such as in which direction of this control the controls in the control set (or action set) will present.

The included angle between the ray originating from the first attack control toward the third control in the first control set and the ray originating from the first attack control toward the fourth control in the first control set is greater than an angle threshold. The angle threshold may be any value between 20° and 45°, for example, the angle threshold is 20°, 30° or 45°. In this way, the setting mode of the position of the controls in the first control set may effectively reduce the problem of accidental touches of the sliding operation.

As a possible implementation, the first control may also be an evasion control, and based on this, the above-mentioned method includes the following steps: controlling the virtual character to perform a first evasive action in response to a click operation on the evasion control; and controlling the virtual character to perform a second evasive action in response to a long press operation on the evasion control, where an evasive distance of the first evasive action and an evasive distance of the second evasive action are different and/or a state after the first evasive action and a state after the second evasive action are different, and the state comprises jogging or sprinting. This way of triggering an evasive action corresponding to an evasion control according to different operation types may realize multiple actions of a control and simplify the number of controls in the graphical user interface.

As other possible implementations, the first control may also be a jump control, and based on this, the above-mentioned method includes the following steps: controlling the virtual character to perform a first jump action in response to a click operation on the jump control; and controlling the virtual character to perform a second jump action in response to a long press operation on the jump control, where a jump posture of the first jump action and a jump posture of the second jump action are different and/or a jump height of the first jump action and a jump height of the second jump action are different. This way of triggering a corresponding jump action of a jump control according to different operation types may realize multiple actions of one control and simplify the number of controls in the graphical user interface.

As a possible implementation, the evasion control may also be configured with an action set with a crouching action, so as to quickly control the virtual character to crouch to avoid an attack of the enemy virtual character through the sliding operation on the basis of controlling an evasion of the virtual character. In at least one embodiment, the evasion control may be configured with a control set with a crouch control, so as to quickly control the virtual character to crouch to avoid the attack of the enemy virtual character through the sliding operation on the basis of controlling the evasion of the virtual character.

The above-mentioned graphical user interface further includes a sixth control, and the sixth control is a jump control. The above-mentioned method further includes the following steps: in response to a fourth touch-control operation acting on the sixth control, if the fourth touch-control operation is a click operation, controlling the virtual character to perform a jump action; and if the fourth touch-control operation is a sliding operation, determining a fourth target action from a third action set according to the sliding operation, and controlling the virtual character to perform the fourth target action. The third action set at least includes a crouching action.

The above-mentioned method further includes the following steps: if the fourth touch-control operation is a long press operation, displaying a third control set, determining a fourth target control from the controls included in the third control set according to a sliding operation continuous with the long press operation, and controlling the virtual character to perform an action corresponding to the fourth target control; and in response to an end of the fourth touch-control operation, cancelling displaying the third control set.

A technology corresponding to the evasion control as the sixth control is similar to the technology corresponding to the above-mentioned second control and fifth control, and will not be described here.

As other possible implementations, the jump control may also be configured with a control set with a crouch control, so as to quickly control the crouching of the virtual character through sliding operation to avoid the attack of the enemy virtual character on the basis of controlling the jumping of the virtual character.

The above-mentioned graphical user interface further includes a sixth control, and the sixth control is a jump control. The above-mentioned method further includes the following steps:
(1) in response to a fourth touch-control operation acting on the sixth control, judging a type of the fourth touch-control operation;
(2) if the fourth touch-control operation is a click operation, controlling the virtual character to perform a jump action; and if the fourth touch-control operation is a long press and then a sliding operation, displaying a third control set, determining a fourth target control from controls included in the third control set according to the sliding operation, and controlling the virtual character to perform an action corresponding to the fourth target control, where the third control set at least includes a crouch control, and the crouch control is used for triggering the virtual character to perform a crouching action; and
(3) cancelling displaying the third control set.

The technology corresponding to the jump control as the sixth control is similar to the technology corresponding to the above-mentioned second control and fifth control, and will not be described here.

Referring to a schematic diagram of another graphical user interface shown in FIG. 10, this embodiment takes the sixth control as the evasion control as an example to explain. The third control set corresponding to the evasion control 20 includes a crouch control 26, and the crouch control is located at a lower side of the evasion control. When the player clicks the evasion control, the virtual character performs an evasive action corresponding to the evasion control. The third control set as shown in FIG. 10 is displayed on a periphery of the evasion control. In this embodiment, there is only a crouch control in the third control set. Considering that the crouch control is used to reduce a height of the virtual character, the crouch control in the third control set in the figure is set directly below the evasion control. Of course, as a possible implementation, the first control set may also be set diagonally below the evasion control.

If the finger of the player slides down from a position where the evasion control is located, that is, the finger slides towards the crouch control, and after the finger slides to a certain extent, for example, sliding into an area where the crouch control is located, the virtual character is controlled to perform a crouching action corresponding to the crouch control. By the sliding operation, the finger moves from the evasion control to the crouch control on the lower side thereof, such that the player character may be switched from the evasive action corresponding to the evasion control to the crouching action corresponding to the crouch control, which is smoother and more convenient in operation, and effectively reduces the problem of accidental touches.

In addition to the above-mentioned attack control, posture adjustment control (the above-mentioned jump control, crouching control or evasion control) or defense control (the above-mentioned counter control), the virtual character of this embodiment will also have some special skills. Correspondingly, the above-mentioned method may also include: displaying a seventh control on the graphical user interface, where the seventh control is a skill control for triggering the virtual character to perform a skill release, and the first attack control is an action control for triggering the virtual character to perform the first attack action. By setting the skill control, the player may perform a skill attack on the enemy virtual character at the right time and improve the attack effect.

A skill corresponding to the above-mentioned skill control has a cooling time, and an action corresponding to the above-mentioned action control does not have the cooling time. That is, the skill control is triggered to make the virtual character to release the skill, and a timing is started at the same time. Only when the timing reaches the cooling time of the skill, then the skill control may be triggered again to make the virtual character release the skill. The action control is not configured with a cooling time. After the action control is triggered, the virtual character may directly trigger the next action control without waiting, such that the virtual character may continuously perform the action corresponding to the action control.

In the game, different virtual characters usually correspond to different skills, and different virtual characters may have the ability to perform the same action. Based on this, there are a first virtual character and a second virtual character in the virtual environment, and a skill of the first virtual character is different from a skill of the second virtual character. Both the first virtual character and the first virtual character may perform the first attack action. For example, the first virtual character has a defensive skill for a specific attack, and if the defensive skill is released, the specific attack of an opponent is invalid. The second virtual character has a skill of double attack damage, and if this skill is released, a current attack will cause double damage to the opponent. Both the first virtual character and the second virtual character may carry out a horizontal attack action or a vertical attack action, as well as a jump action and an evasive action.

As a possible implementation, the above-mentioned first attack action is a contact attack action carried out by limbs and/or a weapon of the virtual character. The contact attack refers to an attack in which the limbs or weapon of an attacking part come into contact with an attacked party, for example, the attacked party hits the enemy's body with a fist, and cuts and stabs the enemy's body with a blade or sword and the like, which are common melee attack actions in the game.

As a possible implementation, if the first touch-control operation is the sliding operation, determining the first target action from the first action set according to the sliding operation and controlling the virtual character to perform the first target action may include: if the first touch-control operation is the sliding operation, determining the first target action from the first action set according to the sliding operation, and determining whether an action interruption condition is met according to a current action state of the virtual character and the first target action; and if the action interruption condition is met, controlling the virtual character to perform the first target action.

The above-mentioned current action state refers to an action that the virtual character is performing before this sliding operation. For example, before this sliding operation, the player clicked on a horizontal attack control (or a jump control), “the current action state of the virtual character” here refers to an action state that the player clicked on the horizontal attack control (or the jump control) such that the virtual character currently performs a horizontal attack (or a jump).

Determining whether the action interruption condition is met according to the current action state of the virtual character and the first target action may includes the following conditions.

If an action corresponding to a control that triggers the virtual character to perform the current action state and the first target action both are a collective action of multiple actions, the action interruption condition is met.

If an interruption point is set on an action trajectory corresponding to the current action state of the virtual character, and a trigger time of the first target action occurs after a time corresponding to the interruption point, the action interruption condition is met. For example, an interruption to evasive action is added on an attack track of a horizontal attack 1 at 0.2 seconds. If the player triggers an evasion instruction (for example, the evasion instruction is triggered by a sliding operation acting on the first attack control) after an action of the horizontal attack 1 is played for 0.2 seconds, the virtual character will interrupt the current horizontal attack action and immediately perform the evasive action. Otherwise, when the action of the horizontal attack 1 is not played for 0.2 seconds, the player triggers the evasion instruction, and the virtual character will not interrupt the current horizontal attack action, that is, the evasion instruction does not take effect.

If a preset interrupt action set corresponding to the control that triggers the virtual character to perform the current action state includes the first target action, the action interrupt condition is met.

The method fturther includes: if the above-mentioned action interruption condition is not met, not controlling the virtual character to perform the first target action, or, if the action interruption condition is not met, controlling the virtual character to continue to perform a currently unfinished action.

As a possible implementation, if the above-mentioned action interruption condition is not met, the virtual character may be controlled to continue to perform the currently unfinished action, and then the first target action may be performed when the currently unfinished action is finished.

In an alternative embodiment, the controls in the first control set may have different functions from the resident controls. Taking the graphical user interface shown in FIG. 7 as an example, there is a counter control on a right side of internal horizontal attack control inside the first control set, and there is also a counter control on a right side outside the first control set (a resident control in the graphical user interface). The counter control in the roulette may make the player quickly perform the counter action through the sliding operation, and the performed counter action may interrupt an action that the virtual character is currently performing, so as to quickly release the counter action. The resident counter control in the graphical user interface may make the virtual character perform the counter action after completing the current action. This counter trigger mechanism does not affect a completion degree of the virtual character's current action, and may enable the character to obtain all the excitation values corresponding to the action.

Since the control in the first control set releases the counter action quickly, it may affect a completion degree of the action that the virtual character is currently performing. Therefore, when a control in the first control set is adopted, an excitation value obtained by the virtual character on this action may be determined according to a completion degree of the current action state of the virtual character. Based on this, the above method further includes: updating incentive information corresponding to the virtual character according to the completion degree of the virtual character's current action state. For example, the completion degree of the action state is positively correlated with the excitation value. The higher the completion degree, the higher the excitation value is, and the highest excitation value is the excitation value corresponding to the original action. For example, if the completion degree of the action state exceeds 90% of the original action, all the excitation values of the action will be obtained. If the completion degree of the action state is lower than 90% of the original action, only half of all the excitation values of the action will be obtained.

As a possible implementation, in the above technology, if an action corresponding to the control in the first control set is triggered based on an end of the sliding operation, there may be a rescission mechanism. That is, if an orientation of a sliding trajectory or a sliding direction changes from a third control to a fourth control during the sliding operation, the fourth control is determined to be a target control, and the virtual character is controlled to perform the action corresponding to the fourth control.

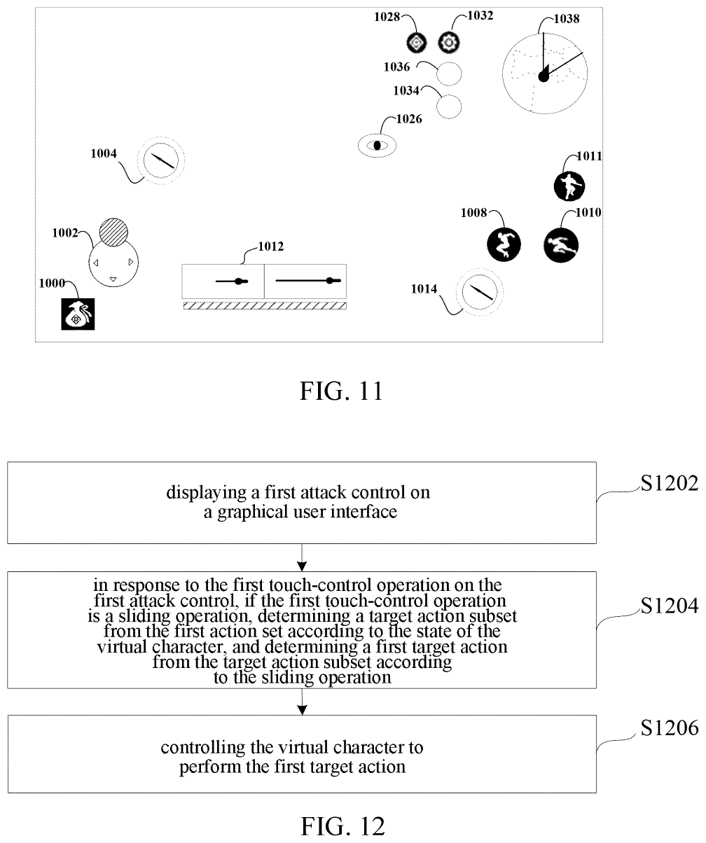

In order to better understand the above technology, this embodiment provides an example of an application scene, referring to a schematic diagram of a graphical user interface shown in FIG. 11, in which contents displayed by the graphical user interface include a game scene and a virtual object (or referred to a virtual character) in the game scene, and the player controls the virtual object to move in the game scene. The interface in FIG. 11 shows various controls, which are displayed on the game scene. Each control is introduced as follows.

Backpack control 1000: Displaying a backpack interface on the graphical user interface is triggered through a touch-control operation acting on the backpack control. The backpack interface is used to view items and props of the backpack, and the items and props includes but not is limited to: a drug, a weapon, an accessory, an armor and other props. In an alternative embodiment, an edge of the backpack control 1000 is provided with an edge line for indicating the amount of the items in the backpack. The touch-control operation acting on the backpack control 1000 may be a click, a double click, a long press, a slide and other operations.

Movement control 1002: A circle filled with shadow is a joystick in the movement control. In an alternative embodiment, the movement control 1002 is configured with a mobile response area, where the mobile response area may have a same size as the movement control 1002, that is, an area in the graphical user interface corresponding to the movement control 1002 is the mobile response area. In an alternative embodiment, a size of the mobile response area may be larger than a size of the movement control 1002, that is, the movement control 1002 is set within the mobile response area. Specifically, the graphical user interface is divided into a left a size and a right area from the middle, and the left area is the mobile response area of the movement control 1002. A movement control command is triggered by a touch-control operation acting on the movement response area of the movement control 1002, and a moving direction of the virtual object is controlled according to the movement control command. The touch-control operation acting on the mobile response area of the movement control 1002 may be a click, a double click, a long press, a slide and other operations.

Attack control 1014: An attack instruction is triggered through a specified touch-control operation acting on an attack response area of the attack control 1014, and the virtual character is controlled to perform an attack action in a game scene according to the attack command. The attack action triggered by the attack control 1014 corresponds to a current assembly state of the virtual character. For example, when the virtual character is equipped with a ranged weapon, the attack action triggered by the attack control is a shooting action, that is, a right hand may perform a shooting operation by triggering the attack control 1014. When the virtual character is equipped with a melee weapon, the attack action triggered by the attack control 1014 is a slashing action. In an alternative implementation, only one of attack controls 1014 is displayed, which is arranged on a lower right side of the graphical user interface. In at least one embodiment, in a feasible embodiment, there may be two attack controls, one is an attack control 1004 on a left side of the graphical user interface and the other is the attack control 1014 on a right side of the graphical user interface. A display position of the attack control may be adjusted according to a position setting instruction, and the position setting instruction may be triggered in a setting interface or in a process of game play. The specified touch-control operation acting on the attack control may be a click, a double click or a long press operation, where the click or the double click is used to control the virtual character to perform a normal attack action, and the long press operation is used to control the virtual character to perform a charge attack action. The attack control 1014 of this embodiment has a control instruction, and when the attack control 1014 is performed a long press operation, a first control set is displayed on the graphical user interface, and the first control set may include at least one of a gesture control, a defense control or other attack controls. If the touch-control operation is a sliding operation, a first target control is determined from the first control set according to the sliding operation, and the virtual character is controlled to perform an action corresponding to the first target control.

Gesture action controls 1008 and 1010: A gesture adjustment instruction is triggered through a touch-control operation acting on the gesture control to adjust a gesture of the virtual character in the game scene. The gesture action control 1008 is triggered so as to control the virtual character to perform a jump action. The gesture action control 1010 is triggered so as to control the virtual object to perform an evasive action. The gesture action controls 1008 and 1010 are mostly used in an attack scene where the virtual character avoids an enemy virtual character in close fighting. According to the needs of the actual application scene, the gesture control may also include other controls, such as a crouch control, a sprinting control and so on. The touch-control operation acting on the gesture action control may be a click, a double click, a long press, a slide and other operations.

Counter control 1011: The counter control is used to quickly disarm a weapon of the enemy. When the player performs a touch-control operation on the counter control 11 to disarm the weapon of the enemy, the virtual character of the player may pick up the weapon. The touch-control operation acting on the counter control may be a click, a double click, a long press, a slide and other operations.

Weapon slot 1012. The weapon slot is triggered so as to switch weapons used by the player. A touch-control operation acting on the weapon slot may be a click, a double click, a long press, slide and other operations.

Vision adjustment control 1026 (which may be an icon of a small eye): The vision adjustment control 1026 is used to control shooting parameters of a virtual camera presenting the game screen, so as to adjust a vision screen of the game scene displayed in the graphical user interface. In an alternative implementation, it is determined that a touch-control operation acting on the vision adjustment control 1026 is detected, and the shooting parameters of the virtual camera are adjusted according to the touch-control operation, where the shooting parameters include, but are not limited to, a position, an orientation and a viewing angle of the virtual camera. In order to facilitate the user's operation, a specific blank area in the graphical user interface may also be used to adjust the vision picture of the game scene. The touch-control operation acting on the vision adjustment control 1026 may be a click, a double click, a long press, a slide and other operations.

Marking control 1028: The marking control marks the virtual character, a virtual physical object and the like in the game scene through a touch-control operation acting on the marking control. The touch-control operation acting on the marking control 1028 may be a click, a double click, a long press, a slide and other operations.

Setting control 1032: The setting control 1032 is used to set basic functions of the current game. The control 1032 is clicked to display a setting menu for the user to perform a setting operation.

Message controls 1034 and 1036: The message control 1034 may be used for viewing a system notification, and the message control 1036 may be used for viewing a message sent by a teammate or sending a message to a teammate.

Minimap 1038: the minimap 1038 is used to display a position of the virtual character controlled by the player, and may also display positions of virtual characters of some other players.

In addition to the above controls, the various controls may also include a lock control, a hook lock control, a lens mode switching control, a combat encyclopedia control, a speaker switch control, a microphone switch control, an expression control, a text chat control, etc. The functions of these controls may refer to related games, which are not described in detail in the present disclosure embodiment.

The above-mentioned movement control of the virtual character may include the following two control modes.

(1) In a non-ranged fighting mode, if performing a moving down operation on the movement rocker, an orientation of the virtual character is adjusted to a direction facing the virtual camera, and the virtual character is controlled to move based on the current orientation. This way of controlling the orientation of the virtual character by the movement rocker in the non-ranged fighting mode may make the virtual character turn to face the virtual camera when dragging the movement rocker downward. A movement on this basis is more in line with a moving way of a role in a real battle scene. For example, in a melee fighting scene, a player virtual character chooses to escape temporarily when the player virtual character is defeated by an attack of an enemy virtual character. Compared with the backward escape, the running speed and sense of direction of a turning and then forward escape are stronger and more vivid. For another example, in the melee fighting scene, when the enemy virtual character suddenly approaches behind the player virtual character, in order to attack the enemy virtual character quickly, the player may drag the movement rocker downward with his left hand to make the player virtual character turn around quickly, and at the same time, operate the attack control with his right hand to release an attack action against the approaching enemy virtual character. This kind of movement rocker function may improve a response speed of the player in the process of fighting, and is closer to behaviors and actions expressed in an actual fighting.

(2) In a ranged fighting mode, considering that it is usually necessary to provide a centering function or a locking function of a ranged weapon, when performing a moving down operation on the movement rocker in the ranged fighting mode, the virtual character is controlled to move backwards, and the orientation of the virtual character is still facing away from the virtual camera, so as not to affect the realization of the centering function or the locking function in a ranged attack.

In addition, the movement rocker in the embodiment of the present disclosure further has a function of adjusting the moving speed of the virtual character according to a dragging amplitude of the movement rocker. In a unit time, the larger the dragging amplitude of the movement rocker, the faster the virtual character moves. In this way, the player may make the virtual character enter the sprinting action from fast walk without the right hand to operate a specific sprinting control, so the sprinting control may no longer be set on the right side, reducing the number of resident controls on the page. On the basis of this function, if the player has entered the sprinting action at present, a sprinting state will not be interrupted when the movement rocker is pulled back, and the sprinting state of the virtual character will continue to be maintained for a certain time. If the player does not drag the movement rocker again quickly within this time, the virtual character will be controlled to enter a fast walk state from the sprinting state. If the player drags the movement rocker again quickly within this time, the virtual character will continue to be controlled to be in the sprinting state. On the one hand, this setting mode may avoid a direct deceleration of the character caused by the inability of the movement rocker to move again after being dragged to an edge of the movable area, and may also alleviate the problem of excessive finger burden caused by continuous and rapid dragging of the movement rocker. When the virtual character needs to run to a specific target position in order to complete the current task, the player may quickly drag the movement rocker for many times to make the virtual character run to the target position in the sprinting state, which saves the execution time of the task and ensures the smooth completion of the task.

In the melee attack scene, the attack direction of the above-mentioned virtual character is mainly controlled by snap. The snap refers to an auxiliary steering function and is a function point on the action track, and its main function is to help the player adjust and turn to the enemy target when performing the attack moves. That is, when the target is not locked, the attack direction of the player virtual character is a direction that the character is currently facing. When there is a locked target, the attack direction is a direction of the locked target. In order to make the attack process more vivid, this embodiment sets an orientation adjustment function point on the attack action track corresponding to the attack control. When the attack action is performed, the orientation adjustment function point takes the attack direction of the attack action as an adjustment basis for the orientation of the character, and adjusts the orientation of the character to the attack direction, such that the character may perform the attack action facing the locked target.

On the basis of the above-mentioned virtual character orientation control, in order to prevent the screen in the game scene from rapidly switching along with the character orientation and affecting the player's viewing, in this embodiment, the shooting angle of the virtual camera is bound with a motionroot point (i.e., a root motion point, which will not change with the change of the orientation of the character) of the player virtual character, and the shooting angle of the virtual camera moves along with the movement of the motionroot point of the character, such that the game scene presented to the player may not change when the player virtual character only changes its orientation.

In an alternative embodiment, another virtual character control method is provided. As shown in FIG. 12, the method includes the following steps S1202-S1206.

In step S1202, a first attack control is displayed on a graphical user interface.

The first attack control corresponds to a first action set, and the first action set includes at least two action subsets. Each action subset corresponds to a state of the virtual character. In this embodiment, the state of the virtual character includes a ground state and a hovering state, so the first action set includes two action subsets, namely, a first action subset corresponding to the ground state and a second action subset corresponding to the hovering state.

The first action set corresponding to the first attack control, the action subsets in the first action set, and the virtual character state corresponding to each action subset may be customized according to the user's needs, and may be customized in the game setting page. For example, in the setting page, a plurality of attack controls may be provided for the user to select the first attack control, a plurality of action lists may be provided for the user to select the first action set corresponding to the first attack control, and an operation window for dividing the first action set into a plurality of action subsets may be provided, and a plurality of states may be provided for the user to select each state corresponding to the action subset. This custom way may reduce the user's understanding cost and make the operation easier.

In step S1204, in response to the first touch-control operation on the first attack control, if the first touch-control operation is a sliding operation, a target action subset is determined from the first action set according to the state of the virtual character, and a first target action is determined from the target action subset according to the sliding operation.

In at least one embodiment, if the state of the virtual character is the ground state, the determined target action subset is the first action subset according to a corresponding relationship between the above-mentioned state and the action subset. If the virtual character is in the hovering state, the determined target action subset is the second action subset according to the corresponding relationship between the state and the action subset.

If the first touch-control operation is a click operation, the virtual character is controlled to perform the first attack action corresponding to the first attack control.

The first attack control is pre-configured with processing modes corresponding to different touch-control operation modes. When the first touch-control operation acts on the first attack control, different processing modes will be triggered according to the touch-control operation mode of the first touch-control operation, such that the first attack control has multiple functions, which not only improves the convenience of operation, but also reduces the number of controls arranged in the page.

In step S1206, the virtual character is controlled to perform the first target action.

According to the above-mentioned method, the first attack control is displayed on the touch graphical user interface, if the first touch-control operation acting on the first attack control is a sliding operation, a target action subset is determined from the first action set according to a state of the virtual character, and the first target action is determined from the target action subset according to the sliding operation, and the virtual character is controlled to perform the first target action, which may be an aggressive action, a defensive action, a jump action and the like. According to the way that the target action subset is determined according to the virtual character state, and then the first target action is determined from the target action subset according to the sliding operation, the user may realize the connection between the first attack action and the first target action more quickly and continuously. When it is necessary to control the virtual character to perform a certain action in the target action subset, it may be triggered by a sliding operation acting on the first attack control without the user lifting his finger and clicking other controls in the graphical user interface, thus realizing the rapid control of the virtual character, such as quickly controlling the attack move transformation or attack and defense conversion. In this operation process, the user may realize control switching without lifting his finger and shifting his eyes, and the way of determining the target action subset according to the virtual character state reduces the complexity of operation and the fatigue of the user, and the user may react quickly in interaction, making the operation more convenient and effectively alleviating the misoperation problem caused by relatively more interface controls. This way of quickly controlling virtual characters also improves the consistency of user operations.

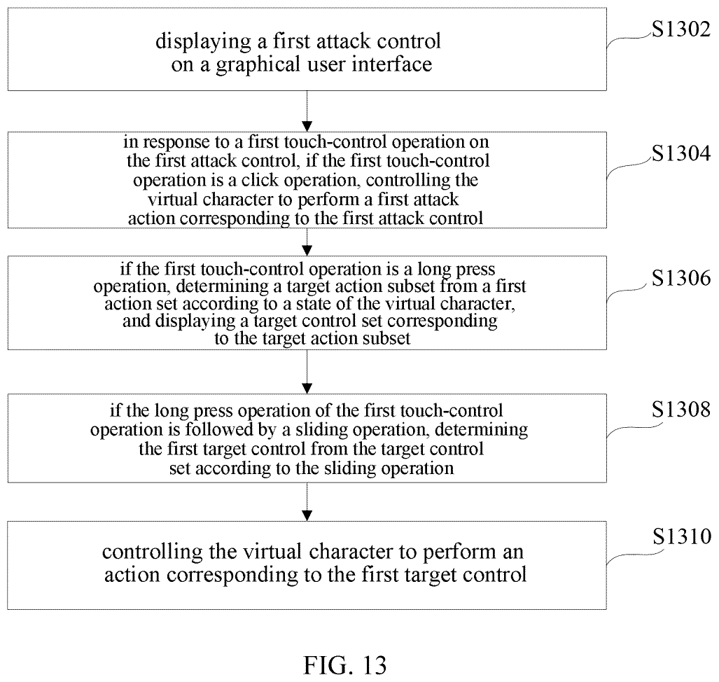

An embodiment of the present disclosure also provides another virtual character control method, which provides a graphical user interface through a touch-control terminal, where the touch-control terminal may be the aforementioned local terminal device or the aforementioned client device in the cloud interaction system. In this embodiment, the first action set is displayed, and the state of the virtual character includes the ground state and the hovering state. Referring to FIG. 13, a flowchart of another virtual character control method in one or more embodiment of the present disclosure is shown, which includes the following steps S1302-S1310.

In step S1302, a first attack control is displayed on a graphical user interface.

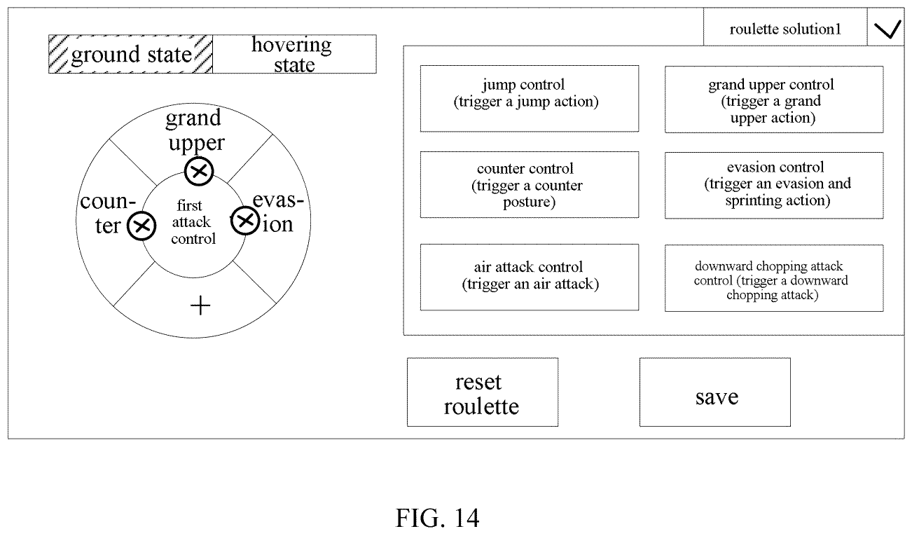

The related information of the action set corresponding to the first attack control is similar to the description information in the method shown in FIG. 12 above, and will not be repeated here. The display positions of actions in each action subset in the first action set are preset. Referring to a schematic diagram of a definition mode of the action subset and the character state shown in FIG. 14, the first action set is presented in the form of a roulette, and the roulette is divided into four sectors. A roulette solution 1 is the first action subset, which corresponds to the ground state of the virtual character (the ground state being in a selected state is indicated by a diagonal filled box in the figure). As shown in the figure, the user may set a grand upper action, the counter action and the evasive action at different positions of the roulette as required. If the user wants to continue adding an action in the first action subset, he/she may drag the corresponding action control to a “+” position in the roulette from the right, and if he wants to delete an action in the first action subset, he/she may click a “×” icon corresponding to this action control in the roulette to delete it. If the user wants to reconfigure the first action subset, he/she may also click a roulette reset control below. If a first action subset is configured, the user may click a save control below to complete the configuration.

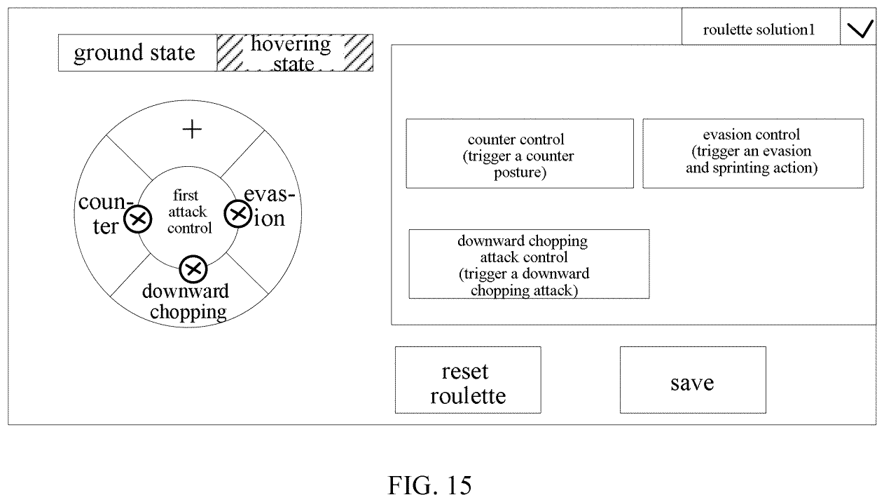

Referring to a schematic diagram of another definition mode of the action subset and the character state shown in FIG. 15, which is similar to the configuration corresponding to the above ground state, FIG. 15 is mainly the schematic diagram of the configuration of the second action subset corresponding to the hovering state, where the roulette solution 1 is the second action subset, which corresponds to the hovering state of the virtual character. As shown in the figure, the hovering state being in a selected state is indicated by a diagonal filled box. The user may set a downward chopping attack action, the counter action and the evasive action at different positions of the roulette as required, and a editing and saving method of the second action subset are similar to a editing and saving method of the first action subset mentioned above, so the details are not repeated here.

In some scenes, the actions in the above-mentioned roulette may be set repeatedly, that is, the same action control may be set in different positions in the roulette.

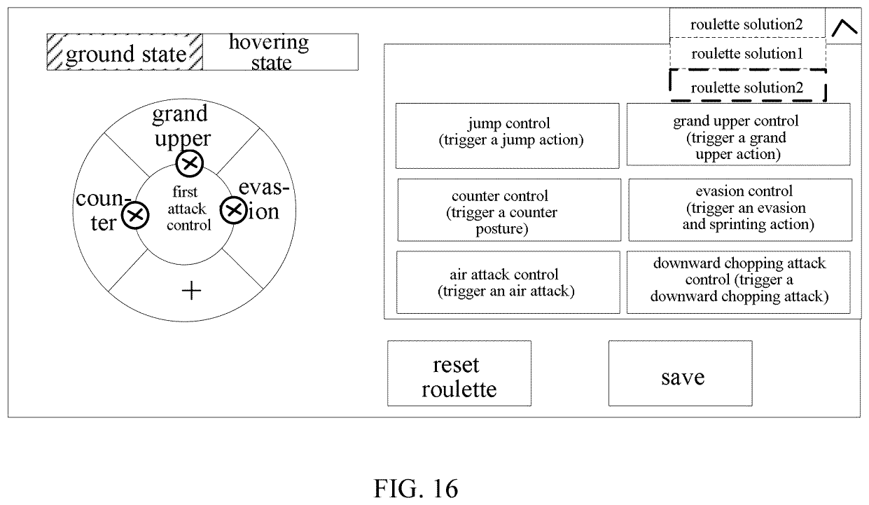

For the same state of a virtual character, a plurality of action subsets may be set correspondingly. A schematic diagram of another definition mode of the action subset and the character state is shown in FIG. 16. In this figure, the ground state corresponds to two first action subsets. As shown in FIG. 16, a roulette solution 1 may be set to correspond to one first action subset, and a roulette solution 2 may be set to correspond to another first action subset. Different roulette solutions may correspond to different attack controls, or different weapons and equipment of the same attack control correspond to different roulettes. The editing and saving method of the first action subset is similar to the above content, and will not be described here.

Each action in the action subset corresponds to a sector. If there are less than four actions in the action subset, there may be empty sectors. Of course, the division mode of the sectors of the roulette is not limited to a four-sector division mode in FIGS. 14-16, and more sectors may be divided as needed, which is not limited in this embodiment.

In step S1304, in response to a first touch-control operation on the first attack control, if the first touch-control operation is a click operation, the virtual character is controlled to perform a first attack action corresponding to the first attack control.

In step S1306, if the first touch-control operation is a long press operation, a target action subset is determined from a first action set according to a state of the virtual character, and a target control set corresponding to the target action subset is displayed.

The above-mentioned target control set is the control set corresponding to the actions in the target action subset. This embodiment takes the roulette displaying the target control set as an example.

If the state of the virtual character is the ground state, according to the corresponding relationship between the state and the action subset, the determined target control set is the control set corresponding to the first action subset. If the virtual character is in the hovering state, according to the corresponding relationship between the state and the action subset, the determined target control set is the control set corresponding to the second action subset. When the state of the virtual character is switched, the displayed target control set is switched accordingly.

In step S1308, if the long press operation of the first touch-control operation is followed by a sliding operation, the first target control is determined from the target control set according to the sliding operation.

The first target control may be specifically determined according to a direction of the sliding operation or a trajectory of the sliding operation.

In step S1310, the virtual character is controlled to perform an action corresponding to the first target control.

Similar to the above embodiment, the displayed target control set may be de-displayed based on time or events to reduce an occlusion of other controls or scenes in the interface.

In the above-mentioned method, the first attack control is displayed on the touch graphical user interface, the first action set corresponds to the first attack control, the first action set includes at least two action subsets, and each action subset corresponds to a state of a virtual character. If the first touch-control operation acting on the first attack control is a click operation, the virtual character is controlled to perform the first attack action. If the first touch-control operation includes a long press operation, the target action subset is determined from the first action set according to the state of the virtual character, and the target control set corresponding to the target action subset is displayed. If the long press operation is followed by a sliding operation, the first target control is determined from the target control set according to the sliding operation, and the virtual character is controlled to perform an action corresponding to the first target control. The action corresponding to the first target control may be an aggressive action, a defensive action, a jump action and the like. The way of determining the action subset and displaying the target control set according to the virtual character state may guide the user's sliding operation more intuitively, and then determine the first target control according to the sliding operation, such that the virtual character may perform the action corresponding to the first target control. In this way, the user may realize a continuation between the first attack action and the first target action more quickly and continuously. When it is needed to control the virtual character to perform an action in the target action subset, it may be triggered only by a sliding operation acting on the first attack control, without the user lifting his finger and clicking other controls in the graphical user interface, thus realizing the rapid control of the virtual character, such as quickly controlling the attack move transformation or the attack and defense conversion, etc. In this operation process, the user may realize control switching without lifting his finger and shifting his eyes. The way of determining the target action subset according to the state of the virtual character and displaying the corresponding controls reduces the complexity of operation and the fatigue of the user. The user may respond quickly in interaction, which is more convenient to operate and effectively alleviates the problem of misoperation caused by relatively more interface controls. This way of quickly controlling the virtual character also improves the consistency of user operations.

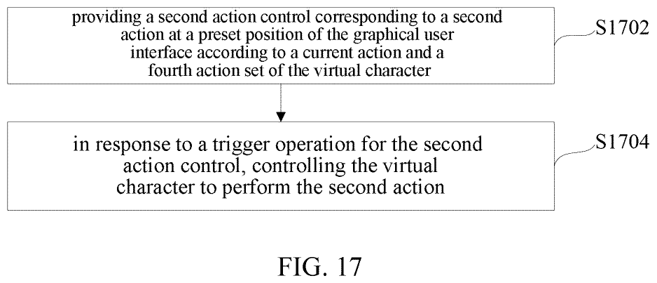

One or more embodiment of the present disclosure provides a virtual character control method, which may be carried out on the basis of the method provided in the above embodiments. Referring to a flowchart of the virtual character control method shown in FIG. 17, and the method includes the following steps S1702-S1704.

In step S1702, a second action control corresponding to a second action is provided at a preset position of the graphical user interface according to a current action and a fourth action set of the virtual character.

The current action of the virtual character refers to the last action performed by the virtual character, the fourth action set is a pre-configured action set, and at least one fourth action set may be pre-configured. The fourth action set includes at least two actions, and the second action is an action in the fourth action set.

The preset position may be set in advance according to an operation habit, or may be determined according to the position of the control that triggers the virtual character to perform the current action, for example, the preset position is a left adjacent position of the control that triggers the virtual character to perform the current action.

Assuming that the player clicks the first attack control, the virtual character performs the first attack action corresponding to the first attack control, and the first attack action corresponds to a fourth action set in advance, when the virtual character performs the first attack action, the second action control corresponding to the second action is provided at a preset position of the graphical user interface (such as a left adjacent position of the first attack control).

In step S1704, in response to a trigger operation for the second action control, the virtual character is controlled to perform the second action.

The trigger operation for the second action control may be a single click action. The second action may be an attack action, a defensive action or a posture action.

If the virtual character does not have the action at present or the current action is not associated with the fourth action set, the graphical user interface does not display the second action control, such that the graphical user interface is concise and clear.

According to the method, when the virtual character performs the current action, the second action control corresponding to the second action is provided at the preset position in the graphical user interface according to the current action of the virtual character and the fourth action set, such that it is more convenient to trigger the virtual character to perform the second action when the virtual character performs the current action. The way of providing the second action control at the preset position may not only reduce the redundancy of the control in the resident page of the second action control, but also facilitate the touch of the second action control and reduce the problem of touching the control by mistake.

As a possible implementation, the above-mentioned fourth action set includes at least two actions and an action sequence. The action sequence is usually set according to needs of controlling the virtual character in the game scene. In this way, the sequence of performing each action in the fourth action set is more in line with the operation needs.

When the fourth action set includes at least two actions, both actions may be called second actions. Based on this, providing the second action control corresponding to the second action in the graphical user interface according to the current action of the virtual character and the fourth action set includes: providing the second action control corresponding to the second action in the graphical user interface according to the current action of the virtual character and the action sequence of the fourth action set. The second action in the fourth action set may be executed in sequence according to the action sequence and displayed at the above-mentioned preset position.

Further, the above-mentioned method also includes: providing a third action control corresponding to a third action at a preset position in the graphical user interface according to the second action and the fourth action set. In response to a trigger operation for the third action control, the virtual character is controlled to perform the third action. The fourth action set includes a plurality of actions, the second action and the third action are all actions in the third action set, and the third action is located after the second action in the action sequence. For example, in some touch-control terminal games, the common operation of an air attack is to click the jump control first and then click the attack control in order to realize the air attack. Through the actions in the fourth action set, the jump control and the attack control may be displayed in sequence at the same preset position, and the user may control the virtual character to realize the air attack as needed without moving the finger position, which may greatly simplify the user's touch-control operation.

For another example, the fourth action set related to the current action includes a normal attack, an air pursuit, a grand upper, a downward chopping attack, a one-stage charge, a two-stage charge and a counter execution, and an action sequence is (1) the normal attack, (2) the air pursuit, (3) the grand upper, (4) the downward chopping attack, (5) the one-stage charge, (6) the two-stage charge and (7) the counter execution. When the virtual character performs the current action, the normal attack control is firstly displayed at the preset position according to the above action sequence. After touching the normal attack control to make the virtual character perform the normal attack action, the normal attack control is switched to the air pursuit control displaying at the preset position. When touching the air pursuit control, the virtual character perform an air pursuit action, and then the grand upper control is displayed at the preset position, and so on, until the user stops touching the control at the preset position or the controls in the fourth action set are sequentially performed according to the serial number, the control displayed at the preset position is not switched, or the display of the above-mentioned second action control at the preset position is cancelled.

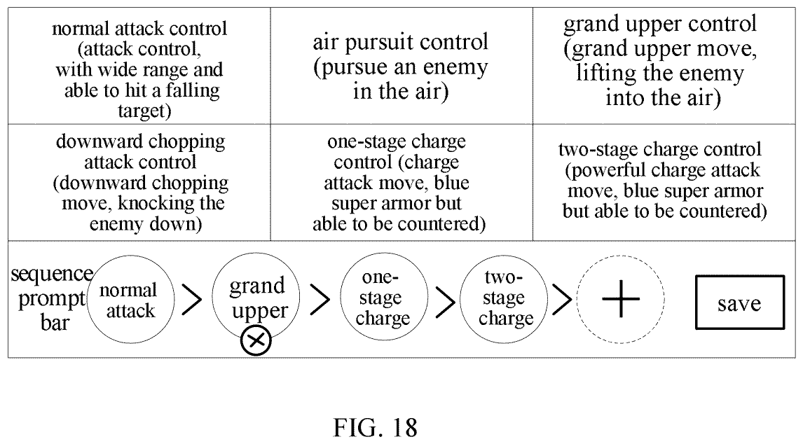

The actions in the fourth action set and the action sequence thereof may be customized. See a schematic diagram of a customized editing interface of the action set shown in FIG. 18, in which the interface provides six action controls for users to choose from, namely, a normal attack, an air pursuit, a grand upper, a downward chopping attack, a one-stage charge and a two-stage charge. The user may drag the icon of the action control to a sequence prompt bar below to add the action to a proper position in the action set. The user may also edit and modify the action sequence in the sequence prompt bar, such as deleting an action in the action set. The player may select the icon of the action in the sequence prompt bar, where a “×” may be displayed, and click the icon again to delete the action from the action set. If it is needed to continue adding actions to the action set, the player clicks the “+” control in the sequence prompt bar, and then selects the action needed to add from the action list to add it to the action set.

In order to avoid a conflict caused by one current action corresponding to multiple fourth action sets, when editing action sets again, a starting move is only allocated to one fourth action set. When the starting move is used, the icon of the action may be locked, and it is indicated that the icon cannot be set as the starting move repeatedly, such that other action sets may no longer select the action corresponding to the starting move.

When the second action control is displayed at the preset position, if there is a touch-control operation for the second action control, the virtual character is controlled to perform the second action, and the third action control is displayed at the preset position. If the touch-control operation for the second action control is not received within a first time period when the second action control is displayed, the second action control displayed at the preset position is cancelled, and the above-mentioned third action control is not displayed at the preset position.

The fourth action set is an action set determined from at least two action sets according to the current action. For example, the current action of the virtual character is the first sequential action in the fourth action set. In at least one embodiment, in order to associate the action with the fourth action set, as a possible implementation, the fourth action set is configured with a starting move, which may not be the action included in the fourth action set or may be the first action included in the fourth action set. Each fourth action set is configured with one starting move, and different fourth action sets correspond to different starting moves, such that when the current action of the virtual character is the same as the starting move, a second action control corresponding to the second action is provided in the graphical user interface according to the current action of the virtual character and the fourth action set.

After touching the attack control to trigger the virtual character to perform an attack action, if the attack action is the starting move of the fourth action set, a second action control corresponding to the second action is provided in the graphical user interface according to the fourth action set.

In order to better prompt the user, the second action control displayed at the preset position may also be marked with set prompt information, for example, text prompt information or symbol prompt information is displayed at an edge of the second action control, such that the user may know that the second action control is a special control followed by a next action, and the virtual character may be controlled sequentially and continuously by sequentially clicking the control displayed at the preset position.

In at least one embodiment, all moves in the fourth action set may be displayed circularly at the preset position, instead of just displaying the second action and the control corresponding to the second action, nor stopping displaying only after displaying the last move in the fourth action set. The icon of the second action control may be consistent with the action content. For example, if the second action control is a jump control, it may take the form of a jump control 1008 in FIG. 11.

The above-mentioned providing the second action control corresponding to the second action in the graphical user interface according to the current action of the virtual character and the fourth action set includes providing the second action control corresponding to the second action in the graphical user interface according to the virtual weapon used by the virtual character, the current action of the virtual character and the fourth action set. This method may meet the needs of a user who uses different weapons together with different fourth action sets in the game, such that the control of the virtual character is more in line with the actual application scene.

As a possible implementation, the above-mentioned providing the second action control corresponding to the second action in the graphical user interface according to the virtual weapon used by the virtual character, the current action of the virtual character and the fourth action set includes: determining candidate action sets according to the virtual weapon used by the virtual character; determining a fourth action set from the candidate action sets according to the current action of the virtual character; according to the current action of the virtual character and an action sequence of the fourth action set, providing the second action control corresponding to the second action in the graphical user interface.

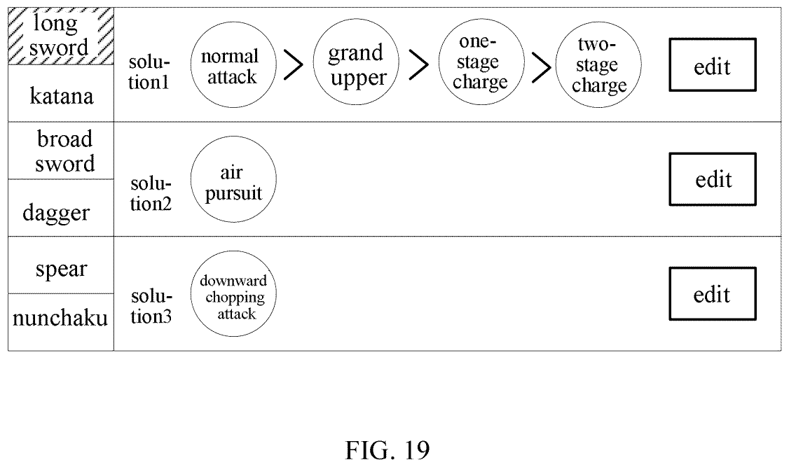

One virtual weapon may correspond to multiple action sets, which are the above-mentioned candidate action sets. The correspondence between virtual weapons and action sets may be customized. Referring to a schematic diagram of an editing interface of the correspondence between virtual weapons and action sets shown in FIG. 19. On the left side of the figure is a list of virtual weapons, which provides optional virtual weapons, such as a long sword, a katana, a broadsword, a dagger, a spear and a nunchaku. On the right side is an editing interface of the fourth action set corresponding to the currently selected virtual weapon. Each virtual weapon may have multiple fourth action sets. In the figure, taking the action set corresponding to the long sword (the currently selected virtual weapon is indicated by a diagonal filled box) including a solution 1, a solution 2 and a solution 3 as examples, the solution 1 includes a normal attack, a grand upper, a one-stage charge and a two-stage charge. The player may add actions in the set and modify the action sequence in the set through an editing control. It may also include editing the corresponding action set through the editing controls corresponding to the solution 2 and the solution 3.

In the above-mentioned way, the same action may be repeatedly used as the starting move in the candidate action sets corresponding to different virtual weapons, but the starting moves of each set are different in the candidate action sets corresponding to the same virtual weapon.

The actions in the fourth action set may be actions corresponding to non-resident controls in the graphical user interface or actions corresponding to resident controls in the graphical user interface, and the actions in the fourth action set may be triggered by a resident control in the graphical user interface or an action control at a preset position, which are independent of each other.

As a possible implementation, a control size and transparency of the action control (the control corresponding to the action in the fourth action set) displayed at the preset position and a position of the preset position in the graphical user interface may be customized according to the user's preference. The action controls displayed at the above-mentioned preset position may use the same icon, or the icons corresponding to different actions may be switched and displayed according to the action sequence in the fourth action set.

The above-mentioned second action is a next sequential action next to the current action (that is, the action that the virtual character performed last time) in the fourth action set. For example, if the virtual character is currently performing a normal attack action, the second action is the next action adjacent to the normal attack action according to the action sequence in the fourth action set.

As a possible implementation, the above-mentioned method further includes receiving a click operation on the first attack control within a first time period after controlling the virtual character to perform the first attack control in response to the click operation on the first attack control, and controlling the virtual character to perform a fourth attack control. The fourth attack action may be a charge attack or a heavy action stronger than the first attack action. That is, the user may click on the same attack control continuously within a certain period of time, thus achieving different attack injuries to the enemy virtual character.

As a possible embodiment, the above-mentioned method further includes receiving a click operation on the first attack control after the first time period after controlling the virtual character to perform the first attack action in response to the click operation on the first attack control, and controlling the virtual character to perform the first attack action. If the click operation on the first attack control is received again after the first time, the virtual character is controlled to perform the first attack action, such that multiple attacks to the same degree of the same attack control may be implemented.

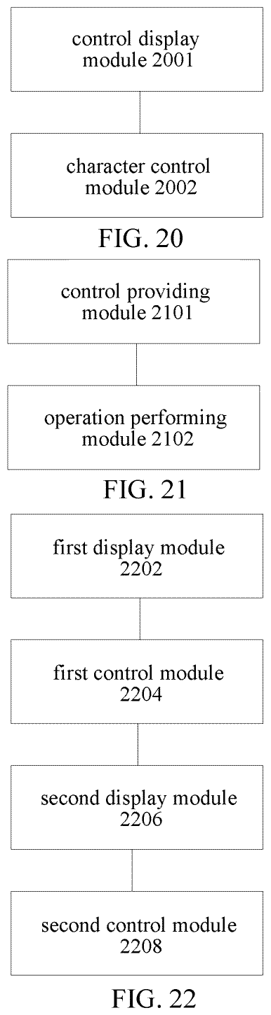

Based on the above method embodiments, an embodiment of the present disclosure also provides a virtual character control apparatus. As shown in FIG. 20, the apparatus includes:
a control display module 2001, configured to display a first attack control on a graphical user interface; and
a character control module 2002, configured to: in response to a first touch-control operation on the first attack control, if the first touch-control operation is a click operation, control the virtual character to perform a first attack action corresponding to the first attack control; and if the first touch-control operation is a sliding operation, determine a first target action from a first action set according to the sliding operation, and control the virtual character to perform the first target action.

The first attack control is displayed on the graphical user interface by the above apparatus, and the user may control the virtual character to perform the first attack action by touching the control. The user may also determine the first target action from the first action set by touching the first attack control, and control the virtual character to perform the first target action. That is, the first attack control may not only control the virtual character to perform the first attack action, but also control the virtual character to perform the first target action. Specifically, if a first touch-control operation acting on the first attack control is a click operation, the virtual character is controlled to perform the first attack action. If the first touch-control operation is a sliding operation, the first target action is determined from the first action set according to the sliding operation, and the virtual character is controlled to perform the first target action. The first target action may be the first attack action as described above or other actions. If the user needs to control the virtual character to perform the first attack action, he/she may click the first attack control originally displayed in the graphical user interface. If the user needs to control the virtual character to perform a jump action, a defensive action and other actions, it may be implemented not only by touching a jump control and a defensive control originally displayed in the graphical user interface, but also by performing a sliding operation on the first attack control. The above-mentioned way of determining the first target action from the first action set according to the sliding operation enables the user to realize a connection between the first attack action and the first target action more quickly and continuously. When it is necessary to control the virtual character to perform a certain action in the first action set, the first target action may be accurately determined from the first action set according to the sliding operation only via the sliding operation acting on the first attack control, without the need for the user to lift his finger and click other controls in the graphical user interface. During the whole process from the first attack action to the first target action of the virtual character, it is not necessary for the user to find and locate another control (a control corresponding to actions such as a defensive action and a jump action) in the interface, and the first target action may be easily determined from the first action set through the sliding operation on the first attack control, so as to control the virtual character to perform the first target action, thus realizing a rapid control of the virtual character, such as quickly controlling an attack move transformation or an attack and defense conversion. In such operation process, the users may realize control switching without lifting his finger and shifting his gaze, and the user may react quickly in the interaction, operate more conveniently, which effectively alleviates a problem of misoperation caused by relatively more interface controls. Such way of quickly controlling the virtual character also improves a consistency of user operations.

The first action set includes direction information and action information corresponding to the direction information. Correspondingly, the character control module 2002 is further configured to: determine an action in the first action set that matches a direction of the sliding operation as the first target action.

The character control module 2002 is further configured to determine the first target action from the first action set according to the sliding operation and a state of the virtual character.

The first action set includes at least two action subsets. Correspondingly, the character control module 2002 is further configured to: determine a target action subset from the first action set according to the state of the virtual character; and determine the first target action from the target action subset according to the sliding operation.

The state of the virtual character includes: a ground state and a hovering state.

The first action set is a user-defined set.

The character control module 2002 is further configured to: if the first touch-control operation is a long press operation, display a first control set, determine a first target control from controls included in the first control set according to a sliding operation continuous with the long press operation, and control the virtual character to perform an action corresponding to the first target control, where the controls included in the first control set correspond to actions included in the first action set.

The first action set includes a first subset of action and a second subset of action, where the first subset of action is an action set corresponding to a resident control in the graphical user interface, and the second subset of action is an action set corresponding to a non-resident control in the graphical user interface.

a direction from the first attack control to a third control in the first control set is different from a direction from the first control to a fourth control in the first control set.

The character control module 2002 is further configured to: confirm the first target action from the first action set according to a sliding trajectory of the sliding operation.

The character control module 2002 is further configured to: if the first touch-control operation is the sliding operation, determine the first target action from the first action set according to the sliding operation, and determine whether an action interruption condition is met or not according to a current action state of the virtual character and the first target action; and if the action interruption condition is met, control the virtual character to perform the first target action. If the action interruption condition is not met, the virtual character is not controlled to perform the first target action. In at least one embodiment, if the action interruption condition is not met, the virtual character is controlled to continue to perform a currently unfinished action.

The character control module 2002 is further configured to receive a click operation acting on the first attack control within a first time period after controlling the virtual character to perform the first attack action in response to the click operation acting on the first attack control, and control the virtual character to perform a fourth attack action.

The character control module 2002 is further configured to receive a click operation acting on the first attack control after a first time period after controlling the virtual character to perform the first attack action in response to the click operation acting on the first attack control, and control the virtual character to perform the first attack action.

The control display module 2001 is further configured to display a first control on the graphical user interface. Correspondingly, the character control module 2002 is further configured to control the virtual character to perform an action corresponding to the first control in response to a second touch-control operation acting on the first control.

The above-mentioned action corresponding to the first control may be a non-aggressive action. The above-mentioned action corresponding to the first control may be a defensive action, an evasive action, a jump action, a squat action or a crawling action.

In at least one embodiment, the above-mentioned first action set includes actions corresponding to the first control.

The first control and the first attack control displayed on the graphical user interface are resident controls in the graphical user interface. The first action set includes a first subset of action and a second subset of action, where the first subset of action is an action set corresponding to a resident control in the graphical user interface, and the second subset of action is an action set corresponding to a non-resident control in the graphical user interface.

The first control set includes a first control subset and a second control subset, where controls included in the first control subset are a subset of resident controls, and controls included in the second control subset are a subset of non-resident controls.

The above-mentioned control display module 2001 is further configured to: display a second attack control on the graphical user interface. An attack angle of the first attack action corresponding to the first attack control is different from an attack angle of a second attack action corresponding to the second attack control.

The character control module 2002 is further configured to: in response to a third touch-control operation acting on the second attack control, if the third touch-control operation is a click operation, control the virtual character to perform the second attack action corresponding to the second attack control; and if the third touch-control operation is a sliding operation, determine a second target action from a second action set according to the sliding operation, and control the virtual character to perform the second target action. If the third touch-control operation is a long press operation, a second control set is displayed, a second target control is determined from controls included in the second control set according to a sliding operation continuous with the long press operation, and the virtual character is controlled to perform an action corresponding to the second target control. The controls included in the second control set correspond to actions included in the second action set.

The above-mentioned control display module 2001 is further configured to cancel displaying the second control set. In at least one embodiment, in response to an end of the third touch-control operation, the display of the second control set is cancelled.

The character control module 2002 is further configured to: control the virtual character to perform a third attack action if the first touch-control operation is a long press operation and a press duration of the long press operation is greater than or equal to a first time threshold; if the first touch-control operation is the long press operation, control the virtual character to perform a preparation action for the third attack action, and control the virtual character to perform the third attack action after the press duration is greater than or equal to a first time threshold; if the first touch-control operation is the long press operation and the press duration of the long press operation is greater than or equal to the first time threshold and less than a second time threshold at an end of the long press operation, trigger the virtual character to perform the third attack action at the end of the long press operation, where the second time threshold is greater than the first time threshold; if the first touch-control operation is the long press operation and the press duration of the long press operation is equal to the second time threshold, automatically trigger the virtual character to perform the third attack action; if the first touch-control operation is the long press operation and the press duration of the long press operation is greater than or equal to a first time threshold and less than a second time threshold, in response to a sliding operation continuous with the long press operation, determine a third target action from the first action set, and control the virtual character to perform the third target action.

In at least one embodiment, the character control module 2002 is fturther configured to confirm the first target action from the first action set according to a sliding trajectory of the sliding operation.

The above-mentioned control display module 2001 is further configured to display a first roulette including the first control set, and controls in the first control set are arranged on the first roulette.

The above-mentioned first roulette surrounds the first attack control.

The above-mentioned first roulette surrounds a preset position in a blank area in the graphical user interface.

A direction from the first attack control to a third control in the first control set is different from a direction from the first attack control to a fourth control in the first control set.

The above-mentioned control display module 2001 is further configured to: display a first control indication in a first direction of the first attack control, and display a second control indication in a second direction of the first attack control, where the first control indication is used to indicate that controls in the first control set are displayed in the first direction of the first attack control when the first control set corresponding to the first attack control is displayed, and the second control indication is used to indicate that the controls in the first control set are displayed in the second direction of the first attack control when the first control set corresponding to the first attack control is displayed.

An included angle between a ray originating from the first attack control toward a third control in the first control set and a ray originating from the first attack control toward a fourth control in the first control set is greater than an angle threshold.

The above-mentioned first control is an evasion control. The character control module 2002 is further configured to: control the virtual character to perform a first evasive action in response to a click operation on the evasion control; control the virtual character to perform a second evasive action in response to a long press operation on the evasion control, where an evasive distance of the first evasive action and an evasive distance of the second evasive action are different and/or a state after the first evasive action and a state after the second evasive action are different, and the state includes jogging or sprinting.

The above-mentioned first attack action may be a contact attack action performed via limbs and/or a weapon of the virtual character.

The above-mentioned character control module 2002 is further configured to: if the first touch-control operation is a sliding operation, determine the first target control from controls included in the first control set according to the sliding operation, and determining whether an action interruption condition is met according to a current action state of the virtual character and the action corresponding to the first target control; and if the action interruption condition is met, control the virtual character to perform the action corresponding to the first target control.

The above-mentioned graphical user interface further includes a sixth control, and the sixth control is a jump control. The character control module 2002 is further configured to: in response to a fourth touch-control operation acting on the sixth control, control the virtual character to perform a jump action if the fourth touch-control operation is a click operation; and if the fourth touch-control operation is a sliding operation, determine a fourth target action from a third action set according to the sliding operation, and control the virtual character to perform the fourth target action, where the third action set at least includes a crouching action; if the fourth touch-control operation is a long press operation, display a third control set, determine a fourth target control from controls included in the third control set according to a sliding operation continuous with the long press operation, and control the virtual character to perform an action corresponding to the fourth target control; in response to an end of the fourth touch-control operation, cancel displaying the third control set; and in response to the end of the fourth touch-control operation, cancel displaying the third control set.

The above-mentioned control display module 2001 is further configured to: display a seventh control on the graphical user interface, where the seventh control is a skill control for triggering the virtual character to perform a skill release, and the second control is an action control for triggering the virtual character to perform the first attack action.

A skill corresponding to the above-mentioned skill control has a cooling time, and an action corresponding to the action control does not have the cooling time.

There are a first virtual character and a second virtual character in a virtual environment corresponding to the graphical user interface, and a skill of the first virtual character is different from a skill of the second virtual character. Both the first virtual character and the first virtual character may perform the first attack action.

The first attack action is a contact attack action performed via limbs and/or a weapon of the virtual character.

Based on the above-mentioned method embodiments, an embodiment of the present disclosure further provides a virtual character control apparatus. As shown in FIG. 21, the apparatus includes:
a control providing module 2101, configured to provide a second action control corresponding to a second action at a preset position of a graphical user interface according to a current action of a virtual character and a fourth action set; and
an operation performing module 2102, configured to control the virtual character to perform the second action in response to a trigger operation for the second action control.

When the virtual character performs the current action, by providing the second action control corresponding to the second action at the preset position of the graphical user interface according to the current action of the virtual character and the fourth action set, the apparatus may make it more convenient to trigger the virtual character to perform the second action when the virtual character performs the current action. The way of providing the second action control at the preset position may not only reduce the redundancy of controls resident in the page of the second action control, but also facilitate the touch of the second action control and reduce the problem of touching the control by mistake.

The fourth action set includes at least two actions and an action sequence.

The control providing module 2101 is further configured to provide the second action control corresponding to the second action in the graphical user interface according to the current action of the virtual character and the action sequence of the fourth action set.

The control providing module 2101 is further configured to provide a third action control corresponding to a third action at the preset position of the graphical user interface according to the second action and the fourth action set. Accordingly, the operation performing module 2102 is further configured to control the virtual character to perform the third action in response to a trigger operation for the third action control.

The fourth action set is an action set determined from at least two action sets according to the current action. The current action is the first-order action of the second action set.

Further, the control providing module 2101 is further configured to provide the second action control corresponding to the second action in the graphical user interface according to a virtual weapon used by the virtual character, the current action of the virtual character and the fourth action set.

The control providing module 2101 is further configured to determine candidate action sets according to the virtual weapon used by the virtual character; determining the fourth action set from the candidate action sets according to the current action of the virtual character; and providing the second action control corresponding to the second action in a graphical user interface according to the current action of the virtual character and the action sequence of the fourth action set.

As a possible implementation, the second action is a next sequential action next to the current action in the fourth action set.

Based on the above method embodiments, an embodiment of the present disclosure also provides a virtual character control apparatus. As shown in FIG. 22, the apparatus includes:
a first display module 2202, configured to display a first control and a second control on a graphical user interface, where the second control is a first attack control;
a first control module 2204, configured to control the virtual character to perform an action corresponding to the first control in response to a second touch-control operation acting on the first control;
a second display module 2206, configured to: display a first control set in response to a long press operation on the second control, where the first control set at least includes a third control, and the third control is used to trigger the virtual character to perform the action corresponding to the first control; and if a touch-control operation acting on the second control is a click operation, not display the first control set, and control the virtual character to perform a first attack action corresponding to the second control; and
a second control module 2208, configured to: in response to a sliding operation continuous with the long press operation acting on the second control, determine a first target control from controls included in the first control set according to the sliding operation, and control the virtual character to perform an action corresponding to the first target control.

According to the above-mentioned virtual character control apparatus provided by one or more embodiment of the present disclosure, a user (player) may control a virtual character to perform an action (such as a jump action, a defensive action, etc.) corresponding to the first control by touching a first control in a graphical user interface. The user performs a long press on a first attack control (i.e. a second control) in the graphical user interface to display the control set corresponding to the first attack control (denoted by a first control set). The first control set includes a third control that may be used to trigger and control the virtual character to perform an action corresponding to the first control. If the long press operation is followed by a sliding operation, a first target control is determined from controls included in the first control set according to the sliding operation, and the virtual character is controlled to perform an action corresponding to the first target control. If the first target control is a third control in the first control set, the virtual character may be controlled to perform the action corresponding to the first control in the graphical user interface. In this way, if the user needs to control the virtual character to perform the first attack action, he/she may click the first attack control originally displayed on the graphical user interface, and perform a long press on the first attack control to display the control set corresponding to the first attack control (denoted by the first control set). The first control set includes the third control that may be used to trigger and control the virtual character to perform an action corresponding to the first control. If the user needs to control the virtual character to perform a jump action, a defensive action and other actions, it may be implemented by touching the first control originally displayed on the graphical user interface. The third control in the control set (denoted by the first control set) may be triggered by a sliding operation acting on the first attack control, so as to control the virtual character to perform the jump action, the defensive action and the other actions. The above-mentioned first control set displayed may enable the user to determine a position of each control in the control set more intuitively and clearly. When a control in the first control set needs to be operated, the first target control may be accurately determined from the first control set according to the sliding operation without the user lifting his finger and clicking on other controls in the graphical interface. During the whole process, The user does not need to find and locate another control (a control corresponding to a defensive action, a jump action, etc.) in the interface, and the sliding operation on the second control may easily determine the first target control from the first control set, thus triggering the virtual character to perform an action corresponding to the first target control, and realizing a rapid control of the virtual character, such as quickly controlling an attack move transformation or an attack and defense conversion. The first control set may be displayed in the case that the second control is pressed for a long time, which provides an intuitive reference for the user to operate the control. The user does not need to remember an operation mode of triggering a control in the first control set, but may slide towards which control in the first control set needs to be operated. If the user has memorized a corresponding relationship between each control in the first control set and a sliding operation direction, the user may not perform a long press on the second control, such that the first control set will not be displayed, which reduces an occlusion of the interface by the first control set to a certain extent and improves a switching speed and a consistency of actions of the virtual character to a certain extent.

In the above-mentioned embodiment, whether the first control set is displayed or not, during the operation, the user may realize control switching without lifting his finger and shifting his gaze, so he/she may react quickly in the interaction, and the operation is more convenient, effectively alleviating the misoperation problem caused by relatively more interface controls. This way of quickly controlling the virtual character also improves the consistency of user operations.

The virtual character control apparatus provided by the embodiments of the present disclosure has the same implementation principle and technical effects as those of the above-mentioned embodiments of the virtual character control method. To simplify the description, parts not mentioned in the embodiments of the virtual character control apparatus may refer to the corresponding contents of the above-mentioned embodiments of the virtual character control method.

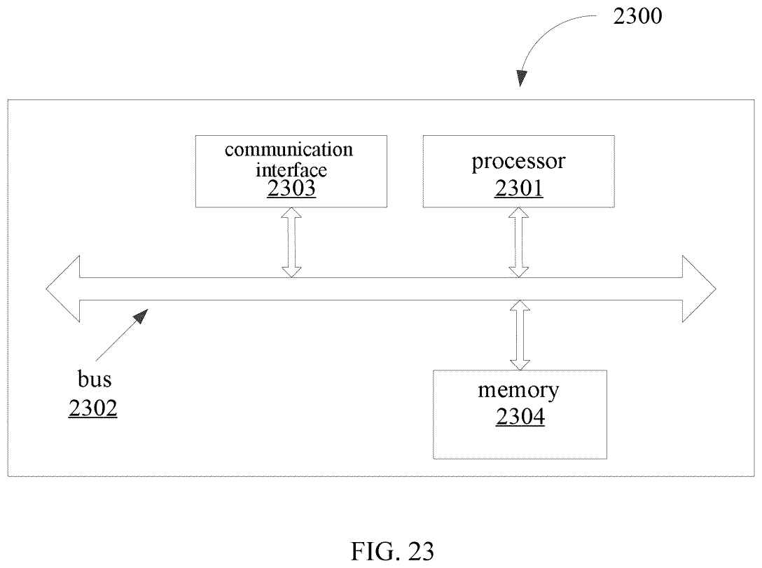

An embodiment of the present disclosure further provides an electronic device, as shown in FIG. 23, which is a structural schematic diagram of the electronic device. The electronic device 2300 includes a processor 2301 and a memory 2304, and the memory 2304 stores a computer-executable instruction that may be executed by the processor 2301, and the processor 2301 performs the computer-executable instruction to realize the virtual character control method.

Specifically, the processor 2301 may perform the following steps:
displaying a first attack control on a graphical user interface; and
in response to a first touch-control operation acting on the first attack control, if the first touch-control operation is a click operation, controlling the virtual character to perform a first attack action corresponding to the first attack control; and if the first touch-control operation is a sliding operation, determining a first target action from a first action set according to the sliding operation, and controlling the virtual character to perform the first target action.

In an alternative implementation, based on the above solution, the above-mentioned first action set includes direction information and action information corresponding to the direction information. The above-mentioned determining the first target action from the first action set according to the sliding operation may be specifically implemented by performing the following step: determining an action in the first action set that matches a direction of the sliding operation as the first target action.

In an alternative implementation, based on the above solution, the above-mentioned determining the first target action from the first action set according to the sliding operation may be specifically implemented by performing the following step: determining the first target action from the first action set according to the sliding operation and a state of the virtual character.

In an alternative implementation, based on the above solution, the above-mentioned first action set includes at least two action subsets. The above-mentioned determining the first target action from the first action set according to the sliding operation and the state of the virtual character may be specifically implemented by performing the following steps: determining a target action subset from the first action set according to the state of the virtual character; and determining the first target action from the target action subset according to the sliding operation.

In an alternative implementation, based on the above solution, the above-mentioned state of the virtual character includes: a ground state and a hovering state.

In an alternative implementation, based on the above solution, the above-mentioned first action set is a user-defined set.

In an alternative implementation, based on the above solution, the following steps may be further performed: displaying a first control on the graphical user interface; and in response to a second touch-control operation acting on the first control, controlling the virtual character to perform an action corresponding to the first control.

In an alternative implementation, based on the above solution, the following step may be further performed: the first action set including the action corresponding to the first control.

In an alternative implementation, based on the above solution, the following step may be performed: if the first touch-control operation is a long press operation, displaying a first control set, determining a first target control from controls included in the first control set according to a sliding operation continuous with the long press operation, and controlling the virtual character to perform an action corresponding to the first target control, where the controls included in the first control set correspond to actions included in the first action set.

In an alternative implementation, based on the above solution, the above-mentioned action corresponding to the first control is a non-aggressive action.

In an alternative implementation, based on the above solution, the above-mentioned action corresponding to the first control is a defensive action, an evasive action, a jump action, a squat action, a sliding tackle action or a crawling action.

In an alternative implementation, based on the above solution, the following step may be further performed: cancelling displaying the first control set.

In an alternative implementation, based on the above solution, the above-mentioned cancelling displaying the first control set may be specifically implemented by performing the following step: in response to an end of the first touch-control operation, cancelling displaying the first control set.

In an alternative implementation, based on the above solution, the first control and the first attack control displayed on the graphical user interface are resident controls in the graphical user interface.

In an alternative implementation, based on the above solution, the above-mentioned first action set includes a first subset of action and a second subset of action, where the first subset of action is an action set corresponding to a resident control in the graphical user interface, and the second subset of action is an action set corresponding to a non-resident control in the graphical user interface.

In an alternative implementation, based on the above solution, the above-mentioned first control set includes a first control subset and a second control subset, where controls included in the first control subset are a subset of resident controls, and controls included in the second control subset are a subset of non-resident controls.

In an alternative implementation, based on the above solution, the following step may be further performed: displaying a second attack control on the graphical user interface, where an attack angle of the first attack action corresponding to the first attack control is different from an attack angle of a second attack action corresponding to the second attack control.

In an alternative implementation, based on the above solution, the following step may be further performed: in response to a third touch-control operation acting on the second attack control, if the third touch-control operation is a click operation, controlling the virtual character to perform the second attack action corresponding to the second attack control; and if the third touch-control operation is a sliding operation, determining a second target action from a second action set according to the sliding operation, and controlling the virtual character to perform the second target action.

In an alternative implementation, based on the above solution, the following step may be further performed: if the third touch-control operation is a long press operation, displaying a second control set, determining a second target control from controls included in the second control set according to a sliding operation continuous with the long press operation, and controlling the virtual character to perform an action corresponding to the second target control, where the controls included in the second control set correspond to actions included in the second action set.

In an alternative implementation, based on the above solution, the following step may also be performed: cancelling displaying the second control set.

In an alternative implementation, based on the above solution, the above-mentioned cancelling displaying the second control set may be specifically implemented by performing the following step: in response to an end of the third touch-control operation, cancelling displaying the second control set.

In an alternative implementation, based on the above solution, the following step may be further performed: if the first touch-control operation is the long press operation and a press duration of the long press operation is greater than or equal to a first time threshold, controlling the virtual character to perform a third attack action.

In an alternative implementation, based on the above solution, if the first touch-control operation is the long press operation and the press duration of the long press operation is greater than or equal to the first time threshold, controlling the virtual character to perform the third attack action may be specifically implemented by performing the following step: if the first touch-control operation is the long press operation, controlling the virtual character to perform a preparation action for the third attack action, and controlling the virtual character to perform the third attack action after the press duration is greater than or equal to the first time threshold.

In an alternative implementation, based on the above solution, if the first touch-control operation is a long press operation and the press duration is greater than or equal to the first time threshold, controlling the virtual character to perform the third attack action may be specifically implemented by performing the following step: if the first touch-control operation is the long press operation and the press duration of the long press operation is greater than or equal to the first time threshold and less than a second time threshold at an end of the long press operation, triggering the virtual character to execute the third attack action at the end of the long press operation, where the second time threshold is greater than the first time threshold.

In an alternative implementation, based on the above solution, the following step may be further performed: if the first touch-control operation is the long press operation and the press duration of the long press operation is equal to the second time threshold, automatically triggering the virtual character to perform the third attack action.

In an alternative implementation, based on the above solution, the following step may be further performed: if the first touch-control operation is the long press operation and the press duration of the long press operation is greater than or equal to the first time threshold and less than the second time threshold, in response to a sliding operation continuous with the long press operation, determining a third target action from the first action set, and controlling the virtual character to perform the third target action.

In an alternative implementation, based on the above solution, the above-mentioned determining the first target action from the first action set according to the sliding operation may be specifically implemented by performing the following step: confirming the first target action from the first action set according to a sliding trajectory of the sliding operation.

In an alternative implementation, based on the above solution, the above-mentioned displaying the first control set may be specifically implemented by performing the following step: displaying a first roulette including the first control set, where controls in the first control set are arranged on the first roulette.

In an alternative implementation, based on the above solution, the above-mentioned first roulette surrounds the first attack control.

In an alternative implementation, based on the above solution, the above-mentioned first roulette surrounds a preset position in a blank area in the graphical user interface.

In an alternative implementation, based on the above solution, a direction from the first attack control to a third control in the first control set is different from a direction from the first attack control to a fourth control in the first control set.

In an alternative implementation, based on the above solution, the following step may be further performed: displaying a first control indication in a first direction of the first attack control, and displaying a second control indication in a second direction of the first attack control, where the first control indication is used to indicate that controls in the first control set are displayed in the first direction of the first attack control when the first control set corresponding to the first attack control is displayed, and the second control indication is used to indicate that the controls in the first control set are displayed in the second direction of the first attack control when the first control set corresponding to the first attack control is displayed.

In an alternative implementation, based on the above solution, an included angle between a ray originating from the first attack control toward a third control in the first control set and a ray originating from the first attack control toward a fourth control in the first control set is greater than an angle threshold.

In an alternative implementation, based on the above solution, the above-mentioned first control is an evasion control. The following steps may be fuirther performed: controlling the virtual character to perform a first evasive action in response to a click operation on the evasion control; and controlling the virtual character to perform a second evasive action in response to a long press operation on the evasion control, where an evasive distance of the first evasive action and an evasive distance of the second evasive action are different and/or a state after the first evasive action and a state after the second evasive action are different, and the state includes jogging or sprinting.

In an alternative implementation, based on the above solution, the above-mentioned graphical user interface further includes a sixth control, and the sixth control is a jump control, and the following step may be performed: in response to a fourth touch-control operation acting on the sixth control, if the fourth touch-control operation is a click operation, controlling the virtual character to perform a jump action; and if the fourth touch-control operation is a sliding operation, determining a fourth target action from a third action set according to the sliding operation, and controlling the virtual character to perform the fourth target action, where the third action set at least includes a crouching action.

In an alternative implementation, based on the above solution, the following steps may be further performed: if the fourth touch-control operation is a long press operation, displaying a third control set, determining a fourth target control from controls included in the third control set according to a sliding operation continuous with the long press operation, and controlling the virtual character to perform an action corresponding to the fourth target control; and in response to an end of the fourth touch-control operation, cancelling displaying the third control set.

In an alternative implementation, based on the above solution, the following step may be further performed: displaying a seventh control on the graphical user interface, where the seventh control is a skill control for triggering the virtual character to perform a skill release, and the first attack control is an action control for triggering the virtual character to perform the first attack action.

In an alternative implementation, based on the above solution, a skill corresponding to the skill control has a cooling time, and an action corresponding to the action control does not have the cooling time.

In an alternative implementation, based on the above solution, there are a first virtual character and a second virtual character in a virtual environment corresponding to the graphical user interface, and a skill of the first virtual character is different from a skill of the second virtual character, where both the first virtual character and the first virtual character may perform the first attack action.

In an alternative implementation, based on the above solution, the above-mentioned first attack action is a contact attack action performed via limbs and/or a weapon of the virtual character.

In an alternative implementation, based on the above solution, if the first touch-control operation is the sliding operation, determining the first target action from the first action set according to the sliding operation, and controlling the virtual character to perform the first target action may be specifically implemented by performing the following steps: determining the first target action from the first action set according to the sliding operation, and determining whether an action interruption condition is met or not according to a current action state of the virtual character and the first target action; and if the action interruption condition is met, controlling the virtual character to perform the first target action.

In an alternative implementation, based on the above solution, the following step may be further performed: if the action interruption condition is not met, not controlling the virtual character to perform the first target action.

In an alternative implementation, based on the above solution, the following step may be further performed: if the action interruption condition is not met, controlling the virtual character to continue to perform a currently unfinished action.

In an alternative implementation, based on the above solution, the following steps may be further performed: providing a second action control corresponding to a second action at a preset position of the graphical user interface according to a current action of the virtual character and a fourth action set; and controlling the virtual character to perform the second action in response to a trigger operation for the second action control.

In an alternative implementation, based on the above solution, the above-mentioned fourth action set includes at least two actions and an action sequence.

In an alternative implementation, the above-mentioned providing the second action control corresponding to the second action in the graphical user interface according to the current action of the virtual character and the fourth action set may be specifically implemented by performing the following step: providing the second action control corresponding to the second action in the graphical user interface according to the current action of the virtual character and the action sequence of the fourth action set.

In an alternative implementation, based on the above solution, the following steps may be further performed: providing a third action control corresponding to a third action at the preset position of the graphical user interface according to the second action and the fourth action set; and controlling the virtual character to perform the third action in response to a trigger operation for the third action control.

In an alternative implementation, based on the above solution, the above-mentioned fourth action set is an action set determined from at least two action sets according to the current action.

In an alternative implementation, based on the above solution, the above-mentioned providing the second action control corresponding to the second action in the graphical user interface according to the current action of the virtual character and the fourth action set may be specifically implemented by performing the following step: providing the second action control corresponding to the second action in the graphical user interface according to a virtual weapon used by the virtual character, the current action of the virtual character and the fourth action set.

In an alternative implementation, based on the above solution, the above-mentioned providing the second action control corresponding to the second action in the graphical user interface according to the virtual weapon used by the virtual character, the current action of the virtual character and the fourth action set may be specifically implemented by performing the following steps: determining candidate action sets according to the virtual weapon used by the virtual character; determining the fourth action set from the candidate action sets according to the current action of the virtual character; and providing the second action control corresponding to the second action in the graphical user interface according to the current action of the virtual character and an action sequence of the fourth action set.

In an alternative implementation, based on the above solution, the above-mentioned second action is a next sequential action next to the current action in the fourth action set.

In an alternative implementation, based on the above solution, the following step may be further performed: receiving a click operation acting on the first attack control within a first time period after the controlling the virtual character to perform the first attack control in response to the click operation acting on the first attack control, and controlling the virtual character to perform a fourth attack control.

In an alternative implementation, based on the above solution, the following step may be further performed: receiving a click operation acting on the first attack control after a first time period after the controlling the virtual character to perform the first attack action in response to the click operation acting on the first attack control, and controlling the virtual character to perform the first attack action.

In the control process of the virtual character as described above, a user (player) may control the virtual character to perform the first attack action by touching the first attack control in the graphical user interface. The user may also determine the first target action from the first action set by touching the first attack control in the graphical user interface, and control the virtual character to perform the first target action. That is, the first attack control may not only control the virtual character to perform the first attack action, but also control the virtual character to perform the first target action. Specifically, if the first touch-control operation acting on the first attack control is a click operation, the virtual character is controlled to perform the first attack action. If the first touch-control operation is a sliding operation, the first target action is determined from the first action set according to the sliding operation, and the virtual character is controlled to perform the first target action. The first target action may be the first attack action as described above or other actions. In this way, if the user needs to control the virtual character to perform the first attack action, he/she may click the first attack control originally displayed in the graphical user interface. If the user needs to control the virtual character to perform a jump action, a defensive action and other actions, it may be implemented not only by touching a jump control and a defensive control originally displayed in the graphical user interface, but also by performing a sliding operation on the first attack control. The above-mentioned way of determining the first target action from the first action set according to the sliding operation enables the user to realize a connection between the first attack action and the first target action more quickly and continuously. When it is necessary to control the virtual character to perform a certain action in the first action set, the first target action may be accurately determined from the first action set according to the sliding operation only via the sliding operation acting on the first attack control, without the need for the user to lift his finger and click other controls in the graphical user interface. During the whole process from the first attack action to the first target action of the virtual character, it is not necessary for the user to find and locate another control (a control corresponding to actions such as defensive action and jump action) in the interface, and the first target action may be easily determined from the first action set through the sliding operation on the first attack control, so as to trigger the virtual character to perform the first target action, thus realizing a rapid control of the virtual character, such as quickly controlling an attack move transformation or an attack and defense conversion. In such operation process, the user may realize control switching without lifting his finger and shifting his gaze, and the user may react quickly in the interaction, operate more conveniently, which effectively alleviates a problem of misoperation caused by relatively more interface controls. Such way of quickly controlling the virtual character also improves a consistency of user operations.

In an implementation shown in FIG. 23, the electronic device 2300 further includes a bus 2302 and a communication interface 2303. The processor 2301, the communication interface 2303 and the memory 2304 are connected through the bus 2302.

The memory 2304 may include a high-speed random access memory (RAM) or a non-volatile memory, such as at least one disk memory. A communication connection between the system network element and at least one other network element is implemented through at least one communication interface 2303 (which may be wired or wireless), and the Internet, wide area network, local network, metropolitan area network and the like may be used. The bus 2302 may be an industry standard architecture (ISA) bus, a peripheral component interconnect (PCI) bus or an extended industry standard architecture (EISA) bus. The bus 2302 may be divided into an address bus, a data bus, a control bus, and the like. For the convenience of representation, only one double-headed arrow is used in FIG. 23, but it does not mean that there is only one bus or one type of bus.

The processor 2301 may be an integrated circuit chip with signal processing capability. In the implementation process, each step of the above method may be completed by an integrated logic circuit in the form of hardware or an instruction in the form of software in the processor 2301. The processor 2301 may be a general-purpose processor, including a central processing unit (CPU) and a network processor (NP), etc. The processor 2301 may also be a digital signal processor (DSP), an application specific integrated circuit (ASIC), a field-programmable gate array (FPGA) or other programmable logic devices, discrete gate or transistor logic devices, and discrete hardware components. The general processor may be a microprocessor or the processor may be any conventional processor, etc. The steps of the method disclosed in combination with the embodiments of the present disclosure may be directly embodied as being performed by a hardware decoding processor, or performed by a combination of hardware and software modules in the decoding processor. Software modules may be located in a random access memory, a flash memory, a read-only memory, a programmable read-only memory or an electrically erasable programmable memory, a register and other mature storage media in the art. The storage medium is located in the memory, and the processor 2301 reads the information in the memory, and completes the steps of the virtual character control method of the aforementioned embodiments in combination with its hardware.

An embodiment of the present disclosure also provides a non-transitory computer-readable storage medium, which stores a computer-executable instruction, and when the computer-executable instruction is called and executed by a processor, the computer-executable instruction causes the processor to realize the above-mentioned virtual character control method, and the specific implementation may be seen in the above-mentioned method embodiments.

Specifically, the computer-executable instruction stored on the non-transitory computer-readable storage medium may cause the processor to perform the following steps:
displaying a first attack control on a graphical user interface; and
in response to a first touch-control operation acting on the first attack control, if the first touch-control operation is a click operation, controlling the virtual character to perform a first attack action corresponding to the first attack control; and if the first touch-control operation is a sliding operation, determining a first target action from a first action set according to the sliding operation, and controlling the virtual character to perform the first target action.

In an alternative implementation, based on the above solution, the above-mentioned first action set includes direction information and action information corresponding to the direction information. The above-mentioned determining the first target action from the first action set according to the sliding operation may be specifically implemented by performing the following step: determining an action in the first action set that matches a direction of the sliding operation as the first target action.

In an alternative implementation, based on the above solution, the above-mentioned determining the first target action from the first action set according to the sliding operation may be specifically implemented by performing the following step: determining the first target action from the first action set according to the sliding operation and a state of the virtual character.

In an alternative implementation, based on the above solution, the above-mentioned first action set includes at least two action subsets. The above-mentioned determining the first target action from the first action set according to the sliding operation and the state of the virtual character may be specifically implemented by performing the following steps: determining a target action subset from the first action set according to the state of the virtual character; and determining the first target action from the target action subset according to the sliding operation.

In an alternative implementation, based on the above solution, the above-mentioned state of the virtual character includes: a ground state and a hovering state.

In an alternative implementation, based on the above solution, the above-mentioned first action set is a user-defined set.

In an alternative implementation, based on the above solution, the following steps may be further performed: displaying a first control on the graphical user interface; and in response to a second touch-control operation acting on the first control, controlling the virtual character to perform an action corresponding to the first control.

In an alternative implementation, based on the above solution, the following step may be further performed: the first action set including the action corresponding to the first control.

In an alternative implementation, based on the above solution, the following step may be performed: if the first touch-control operation is a long press operation, displaying a first control set, determining a first target control from controls included in the first control set according to a sliding operation continuous with the long press operation, and controlling the virtual character to perform an action corresponding to the first target control, where the controls included in the first control set correspond to actions included in the first action set.

In an alternative implementation, based on the above solution, the above-mentioned action corresponding to the first control is a non-aggressive action.

In an alternative implementation, based on the above solution, the above-mentioned action corresponding to the first control is a defensive action, an evasive action, a jump action, a squat action, a sliding tackle action or a crawling action.

In an alternative implementation, based on the above solution, the following step may be further performed: cancelling displaying the first control set.

In an alternative implementation, based on the above solution, the above-mentioned cancelling displaying the first control set may be specifically implemented by performing the following step: in response to an end of the first touch-control operation, cancelling displaying the first control set.

In an alternative implementation, based on the above solution, the first control and the first attack control displayed on the graphical user interface are resident controls in the graphical user interface.

In an alternative implementation, based on the above solution, the above-mentioned first action set includes a first subset of action and a second subset of action, where the first subset of action is an action set corresponding to a resident control in the graphical user interface, and the second subset of action is an action set corresponding to a non-resident control in the graphical user interface.

In an alternative implementation, based on the above solution, the above-mentioned first control set includes a first control subset and a second control subset, where controls included in the first control subset are a subset of resident controls, and controls included in the second control subset are a subset of non-resident controls.

In an alternative implementation, based on the above solution, the following step may be further performed: displaying a second attack control on the graphical user interface, where an attack angle of the first attack action corresponding to the first attack control is different from an attack angle of a second attack action corresponding to the second attack control.

In an alternative implementation, based on the above solution, the following step may be further performed: in response to a third touch-control operation acting on the second attack control, if the third touch-control operation is a click operation, controlling the virtual character to perform the second attack action corresponding to the second attack control; and if the third touch-control operation is a sliding operation, determining a second target action from a second action set according to the sliding operation, and controlling the virtual character to perform the second target action.

In an alternative implementation, based on the above solution, the following step may be further performed: if the third touch-control operation is a long press operation, displaying a second control set, determining a second target control from controls included in the second control set according to a sliding operation continuous with the long press operation, and controlling the virtual character to perform an action corresponding to the second target control, where the controls included in the second control set correspond to actions included in the second action set.

In an alternative implementation, based on the above solution, the following step may also be performed: cancelling displaying the second control set.

In an alternative implementation, based on the above solution, the above-mentioned cancelling displaying the second control set may be specifically implemented by performing the following step: in response to an end of the third touch-control operation, cancelling displaying the second control set.

In an alternative implementation, based on the above solution, the following step may be further performed: if the first touch-control operation is the long press operation and a press duration of the long press operation is greater than or equal to a first time threshold, controlling the virtual character to perform a third attack action.

In an alternative implementation, based on the above solution, if the first touch-control operation is the long press operation and the press duration of the long press operation is greater than or equal to the first time threshold, controlling the virtual character to perform the third attack action may be specifically implemented by performing the following step: if the first touch-control operation is the long press operation, controlling the virtual character to perform a preparation action for the third attack action, and controlling the virtual character to perform the third attack action after the press duration is greater than or equal to the first time threshold.

In an alternative implementation, based on the above solution, if the first touch-control operation is a long press operation and the press duration is greater than or equal to the first time threshold, controlling the virtual character to perform the third attack action may be specifically implemented by performing the following step: if the first touch-control operation is the long press operation and the press duration of the long press operation is greater than or equal to the first time threshold and less than a second time threshold at an end of the long press operation, triggering the virtual character to execute the third attack action at the end of the long press operation, where the second time threshold is greater than the first time threshold.

In an alternative implementation, based on the above solution, the following step may be further performed: if the first touch-control operation is the long press operation and the press duration of the long press operation is equal to the second time threshold, automatically triggering the virtual character to perform the third attack action.

In an alternative implementation, based on the above solution, the following step may be further performed: if the first touch-control operation is the long press operation and the press duration of the long press operation is greater than or equal to the first time threshold and less than the second time threshold, in response to a sliding operation continuous with the long press operation, determining a third target action from the first action set, and controlling the virtual character to perform the third target action.

In an alternative implementation, based on the above solution, the above-mentioned determining the first target action from the first action set according to the sliding operation may be specifically implemented by performing the following step: confirming the first target action from the first action set according to a sliding trajectory of the sliding operation.

In an alternative implementation, based on the above solution, the above-mentioned displaying the first control set may be specifically implemented by performing the following step: displaying a first roulette including the first control set, where controls in the first control set are arranged on the first roulette.

In an alternative implementation, based on the above solution, the above-mentioned first roulette surrounds the first attack control.

In an alternative implementation, based on the above solution, the above-mentioned first roulette surrounds a preset position in a blank area in the graphical user interface.

In an alternative implementation, based on the above solution, a direction from the first attack control to a third control in the first control set is different from a direction from the first attack control to a fourth control in the first control set.

In an alternative implementation, based on the above solution, the following step may be further performed: displaying a first control indication in a first direction of the first attack control, and displaying a second control indication in a second direction of the first attack control, where the first control indication is used to indicate that controls in the first control set are displayed in the first direction of the first attack control when the first control set corresponding to the first attack control is displayed, and the second control indication is used to indicate that the controls in the first control set are displayed in the second direction of the first attack control when the first control set corresponding to the first attack control is displayed.

In an alternative implementation, based on the above solution, an included angle between a ray originating from the first attack control toward a third control in the first control set and a ray originating from the first attack control toward a fourth control in the first control set is greater than an angle threshold.

In an alternative implementation, based on the above solution, the above-mentioned first control is an evasion control. The following steps may be fuirther performed: controlling the virtual character to perform a first evasive action in response to a click operation on the evasion control; and controlling the virtual character to perform a second evasive action in response to a long press operation on the evasion control, where an evasive distance of the first evasive action and an evasive distance of the second evasive action are different and/or a state after the first evasive action and a state after the second evasive action are different, and the state includes jogging or sprinting.

In an alternative implementation, based on the above solution, the above-mentioned graphical user interface further includes a sixth control, and the sixth control is a jump control, and the following step may be performed: in response to a fourth touch-control operation acting on the sixth control, if the fourth touch-control operation is a click operation, controlling the virtual character to perform a jump action; and if the fourth touch-control operation is a sliding operation, determining a fourth target action from a third action set according to the sliding operation, and controlling the virtual character to perform the fourth target action, where the third action set at least includes a crouching action.

In an alternative implementation, based on the above solution, the following steps may be further performed: if the fourth touch-control operation is a long press operation, displaying a third control set, determining a fourth target control from controls included in the third control set according to a sliding operation continuous with the long press operation, and controlling the virtual character to perform an action corresponding to the fourth target control; and in response to an end of the fourth touch-control operation, cancelling displaying the third control set.

In an alternative implementation, based on the above solution, the following step may be further performed: displaying a seventh control on the graphical user interface, where the seventh control is a skill control for triggering the virtual character to perform a skill release, and the first attack control is an action control for triggering the virtual character to perform the first attack action.

In an alternative implementation, based on the above solution, a skill corresponding to the above-mentioned skill control has a cooling time, and an action corresponding to the action control does not have the cooling time.

In an alternative implementation, based on the above solution, there are a first virtual character and a second virtual character in a virtual environment corresponding to the graphical user interface, and a skill of the first virtual character is different from a skill of the second virtual character, where both the first virtual character and the first virtual character may perform the first attack action.

In an alternative implementation, based on the above solution, the above-mentioned first attack action is a contact attack action performed via limbs and/or a weapon of the virtual character.

In an alternative implementation, based on the above solution, if the first touch-control operation is the sliding operation, determining the first target action from the first action set according to the sliding operation, and controlling the virtual character to perform the first target action may be specifically implemented by performing the following steps: determining the first target action from the first action set according to the sliding operation, and determining whether an action interruption condition is met or not according to a current action state of the virtual character and the first target action; and if the action interruption condition is met, controlling the virtual character to perform the first target action.

In an alternative implementation, based on the above solution, the following step may be further performed: if the action interruption condition is not met, not controlling the virtual character to perform the first target action.

In an alternative implementation, based on the above solution, the following step may be further performed: if the action interruption condition is not met, controlling the virtual character to continue to perform a currently unfinished action.

In an alternative implementation, based on the above solution, the following steps may be further performed: providing a second action control corresponding to a second action at a preset position of the graphical user interface according to a current action of the virtual character and a fourth action set; and controlling the virtual character to perform the second action in response to a trigger operation for the second action control.

In an alternative implementation, based on the above solution, the above-mentioned fourth action set includes at least two actions and an action sequence.

In an alternative implementation, the above-mentioned providing the second action control corresponding to the second action in the graphical user interface according to the current action of the virtual character and the fourth action set may be specifically implemented by performing the following step: providing the second action control corresponding to the second action in the graphical user interface according to the current action of the virtual character and the action sequence of the fourth action set.

In an alternative implementation, based on the above solution, the following steps may be further performed: providing a third action control corresponding to a third action at the preset position of the graphical user interface according to the second action and the fourth action set; and controlling the virtual character to perform the third action in response to a trigger operation for the third action control.

In an alternative implementation, based on the above solution, the above-mentioned fourth action set is an action set determined from at least two action sets according to the current action.

In an alternative implementation, based on the above solution, the above-mentioned providing the second action control corresponding to the second action in the graphical user interface according to the current action of the virtual character and the fourth action set may be specifically implemented by performing the following step: providing the second action control corresponding to the second action in the graphical user interface according to a virtual weapon used by the virtual character, the current action of the virtual character and the fourth action set.

In an alternative implementation, based on the above solution, the above-mentioned providing the second action control corresponding to the second action in the graphical user interface according to the virtual weapon used by the virtual character, the current action of the virtual character and the fourth action set may be specifically implemented by performing the following steps: determining candidate action sets according to the virtual weapon used by the virtual character; determining the fourth action set from the candidate action sets according to the current action of the virtual character; and providing the second action control corresponding to the second action in the graphical user interface according to the current action of the virtual character and an action sequence of the fourth action set.

In an alternative implementation, based on the above solution, the above-mentioned second action is a next sequential action next to the current action in the fourth action set.

In an alternative implementation, based on the above solution, the following step may be further performed: receiving a click operation acting on the first attack control within a first time period after the controlling the virtual character to perform the first attack control in response to the click operation acting on the first attack control, and controlling the virtual character to perform a fourth attack control.

In an alternative implementation, based on the above solution, the following step may be further performed: receiving a click operation acting on the first attack control after a first time period after the controlling the virtual character to perform the first attack action in response to the click operation acting on the first attack control, and controlling the virtual character to perform the first attack action.

In the control process of the virtual character as described above, the user (player) may control the virtual character to perform the first attack action by touching the first attack control in the graphical user interface. The user may also determine the first target action from the first action set by touching the first attack control in the graphical user interface, and control the virtual character to perform the first target action. That is, the first attack control may not only control the virtual character to perform the first attack action, but also control the virtual character to perform the first target action. Specifically, if a first touch-control operation acting on the first attack control is a click operation, the virtual character is controlled to perform the first attack action. If the first touch-control operation is a sliding operation, the first target action is determined from the first action set according to the sliding operation, and the virtual character is controlled to perform the first target action. The first target action may be the first attack action as described above or other actions. In this way, if the user needs to control the virtual character to perform the first attack action, he/she may click the first attack control originally displayed in the graphical user interface. If the user needs to control the virtual character to perform a jump action, a defensive action and other actions, it may be implemented not only by touching a jump control and a defensive control originally displayed in the graphical user interface, but also by performing a sliding operation on the first attack control. The way of determining the first target action from the first action set according to the sliding operation enables the user to realize a connection between the first attack action and the first target action more quickly and continuously. When it is necessary to control the virtual character to perform a certain action in the first action set, the first target action may be accurately determined from the first action set according to the sliding operation only via the sliding operation acting on the first attack control, without the need for the user to lift his finger and click other controls in the graphical user interface. During the whole process from the first attack action to the first target action of the virtual character, it is not necessary for the user to find and locate another control (a control corresponding to actions such as a defensive action and a jump action) in the interface, and the first target action may be easily determined from the first action set through the sliding operation on the first attack control, so as to trigger the virtual character to perform the first target action, thus realizing a rapid control of the virtual character, such as quickly controlling an attack move transformation or an attack and defense conversion. In such operation process, the user may realize control switching without lifting his finger and shifting his gaze, and the user may react quickly in the interaction, operate more conveniently, which effectively alleviates a problem of misoperation caused by relatively more interface controls. Such way of quickly controlling the virtual character also improves a consistency of user operations.

A virtual character control method is provided and includes:
displaying a first attack control on a graphical user interface; and
in response to a first touch-control operation acting on the first attack control, in response to determining that the first touch-control operation is a click operation, controlling a virtual character to perform a first attack action corresponding to the first attack control; in response to determining that the first touch-control operation is a sliding operation, determining a first target action from a first action set according to the sliding operation, and controlling the virtual character to perform the first target action.

In some embodiments, the first action set includes direction information and action information corresponding to the direction information; and determining the first target action from the first action set according to the sliding operation includes:
determining an action matching a direction of the sliding operation in the first action set as the first target action.

In some embodiments, determining the first target action from the first action set according to the sliding operation includes:
determining the first target action from the first action set according to the sliding operation and a state of the virtual character.

In some embodiments, the first action set includes at least two action subsets; and determining the first target action from the first action set according to the sliding operation and the state of the virtual character includes:
determining a target action subset from the first action set according to the state of the virtual character; and
determining the first target action from the target action subset according to the sliding operation.

In some embodiments, the state of the virtual character includes: a ground state and a hovering state.

In some embodiments, the first action set is a user-defined set.

In some embodiments, the method further includes:
displaying a first control on the graphical user interface; and
in response to a second touch-control operation acting on the first control, controlling the virtual character to perform an action corresponding to the first control.

In some embodiments, the first action set includes the action corresponding to the first control.

In some embodiments, the method further includes:
in response to determining that the first touch-control operation is a long press operation, displaying a first control set, determining a first target control from controls included in the first control set according to a sliding operation continuous with the long press operation, and controlling the virtual character to perform an action corresponding to the first target control, where the controls included in the first control set correspond to actions included in the first action set.

In some embodiments, the action corresponding to the first control is a non-aggressive action.

In some embodiments, the action corresponding to the first control is a defensive action, an evasive action, a jump action, a squat action, a sliding tackle action or a crawling action.

In some embodiments, the method further includes:
cancelling displaying the first control set.

In some embodiments, cancelling displaying the first control set includes:
in response to an end of the first touch-control operation, cancelling displaying the first control set.

In some embodiments, the first control and the first attack control displayed on the graphical user interface are resident controls in the graphical user interface.

In some embodiments, the first action set includes a first subset of action and a second subset of action, where the first subset of action is an action set corresponding to a resident control in the graphical user interface, and the second subset of action is an action set corresponding to a non-resident control in the graphical user interface.

In some embodiments, the first control set includes a first control subset and a second control subset, where controls included in the first control subset are a subset of resident controls, and controls included in the second control subset are a subset of non-resident controls.

In some embodiments, the method further includes:
displaying a second attack control on the graphical user interface, where an attack angle of the first attack action corresponding to the first attack control is different from an attack angle of a second attack action corresponding to the second attack control.

In some embodiments, the method further includes:
in response to a third touch-control operation acting on the second attack control, in response to determining that the third touch-control operation is a click operation, controlling the virtual character to perform the second attack action corresponding to the second attack control; in response to determining that the third touch-control operation is a sliding operation, determining a second target action from a second action set according to the sliding operation, and controlling the virtual character to perform the second target action.

In some embodiments, the method further includes:
in response to determining that the third touch-control operation is a long press operation, displaying a second control set, determining a second target control from controls included in the second control set according to a sliding operation continuous with the long press operation, and controlling the virtual character to perform an action corresponding to the second target control, where the controls included in the second control set correspond to actions included in the second action set.

In some embodiments, the method further includes:
cancelling displaying the second control set.

In some embodiments, cancelling displaying the second control set includes:
in response to an end of the third touch-control operation, cancelling displaying the second control set.

In some embodiments, the method further includes:
in response to determining that the first touch-control operation is the long press operation and a press duration of the long press operation is greater than or equal to a first time threshold, controlling the virtual character to perform a third attack action.

In some embodiments, in response to determining that the first touch-control operation is the long press operation and the press duration of the long press operation is greater than or equal to the first time threshold, controlling the virtual character to perform the third attack action includes:
in response to determining that the first touch-control operation is the long press operation, controlling the virtual character to perform a preparation action for the third attack action, and after the press duration is greater than or equal to the first time threshold, controlling the virtual character to perform the third attack action.

In some embodiments, in response to determining that the first touch-control operation is the long press operation and the press duration of the long press operation is greater than or equal to the first time threshold, controlling the virtual character to perform the third attack action includes:
in response to determining that the first touch-control operation is the long press operation and the press duration of the long press operation is greater than or equal to the first time threshold and less than a second time threshold at an end of the long press operation, triggering the virtual character to perform the third attack action at the end of the long press operation, where the second time threshold is greater than the first time threshold.

In some embodiments, the method further includes: in response to determining that the first touch-control operation is the long press operation and the press duration of the long press operation is equal to the second time threshold, automatically triggering the virtual character to perform the third attack action.

In some embodiments, the method further includes:
in response to determining that the first touch-control operation is the long press operation and the press duration of the long press operation is greater than or equal to the first time threshold and less than the second time threshold, in response to a sliding operation continuous with the long press operation, determining a third target action from the first action set, and controlling the virtual character to perform the third target action.

In some embodiments, determining the first target action from the first action set according to the sliding operation includes:
confirming the first target action from the first action set according to a sliding trajectory of the sliding operation.

In some embodiments, displaying the first control set includes:
displaying a first roulette including the first control set, where controls in the first control set are arranged on the first roulette.

In some embodiments, the first roulette surrounds the first attack control.

In some embodiments, the first roulette surrounds a preset position in a blank area in the graphical user interface.

In some embodiments, a direction from the first attack control to a third control in the first control set is different from a direction from the first attack control to a fourth control in the first control set.

In some embodiments, the method further includes:
displaying a first control indication in a first direction of the first attack control, and displaying a second control indication in a second direction of the first attack control, where the first control indication is used to indicate that controls in the first control set are displayed in the first direction of the first attack control when the first control set corresponding to the first attack control is displayed, and the second control indication is used to indicate that controls in the first control set are displayed in the second direction of the first attack control when the first control set corresponding to the first attack control is displayed.

In some embodiments, an included angle between a ray originating from the first attack control toward a third control in the first control set and a ray originating from the first attack control toward a fourth control in the first control set is greater than an angle threshold.

In some embodiments, the first control is an evasion control, and the method includes:
controlling the virtual character to perform a first evasive action in response to a click operation on the evasion control; and
controlling the virtual character to perform a second evasive action in response to a long press operation on the evasion control, where an evasive distance of the first evasive action and an evasive distance of the second evasive action are different and/or a state after the first evasive action and a state after the second evasive action are different, and the state includes jogging or sprinting.

In some embodiments, the graphical user interface further includes a sixth control, and the sixth control is a jump control, where the method includes:
in response to a fourth touch-control operation acting on the sixth control, in response to determining that the fourth touch-control operation is a click operation, controlling the virtual character to perform a jump action; in response to determining that the fourth touch-control operation is a sliding operation, determining a fourth target action from a third action set according to the sliding operation, and controlling the virtual character to perform the fourth target action, where the third action set at least includes a crouching action.

In some embodiments, the method further includes:
in response to determining that the fourth touch-control operation is a long press operation, displaying a third control set, determining a fourth target control from controls included in the third control set according to a sliding operation continuous with the long press operation, and controlling the virtual character to perform an action corresponding to the fourth target control; and
in response to an end of the fourth touch-control operation, cancelling displaying the third control set.

In some embodiments, the method further includes:
displaying a seventh control on the graphical user interface, where the seventh control is a skill control for triggering the virtual character to perform a skill release, and the first attack control is an action control for triggering the virtual character to perform the first attack action.

In some embodiments, a skill corresponding to the skill control has a cooling time, and an action corresponding to the action control does not have the cooling time.

In some embodiments, a first virtual character and a second virtual character are provided in a virtual environment corresponding to the graphical user interface, and a skill of the first virtual character is different from a skill of the second virtual character, where both the first virtual character and the first virtual character are able to perform the first attack action.

In some embodiments, the first attack action is a contact attack action performed via limbs and/or a weapon of the virtual character.

In some embodiments, in response to determining that the first touch-control operation is the sliding operation, determining the first target action from the first action set according to the sliding operation, and controlling the virtual character to perform the first target action includes:
in response to determining that the first touch-control operation is the sliding operation, determining the first target action from the first action set according to the sliding operation, and determining whether an action interruption condition is met according to a current action state of the virtual character and the first target action; and
in response to determining that the action interruption condition is met, controlling the virtual character to perform the first target action.

In some embodiments, the method further includes:
in response to determining that the action interruption condition is not met, not controlling the virtual character to perform the first target action.

In some embodiments, the method further includes:
in response to determining that the action interruption condition is not met, controlling the virtual character to continue to perform a currently unfinished action.

In some embodiments, the method further includes:
providing a second action control corresponding to a second action at a preset position of the graphical user interface according to a current action of the virtual character and a fourth action set; and
controlling the virtual character to perform the second action in response to a trigger operation for the second action control.

In some embodiments, the fourth action set includes at least two actions and an action sequence.

In some embodiments, providing the second action control corresponding to the second action in the graphical user interface according to the current action of the virtual character and the fourth action set includes:
providing the second action control corresponding to the second action in the graphical user interface according to the current action of the virtual character and the action sequence of the fourth action set.

In some embodiments, the method further includes:
providing a third action control corresponding to a third action at the preset position of the graphical user interface according to the second action and the fourth action set; and
controlling the virtual character to perform the third action in response to a trigger operation for the third action control.

In some embodiments, the fourth action set is an action set determined from at least two action sets according to the current action.

In some embodiments, providing the second action control corresponding to the second action in the graphical user interface according to the current action of the virtual character and the fourth action set includes:
providing the second action control corresponding to the second action in the graphical user interface according to a virtual weapon used by the virtual character, the current action of the virtual character and the fourth action set.

In some embodiments, providing the second action control corresponding to the second action in the graphical user interface according to the virtual weapon used by the virtual character, the current action of the virtual character and the fourth action set includes:
determining a candidate action set according to the virtual weapon used by the virtual character;
determining the fourth action set from the candidate action set according to the current action of the virtual character; and
providing the second action control corresponding to the second action in the graphical user interface according to the current action of the virtual character and an action sequence of the fourth action set.

In some embodiments, the second action is a next sequential action next to the current action in the fourth action set.

In some embodiments, the method further includes:
in response to the click operation acting on the first attack control, receiving the click operation acting on the first attack control within a first time period after the controlling the virtual character to perform the first attack action, and controlling the virtual character to perform a fourth attack action.

In some embodiments, the method further includes:
in response to the click operation acting on the first attack control, receiving the click operation acting on the first attack control after a first time period after the controlling the virtual character to perform the first attack action, and controlling the virtual character to perform the first attack action.

A virtual character control apparatus, is provided and includes:
a control display module, configured to display a first attack control on a graphical user interface; and
a character control module, configured to: in response to a first touch-control operation acting on the first attack control, in response to determining that the first touch-control operation is a click operation, control the virtual character to perform a first attack action corresponding to the first attack control; in response to determining that the first touch-control operation is a sliding operation, determine a first target action from a first action set according to the sliding operation, and control the virtual character to perform the first target action.

An electronic device is provided and includes a processor and a memory, where a computer-executable instruction executable by the processor is stored on the memory, and the computer-executable instruction is executed by the processor to realize the virtual character control method according to any one of above embodiments.

A non-transitory computer-readable storage medium is provided, the non-transitory computer-readable storage medium stores a computer-executable instruction, where when called and executed by a processor, the computer-executable instruction causes the processor to realize the virtual character control method according to any one of above embodiments.

One or more embodiment of the present disclosure provides a virtual character control method, in which a user (player) may control a virtual character to perform a first attack action by touching a first attack control in a graphical user interface. The user may also determine a first target action from a first action set by touching the first attack control in the graphical user interface, and control the virtual character to perform the first target action. That is, the first attack control may not only control the virtual character to perform the first attack action, but also control the virtual character to perform the first target action. Specifically, if a first touch-control operation acting on the first attack control is a click operation, the virtual character is controlled to perform the first attack action. If the first touch-control operation is a sliding operation, the first target action is determined from the first action set according to the sliding operation, and the virtual character is controlled to perform the first target action. The first target action may be the first attack action as described above or other actions. In this way, if the user needs to control the virtual character to perform the first attack action, he/she may click the first attack control originally displayed in the graphical user interface. If the user needs to control the virtual character to perform a jump action, a defensive action and other actions, it may be implemented not only by touching a jump control and a defensive control originally displayed in the graphical user interface, but also by performing a sliding operation on the first attack control. The above-mentioned way of determining the first target action from the first action set according to the sliding operation enables the user to realize a connection between the first attack action and the first target action more quickly and continuously. When it is necessary to control the virtual character to perform a certain action in the first action set, the first target action may be accurately determined from the first action set according to the sliding operation only via the sliding operation acting on the first attack control, without the need for the user to lift his finger and click other controls in the graphical user interface. During the whole process from the first attack action to the first target action of the virtual character, it is not necessary for the user to find and locate another control (a control corresponding to actions such as a defensive action and a jump action) in the interface, and the first target action may be easily determined from the first action set through the sliding operation on the first attack control, so as to trigger the virtual character to perform the first target action, thus realizing a rapid control of the virtual character, such as quickly controlling an attack move transformation or an attack and defense conversion. In such operation process, the user may realize control switching without lifting his finger and shifting his gaze, and the user may react quickly in the interaction, operate more conveniently, which effectively alleviates a problem of misoperation caused by relatively more interface controls. Such way of quickly controlling the virtual character also improves a consistency of user operations.

The virtual character control method, apparatus and computer program product of electronic device provided by the embodiments of the present disclosure include a computer-readable storage media in which program codes are stored, and the instructions included in the program codes may be used to perform the methods in the previous method embodiments. The specific implementation may be referred to the method embodiments, which will not be repeated here.

Unless otherwise specified, the relative steps, numerical expressions and numerical values of components and steps set forth in these embodiments do not limit the scope of the present disclosure.

When the functions are implemented in the form of a software functional unit and sold or used as an independent product, the functions may be stored in a processor-executable nonvolatile computer-readable storage medium. Based on such understanding, the technical solution of the present disclosure may be embodied in the form of a software product, which is stored in a storage medium and includes several instructions to make a computer device (which may be a personal computer, a server, a network device, etc.) execute all or part of the steps of the methods of various embodiments of the present disclosure. The foregoing storage media include: a U disk, a mobile hard disk, a read-only memory (ROM), a random access memory (RAM), a magnetic disk or optical disk and other media that may store program codes.

In the description of the present disclosure, it should be noted that the orientation or positional relationship indicated by the terms “center”, “upper”, “lower”, “left”, “right”, “vertical”, “horizontal”, “inner”, “outer”, and the like is based on the orientation or positional relationship shown in the drawings, just for the convenience of describing the present disclosure and simplifying the description, rather than indicating or implying that the indicated apparatus or element must have a specific orientation, or be constructed and operated in a specific orientation, and therefore cannot be understood as a limitation to the present disclosure. In addition, the terms “first”, “second” and “third” are used for purposes of description only and cannot be understood as indicating or implying relative importance.

Finally, it should be noted that, the above embodiments are only specific embodiments of the present disclosure, and are used to illustrate the technical solutions of the present disclosure without limitation, and the protection scope of the present disclosure is not limited to this. Although the present disclosure has been described in detail with reference to the foregoing embodiments, those of ordinary skilled in the art should understand that any person skilled in the art familiar with the technical field may still modify or easily think of changes to the technical solutions recorded in the forgoing embodiments within the technical scope disclosed by the present disclosure. And these modifications, changes or substitutions do not separate the essence of the corresponding technical solutions from the spirit and scope of the technical solution of the embodiments in the present disclosure, and should be covered within the protection scope of the present disclosure. Therefore, the protection scope of the present disclosure shall be subject to the protection scope of the claims.

1. A virtual character control method, comprising:
displaying a first attack control on a graphical user interface;
in response to detecting a first touch-control operation acting on the first attack control, determining whether the first touch-control operation is a click operation or a sliding operation;
in response to determining that the first touch-control operation is the click operation, controlling a virtual character to perform a first attack action corresponding to the first attack control; and
in response to determining that the first touch-control operation is the sliding operation, determining a first target action from a first action set according to the sliding operation, and controlling the virtual character to perform the first target action.

2. The method according to claim 1, wherein the first action set comprises direction information and action information corresponding to the direction information; and determining the first target action from the first action set according to the sliding operation comprises:
determining an action matching a direction of the sliding operation in the first action set as the first target action.

3. The method according to claim 1, wherein determining the first target action from the first action set according to the sliding operation comprises:
determining the first target action from the first action set according to the sliding operation and a state of the virtual character.

4. The method according to claim 3, wherein the first action set comprises at least two action subsets; and determining the first target action from the first action set according to the sliding operation and the state of the virtual character comprises:
determining a target action subset from the first action set according to the state of the virtual character; and
determining the first target action from the target action subset according to the sliding operation;
wherein the state of the virtual character comprises: a ground state and a hovering state.

5. (canceled)

6. The method according to claim 1, wherein the first action set is a user-defined set,
wherein the first attack action is a contact attack action performed via at least one of limbs or a weapon of the virtual character.

7. The method according to claim 1, further comprising:
displaying a first control on the graphical user interface; and
in response to detecting a second touch-control operation acting on the first control, controlling the virtual character to perform an action corresponding to the first control.

8. The method according to claim 7, wherein the first action set comprises the action corresponding to the first control, and the action corresponding to the first control is a non-aggressive action;
wherein the action corresponding to the first control comprises at least one of a defensive action, an evasive action, a jump action, a squat action, a sliding tackle action or a crawling action;
wherein the first control and the first attack control displayed on the graphical user interface are resident controls in the graphical user interface.

9. The method according to claim 1, further comprising:
in response to determining that the first touch-control operation is a long press operation, displaying a first control set, determining a first target control from controls comprised in the first control set according to a sliding operation continuous with the long press operation, and controlling the virtual character to perform an action corresponding to the first target control, wherein the controls comprised in the first control set correspond to actions comprised in the first action set.

10-12. (canceled)

13. The method according to claim 9, further comprising:
in response to detecting an end of the first touch-control operation, cancelling displaying the first control set.

14. (canceled)

15. The method according to claim 1, wherein the first action set comprises a first subset of action and a second subset of action, wherein the first subset of action is an action set corresponding to a resident control in the graphical user interface, and the second subset of action is an action set corresponding to a non-resident control in the graphical user interface;
wherein the first control set comprises a first control subset and a second control subset, wherein controls comprised in the first control subset are a subset of resident controls, and controls comprised in the second control subset are a subset of non-resident controls.

16. (canceled)

17. The method according to claim 1, further comprising:
displaying a second attack control on the graphical user interface, wherein an attack angle of the first attack action corresponding to the first attack control is different from an attack angle of a second attack action corresponding to the second attack control.

18. The method according to claim 17, further comprising:
in response to detecting a third touch-control operation acting on the second attack control, if the third touch-control operation is a click operation, controlling the virtual character to perform the second attack action corresponding to the second attack control; in response to determining that the third touch-control operation is a sliding operation, determining a second target action from a second action set according to the sliding operation, and controlling the virtual character to perform the second target action;
in response to determining that the third touch-control operation is a long press operation, displaying a second control set, determining a second target control from controls comprised in the second control set according to a sliding operation continuous with the long press operation, and controlling the virtual character to perform an action corresponding to the second target control, wherein the controls comprised in the second control set correspond to actions comprised in the second action set;
in response to detecting an end of the third touch-control operation, cancelling displaying the second control set.

19-21. (canceled)

22. The method according to claim 9, further comprising:
in response to determining that the first touch-control operation is the long press operation and a press duration of the long press operation is greater than or equal to a first time threshold, controlling the virtual character to perform a third attack action.

23. The method according to claim 22, wherein in response to determining that the first touch-control operation is the long press operation and the press duration of the long press operation is greater than or equal to the first time threshold, controlling the virtual character to perform the third attack action comprises:
in response to determining that the first touch-control operation is the long press operation, controlling the virtual character to perform a preparation action for the third attack action, and after the press duration is greater than or equal to the first time threshold, controlling the virtual character to perform the third attack action.

24. The method according to claim 22, wherein in response to determining that the first touch-control operation is the long press operation and the press duration of the long press operation is greater than or equal to the first time threshold, controlling the virtual character to perform the third attack action comprises:
in response to determining that the first touch-control operation is the long press operation and the press duration of the long press operation is greater than or equal to the first time threshold and less than a second time threshold at an end of the long press operation, triggering the virtual character to perform the third attack action at the end of the long press operation, wherein the second time threshold is greater than the first time threshold;
wherein the method further comprises:
in response to determining that the first touch-control operation is the long press operation and the press duration of the long press operation is greater than or equal to the first time threshold and less than the second time threshold, in response to detecting a sliding operation continuous with the long press operation, determining a third target action from the first action set, and controlling the virtual character to perform the third target action.

25. The method according to claim 22, further comprising:
in response to determining that the first touch-control operation is the long press operation and the press duration of the long press operation is equal to a second time threshold, automatically triggering the virtual character to perform the third attack action, wherein the second time threshold is greater than the first time threshold.

26. (canceled)

27. The method according to claim 1, wherein determining the first target action from the first action set according to the sliding operation comprises:
confirming the first target action from the first action set according to a sliding trajectory of the sliding operation.

28. The method according to claim 9, wherein displaying the first control set comprises:
displaying a first roulette including the first control set, wherein controls in the first control set are arranged on the first roulette;
wherein the first roulette surrounds the first attack control or a preset position in a blank area in the graphical user interface.

29-30. (canceled)

31. The method according to claim 9, wherein a direction from the first attack control to a third control in the first control set is different from a direction from the first attack control to a fourth control in the first control set,
wherein an included angle between a ray originating from the first attack control toward a third control in the first control set and a ray originating from the first attack control toward a fourth control in the first control set is greater than an angle threshold.

32. The method according to claim 9, further comprising:
displaying a first control indication in a first direction of the first attack control, and displaying a second control indication in a second direction of the first attack control, wherein the first control indication is used to indicate that controls in the first control set are displayed in the first direction of the first attack control when the first control set corresponding to the first attack control is displayed, and the second control indication is used to indicate that controls in the first control set are displayed in the second direction of the first attack control when the first control set corresponding to the first attack control is displayed.

33. (canceled)

34. The method according to claim 7, wherein the first control is an evasion control, and the method comprises:
controlling the virtual character to perform a first evasive action in response to detecting a click operation on the evasion control; and
controlling the virtual character to perform a second evasive action in response to detecting a long press operation on the evasion control,
wherein an evasive distance of the first evasive action and an evasive distance of the second evasive action are different, or a state after the first evasive action and a state after the second evasive action are different, or the evasive distance of the first evasive action and the evasive distance of the second evasive action are different as well as the state after the first evasive action and the state after the second evasive action are different, and the state comprises jogging or sprinting.

35. The method according to claim 1, wherein the graphical user interface further comprises a sixth control, and the sixth control is a jump control, wherein the method comprises:
in response to detecting a fourth touch-control operation acting on the sixth control, in response to determining that the fourth touch-control operation is a click operation, controlling the virtual character to perform a jump action; in response to determining that the fourth touch-control operation is a sliding operation, determining a fourth target action from a third action set according to the sliding operation, and controlling the virtual character to perform the fourth target action, wherein the third action set at least comprises a crouching action;
in response to determining that the fourth touch-control operation is a long press operation, displaying a third control set, determining a fourth target control from controls comprised in the third control set according to a sliding operation continuous with the long press operation, and controlling the virtual character to perform an action corresponding to the fourth target control; and
in response to detecting an end of the fourth touch-control operation, cancelling displaying the third control set.

36. (canceled)

37. The method according to claim 1, further comprising:
displaying a seventh control on the graphical user interface, wherein the seventh control is a skill control for triggering the virtual character to perform a skill release, and the first attack control is an action control for triggering the virtual character to perform the first attack action;
wherein a skill corresponding to the skill control has a cooling time, and an action corresponding to the action control does not have the cooling time; and
wherein a first virtual character and a second virtual character are provided in a virtual environment corresponding to the graphical user interface, and a skill of the first virtual character is different from a skill of the second virtual character, wherein both the first virtual character and the first virtual character are able to perform the first attack action.

38-40. (canceled)

41. The method according to claim 1, wherein in response to determining that the first touch-control operation is the sliding operation, determining the first target action from the first action set according to the sliding operation, and controlling the virtual character to perform the first target action comprises:
in response to determining that the first touch-control operation is the sliding operation, determining the first target action from the first action set according to the sliding operation, and determining whether an action interruption condition is met according to a current action state of the virtual character and the first target action; and
in response to determining that the action interruption condition is met, controlling the virtual character to perform the first target action;
in response to determining that the action interruption condition is not met, performing one of the following:
not controlling the virtual character to perform the first target action; and
controlling the virtual character to continue to perform a currently unfinished action.

42-43. (canceled)

44. The method according to claim 1, further comprising:
providing a second action control corresponding to a second action at a preset position of the graphical user interface according to a current action of the virtual character and a fourth action set; and
controlling the virtual character to perform the second action in response to detecting a trigger operation for the second action control.

45. The method according to claim 44, wherein the fourth action set comprises at least two actions and an action sequence;
wherein providing the second action control corresponding to the second action in the graphical user interface according to the current action of the virtual character and the fourth action set comprises:
providing the second action control corresponding to the second action in the graphical user interface according to the current action of the virtual character and the action sequence of the fourth action set;
wherein the second action is a next sequential action next to the current action in the fourth action set.

46. (canceled)

47. The method according to claim 44, further comprising:
providing a third action control corresponding to a third action at the preset position of the graphical user interface according to the second action and the fourth action set; and
controlling the virtual character to perform the third action in response to detecting a trigger operation for the third action control;
wherein the fourth action set is an action set determined from at least two action sets according to the current action.

48. (canceled)

49. The method according to claim 44, wherein providing the second action control corresponding to the second action in the graphical user interface according to the current action of the virtual character and the fourth action set comprises:
providing the second action control corresponding to the second action in the graphical user interface according to a virtual weapon used by the virtual character, the current action of the virtual character and the fourth action set;
wherein providing the second action control corresponding to the second action in the graphical user interface according to the virtual weapon used by the virtual character, the current action of the virtual character and the fourth action set comprises:
determining a candidate action set according to the virtual weapon used by the virtual character;
determining the fourth action set from the candidate action set according to the current action of the virtual character; and
providing the second action control corresponding to the second action in the graphical user interface according to the current action of the virtual character and an action sequence of the fourth action set.

50-51. (canceled)

52. The method according to claim 1, further comprising:
in response to detecting the click operation acting on the first attack control, receiving the click operation acting on the first attack control within a first time period after the controlling the virtual character to perform the first attack action, and controlling the virtual character to perform a fourth attack action; and
in response to detecting the click operation acting on the first attack control, receiving the click operation acting on the first attack control after a first time period after the controlling the virtual character to perform the first attack action, and controlling the virtual character to perform the first attack action.

53-54. (canceled)

55. An electronic device, comprising a processor and a memory, wherein a computer-executable instruction executable by the processor is stored on the memory, and the computer-executable instruction is executed by the processor, the processor is configured to:
display a first attack control on a graphical user interface;
in response to detecting a first touch-control operation acting on the first attack control, determine whether the first touch-control operation is a click operation or a sliding operation;
in response to determining that the first touch-control operation is the click operation, control a virtual character to perform a first attack action corresponding to the first attack control; and
in response to determining that the first touch-control operation is the sliding operation, determine a first target action from a first action set according to the sliding operation, and control the virtual character to perform the first target action.

56. (canceled)
